(19) United States
(12) Patent Application Publication
(10) Pub. No.: US 2019/0168036 A1
(43) Pub. Date: Jun. 6, 2019

(54) SYSTEMS AND METHODS FOR AUTOMATED EARLY FIRE-OUTBREAK AND ARSON-ATTACK DETECTION AND ELIMINATION IN WOOD-FRAMED AND MASS TIMBER BUILDINGS

(71) Applicant: M-Fire Suppression, Inc., Carlsbad, CA (US)

(72) Inventor: Stephen Conboy, Carlsbad, CA (US)

(73) Assignee: M-Fire Suppression, Inc., Carlsbad, CA (US)

(21) Appl. No.: 16/041,850

(22) Filed: Jul. 23, 2018

Related U.S. Application Data
(63) Continuation-in-part of application No. 15/874,874, filed on Jan. 18, 2018.
Application No. 15/874,874 is a continuation-in-part of application No. 15/866,454, filed on Jan. 9, 2018.
Application No. 15/866,454 is a continuation-in-part of application No. 15/829,914, filed on Dec. 2, 2017, now Pat. No. 10,260,232.
Application No. 15/829,914 is a continuation-in-part of application No. 15/866,456, filed on Jan. 9, 2018.
Application No. 15/866,456 is a continuation-in-part of application No. 15/829,914, filed on Dec. 2, 2017, now Pat. No. 10,260,232.
Application No. 15/829,914 is a continuation-in-part of application No. 15/952,183, filed on Apr. 12, 2018.
Application No. 15/952,183 is a continuation-in-part of application No. 15/921,617, filed on Mar. 14, 2018.
Application No. 15/921,617 is a continuation-in-part of application No. 15/866,454, filed on Jan. 9, 2018.
Application No. 15/866,454 is a continuation-in-part of application No. 15/829,914, filed on Dec. 2, 2017, now Pat. No. 10,260,232.
Application No. 15/829,914 is a continuation-in-part of application No. 15/866,451, filed on Jan. 9, 2018.
Application No. 15/866,451 is a continuation-in-part of application No. 16/039,291, filed on Jul. 18, 2018.

(51) Int. Cl. A62C 3/02; B64C 39/02; H04L 29/08; A62C 27/00; A62C 37/00; G08B 25/10

(52) U.S. Cl. CPC A62C 3/0242; B64C 39/024; H04L 67/12; B64C 2201/12; A62C 37/00; G08B 25/10; A62C 27/00

(57) ABSTRACT

A method of and system for helping building construction team members in significant ways: (i) quickly detect high-risk fire outbreaks and arson strikes to a wood-framed and mass timber buildings under construction; (ii) receiving automatic notifications when fire outbreaks and arson strikes are detected at GPS-specific regions in a building under construction, and (iii) automatically and quickly responding to the detected fire outbreak and/or arson strike using AI-guided and/or VR-guided thermal-imaging flying drones, and AI/guided and/or VR-guided thermally-imaging fire seeking and suppressing robots and drone systems which eliminate these fire outbreaks by directly controlled spray streams of clean anti-fire (AF) liquid on the fire, using only ¼ of the water required using conventional fire extinguishing methods.

### RELATED CASES

The present patent application is a Continuation-in-Part (CIP) of: copending application Ser. No. 15/866,451 filed Jan. 9, 2018; and co-pending application Ser. No. 16/039,291 filed Jul. 18, 2018 which is a Continuation-in-Part (CIP) of copending patent application Ser. No. 15/874,874 filed Jan. 18, 2018, which is a Continuation-in-Part (CIP) of copending patent application Ser. No. 15/866,454 filed Jan. 9, 2018 which is a Continuation-in-Part (CIP) of copending patent application Ser. No. 15/829,914 filed Dec. 2, 2017; and copending patent application Ser. No. 15/866,456 filed Jan. 9, 2018 which is a Continuation-in-Part (CIP) of copending patent application Ser. No. 15/829,914 filed Dec. 2, 2017, each said patent application being commonly owned by M-Fire Suppression, Inc., and incorporated herein by reference as if fully set forth herein.

### BACKGROUND OF INVENTION

### Field of Invention

The present invention relates to improvements in methods of and apparatus for collecting intelligence and various forms of information relating to the condition of wood-framed and mass timber buildings under construction, including early detection and response to fire outbreaks and arson attacks.

### Brief Description of the State of Knowledge in the Art

Before arriving on the scene of fire inside a wood-framed or mass timber building under construction, fire fighters and early responders search quickly for early technical information that will help the Fire Chief decide on whether to incur serious risks in attempting to save a burning wood-framed building under construction. A seasoned Fire Chief will attempt to determine the behavior of the building fire and whether or not it is struggling to generate combustion gasses that collect in the floor ceiling assemblies of the building construction, to achieve flash over conditions when the entire building will become quickly engulfed in fire.

While a few vendors, such as Pillar Technologies, NYC, currently offer wireless sensors for installation in buildings under construction, these systems fail to collect the necessary intelligence that might help fire chiefs make the necessary decisions in response to a building fire, such as sending firefighters into a burning building under construction, or allowing it to burn and defending neighboring buildings.

In view of the above shortcomings and drawbacks, significant improvements are needed in the field of wood-frame and mass timber building construction, including information collection, analysis and response to fire outbreaks and arson attacks, while overcoming the shortcomings and drawbacks of prior art apparatus and methodologies.

### OBJECTS AND SUMMARY OF THE PRESENT INVENTION

Accordingly, a primary object of the present disclosure is to provide new and improved methods of and apparatus for collection intelligence and various forms of information relating to building conditions, to assist fire chiefs in making more timely and better informed decisions in protecting human life and real property during wood building fire management operations, while avoiding the shortcomings and drawbacks of prior art systems, apparatus and methodologies.

Another object of the present invention is to provide a novel system for helping building construction management team members in significant ways, namely: instantly detecting when fire outbreaks and/or arson attacks occur within a wood framed or mass timber building under construction; and automatically eliminating the fire outbreak using thermal-imaging fire seeking and suppressing robots spraying clean anti-fire (AF) chemical liquid which instantly breaks the free radical chain reactions within the fire, using less than ¼ the amount of water using in conventional fire extinguishing operations.

Another object of the present invention is to provide a new and improved system for automatically generating notifications and fire-suppression commands when fire outbreaks and arson attacks are automatically detected from real-time thermally-imaging analysis of the interior space of a wood-framed or mass timber building under construction, using a wireless passive infra-red (PIR) thermal-imaging fire-outbreak and arson-attack sensor network, based preferably on the low-power IEEE 802.15.4-based specification for high-level communication protocols supporting small, low-power digital radios embedded in GPS-tracking thermal sensors, employing high spatial-resolution position technologies such as real-time kinematics (RTK).

Another object of the present invention is to provide such a system, wherein the fire suppression commands are transmitted to AI-guided thermally-imaging fire seeking and suppressing robot systems deployed on the floors of the building; (iii) collecting various forms of intelligence about conditions developing on and about a building under construction and use such information for use in supporting intelligent decision making processes such as fire chief's decision to enter a burning wood building and attempt to extinguish the fire; (iv) quickly, efficiently and safely removing dangerous risk-presenting fire thermal conditions on a building while minimizing risk to human workers and increasing building operating efficiency; and (v) automatically removing excessive fire thermal conditions at specified regions on a building's building.

Another object of the present invention is to provide a novel system for helping building owners and insurers in significant ways, namely: (i) improving building construction worker safety conditions; (ii) reducing the cost of maintaining fire-safety conditions in wood-framed buildings under construction; (iii) reducing the risk of property damage and construction worker injury; and (iv) reducing the risk of disruption of business and rental and/or operating income as a result of building and other forms of fire damage caused to neighboring buildings by very hot building fires on a construction site.

Another object of the present invention is to provide a novel early building fire-outbreak/arson-attack detection and elimination system for use by members of building construction management teams, and local fire chiefs and fire men, responding to detected fire-outbreaks and/or arson attacks, so that they can make better decisions while protecting buildings from fire that can present great risk to real property, and human safety and life.

Another object of the present invention is to provide an early building fire-outbreak/arson-attack detection and elimination system that can be readily integrated with (i) conventional building management systems, (ii) fire and police department emergency response networks, and (iii) elsewhere in various ways, to support the goals and objectives of the system.

Another object of the present invention is to provide an early building fire-outbreak/arson-attack detection and elimination system for deployment across a portfolio of wood-framed and mass timber buildings under construction, within which a network of passive IR (PIR) thermal imaging fire-outbreak and arson-attack sensor networks are installed in the ground and lower floors of wood-framed and mass timber buildings under construction.

Another object of the present invention is to provide a novel early building fire-outbreak/arson-attack detection and elimination system comprising a virtual reality (VR) multi-modal operator interface station that displays a realistic virtual reality depiction of a wood building fire fighting robot system, performing rapid fire suppression operations in conjunction with VR-controlled equipment.

Another object of the present invention is to provide a novel early building fire-outbreak/arson-attack detection and elimination system, for close integration with a novel automated building fire suppression system comprising (i) wireless pass infra-red (PIR) or active infra-red (AIR) thermal imaging fire outbreak and arson-attack sensor network, (ii) VR-guided fire fighting robot systems, and (iii) flying unmanned thermal imaging drone aircraft systems with video image capturing capabilities to monitor a building under fire, wherein all such subsystems being integrated with and in communication with the data center and internet (TCP/IP) infrastructure of the building intelligence collection, processing and information management system of the present invention, and are tracked in real-time using a global navigation satellite system (GNSS) with real-time kinematic referencing for high-resolution global positioning.

Another object of the present invention is to provide such an early building fire-outbreak/arson-attack detection and elimination system, wherein (i) Web-enabled client machines are provided for remotely accessing fire thermal inspection reports stored in the system database, (ii) VR-enabled control stations are provided for remotely controlling VR-navigated and controlled fire suppressing robot systems deployed inside wood-framed and mass timber buildings under construction, (iii) VR-enabled control stations are provided for remotely controlling VR-navigated and controlled thermal imaging drone aircraft systems deployed at specified buildings under construction, and (iv) web, application and database servers are provided for building management team members to access information sources related to, for example, weather forecasting, social media, financial markets, and the like.

Another object of the present invention is to provide a novel wireless system and methods for automatically analyzing and responding to intelligence collected within and about the construction sites of wood-framed and mass-timber buildings so as to automatically detect early re-outbreaks and/or arson-attacks and responding to the same using stationary and moving thermal-imaging robots and drones, and virtual-reality (VR) guided fire-suppressing robots to eliminate the detected fire in an early manner.

Another object of the present invention is to provide a novel system that provides fire fighters with early technical information before arriving on the scene of a building fire to help the fire chief in deciding to save a burning building under construction, as well as to step in continue fire fighting operations using the rapidly deployed drone and robotic instruments in response to the automated detection of thermal events indicative of a fire outbreak or arson strike to a specific wood-framed or mass timber building under construction.

Another object of the present invention is to provide an early warning fire response system employing a network of passive infra-red (PIR) thermal imaging fire outbreak sensors network, which triggers the takeoff of a thermal imaging drone aircraft to capture real-time aerial IR imaging to inform fire chiefs in determining how best to respond to a fire burning within a wood-framed or mass timber building under construction.

Another object of the present invention is to provide a method of navigating a fire suppressing robot or drone into a burning wood-framed or mass timber building sustaining an arson attack, wherein once the robot or drone vehicle arrives at the burning building section using GPS coordinates and other collected thermal intelligence from the wireless thermal imaging sensor network, during the last leg of travel towards the fire outbreak, the drone or robot will use real-time thermal imaging and tracking principles to seek, find and lock-onto and eliminate the fire outbreak or arson attack with a variable stream of anti-fire (AF) liquid sprayed directly onto the burning fire liquid.

These and other objects will become apparent hereinafter and in the Claims to Invention appended hereto.

### BRIEF DESCRIPTION OF THE DRAWINGS

In order to more fully understand the Objects, the following Detailed Description of the illustrative embodiments should be read in conjunction with the accompanying Drawings, wherein:

FIG. 1 is a schematic representation of a wood-framed building under construction, in which the early building fire-outbreak/arson-attack detection and elimination system of the present invention shown in FIGS. 3 through 25 is embodied, including a global navigation satellite system (GHSS) with a RTK (real-time kinematic) reference station for high-resolution GPS positioning, a cellular phone and SMS messaging system, a wireless internet gateway, and a thermally imaging drone docking and charging airport mounted above the ground surface;

FIG. 2 is a flow chart describing the primary steps involved in practicing the method of defending a wood-framed and mass timber buildings under construction using early fire-outbreak/arson-attack detection and elimination system of the present invention, comprising the steps (a) defending completed wood-framed or mass timber building sections using clean fire inhibiting chemical (CFIC) liquid spray methods on construction job sites, providing Class-A fire-protection to all defended wood, (b) installing a wireless passive infra-red (PIR) thermal-imaging fire outbreak and arson-attack sensor network within each defended wood building section in the wood building being defended under construction, (c) deploying thermally-imaging drone aircraft outside of the wood building under construction for automated deployment and capturing and transmission of thermal images of the building for use by local fire department and chiefs called to the scene of a fire or arson strike to the wood framed building, and (d) deploying AI-guided and/or VR-guided thermal-imaging fire seeking and suppressing robots for automated early elimination of fire detected in wood building sections of the wood building under construction;

FIG. 3A is a schematic representation illustrating the method of and system for the present invention for on-job-site spray-coating clean fire inhibiting liquid chemical (CFIC) liquid over all exposed interior surfaces of raw as well as fire-treated lumber and sheathing used in a completed section of a wood-framed building during its construction phase, wherein a GPS-tracked mobile clean fire-inhibiting chemical (CFIC) liquid spraying system, and the system network illustrated in FIG. 8, are used to apply and document the spraying of a thin CFIC film or coating over all exposed interior wood surfaces, and thereby provide Class-A fire-protection over all lumber and sheathing used in the wood-framed building construction, along with a complete chain of evidence and documentation to qualify the owner of the Class-A fire-protected wood-framed building for lower causality insurance premiums, and provide local fire departments with valuable building information when fighting fires that may break out in such Class-A fire-protected wood-framed buildings;

FIG. 3B is a schematic representation showing the primary components of the air-less liquid spraying system for spraying environmentally-clean Class-A fire-protective liquid coatings, comprising (i) an air-less type liquid spray pumping subsystem having a reservoir tank for containing a volume of clean fire inhibiting chemical (CFIC) liquid, (ii) a hand-held liquid spray nozzle gun for holding in the hand of a spray-coating technician, and (iii) a sufficient length of flexible tubing, preferably supported on a carry-reel assembly, if necessary, for carrying the CFIC liquid from the reservoir tank of the liquid spray pumping subsystem, to the hand-held liquid spray gun during spraying operations carried out inside the wood-framed building during the construction phase of the building project;

FIG. 4A is a perspective view of a mobile GPS-tracked CFIC liquid spraying system supported on a set of wheels, with integrated supply tank and rechargeable-battery operated electric spray pump, for deployment at private and public properties having building structures, for spraying the same with CFIC liquid in accordance with the principles of the present invention;

FIG. 4B is a schematic representation of the GPS-tracked mobile CFIC liquid spraying system shown in FIG. 4A, comprising a GPS-tracked and remotely-monitored CFIC liquid spray control subsystem interfaced with a micro-computing platform for monitoring the spraying of CFIC liquid from the system when located at specific GPS-indexed location coordinates, and automatically logging and recording such CFIC liquid spray application operations within the network database system;

FIG. 5 is a perspective view of a first job-site of multi-apartment wood-framed building under construction prepared and ready for clean fire inhibiting chemical (CFIC) liquid spray coating treatment applied in accordance with the principles of the present invention;

FIGS. 6A and 6B, taken together, set forth a high-level flow chart describing the steps carried out when practicing the method of producing Class-A fire-protected multi-story wood-framed buildings having improved resistance against total fire destruction, comprising the steps of (a) a fire-protection spray coating technician receives a request from a builder to apply clean fire inhibiting chemical (CFIC) liquid coating on all interior surfaces of the untreated and/or treated wood lumber and sheathing to be used to construct a wood-framed multi-story building at a particular site location, (b) the fire-protection spray coating technician receives building construction specifications, analyze same to determine the square footage of clean fire inhibiting chemical (CFIC) coating to be spray applied to the interior surfaces of the wood-framed building, compute the quantity of CFIC liquid required to do the spray job satisfactorily, and generate a job price quote for the spray job and send to the builder for review and approval, (c) after the builder accepts the job price quote, the builder orders the fire-protection spray coating team to begin performing the on-site wood coating spray job, in accordance with the building construction schedule, so that after the builder completes each predetermined section of the building, where wood framing has been constructed and sheathing installed, but before any wallboard has been installed, clean fire-inhibiting chemical (CFIC) liquid is supplied to an airless liquid spraying system, for spray coating all interior wood surfaces with a CFIC coating, (d) when the section of the building is spray coated with clean fire-protection chemical coating, the section is certified and marked as certified for visual inspection, (e) as each section of the wood-framed building is constructed according to the construction schedule, the spray coating team continues to spray coat the completed section, and certify and mark as certified each such completed spray coated section of the building under construction, (f) when all sections of the building under construction have been completely spray coated with clean fire-inhibiting chemical (CFIC) liquid materials, and certified as such, the spray technicians remove the spray equipment from the building, and the builder proceeds to the next stages of construction and completes the building construction according to architectural and building specifications and plans, and (g) the spray technician then issues a certificate of completion with respect to the application of clean fire inhibiting chemical (CFIC) liquid to all exposed wood surfaces on the interior of the wood-framed building during its construction phase, thereby protecting the building from risk of total destruction by fire;

FIG. 7 shows a schematic table representation illustrating the flame spread and smoke development indices obtained through testing of on-job-site CFIC spray-treated Class-A fire-protected lumber and sheathing produced using the method of the illustrative embodiment described in FIGS. 45 through 49, and tested in accordance with standard ASTM E2768-1;

FIG. 8 is a schematic system diagram showing the Internet-based (i.e. cloud-based) system of the present invention for verifying and documenting Class-A fire-protection spray-treatment of a wood-framed building using on-site spraying of a clean fire inhibiting chemical (CFIC) liquid, comprising (i) a data center with web, application and database servers for supporting a web-based site for hosting images of certificates stamped on spray-treated wood surfaces, and other certification documents, and (ii) mobile smart-phones used to capture digital photographs and video recording of spray-treated wood-framed building sections during the on-site fire-protection spray process supported using mobile GPS-tracked CFIC-liquid spray systems, and uploading the captured digital images to the data center, for each spray treatment project, so that insurance companies, builders, and other stakeholders can review such on-site spray completion certifications, and other information relating to the execution and management (e.g. logistics) of such fire-protection spray-treatment projects during the building construction phase of wood-framed buildings;

FIG. 9 is perspective view of a mobile client computing system used in the system shown in FIG. 8, supporting a mobile application installed on the mobile computing system for the purpose of tracking and managing projects involving on-site clean fire inhibiting chemical (CFIC) liquid spray treatment of wood-framed buildings during the construction phase so as to ensure Class-A fire-protection of the wood employed therein;

FIG. 9A is a system diagram for the mobile client computing system shown in FIG. 56A, showing the components supported by each client computing system;

FIG. 9B is an exemplary wire frame model of a graphical user interface of a mobile application configured for use by building/property owners, insurance companies, and other stakeholders, showing a menu of high-level services supported by the system network of the present invention;

FIG. 9B1 is an exemplary wire frame model of a graphical user interface of the mobile application configured for use by building/property owners, insurance companies, and other stakeholders showing receipt of new message (via email, SMS messaging and/or push-notifications) relating to building status from messaging services supported by the system network of the present invention;

FIG. 9B2 is an exemplary wire frame model of a graphical user interface of the mobile application configured for use by building/property owners, insurance companies, and other stakeholders to update building profile using profile services supported by the system network of the present invention;

FIG. 10 is an exemplary wire frame model of a graphical user interface of the mobile application showing a high-level menu of services configured for use by on-site fire-protection spray administrators and technicians supported by the system network of the present invention;

FIG. 10A is an exemplary wire frame model of a graphical user interface of the mobile application configured for use by on-site fire-protection spray administrators and technicians to send and receive messages (via email, SMS messaging and/or push-notifications) with registered users, using messaging services supported by the system network of the present invention;

FIG. 10B is an exemplary wire frame model of a graphical user interface of the mobile application configured for use by on-site fire-protection spray administrators and technicians to update a building information profile using the building profile services supported by the system network of the present invention;

FIG. 10C is an exemplary wire frame model of a graphical user interface of the mobile application configured for use by on-site fire-protection spray administrators and technicians to review a building spray-based fire-protection project using services supported by the system network of the present invention;

FIG. 10D is an exemplary wire frame model of a graphical user interface of the mobile application configured for use by on-site fire-protection spray administrators and technicians to review the status of any building registered with the system network using services supported by the system network of the present invention;

FIGS. 11A and 11B, taken together, set forth a flow chart describing the primary steps involved in carrying out the method of verifying and documenting on-site spray-applied Class-A fire-protection over wood-framed buildings during construction;

FIG. 12A is a schematic representation of an architectural floor plans for a wood-framed building scheduled to be sprayed with CFIC liquid to provide exposed interior surfaces with Class-A fire-protection;

FIG. 12B is a schematic representation of architectural floor plans for a wood-framed building, with a section marked up by the builder, and scheduled to be sprayed with CFIC liquid to provide Class-A fire-protection;

FIG. 12C is a schematic representation of marked-up architectural floor plans indicating a completed section that has been sprayed with CFIC liquid to provide exposed interior surfaces with Class-A fire-protection;

FIG. 13 is a schematic representation of a wood-framed door panel showing the studs and header above a doorway, on which the barcoded/RFID-tag encoded inspection checkpoint of the present invention, realized on a piece of thin flexible plastic material and supporting a barcode symbol and RFID-tag encoded to the spray project at hand, and bearing printed certifications by a spray technician and spray supervisor, and optionally by the building site superintendent shown in greater detail in FIG. 14;

FIG. 14 is a schematic representation of the barcoded/RFID-tag encoded inspection checkpoint shown in FIG. 13, with integrated certifications by spray technician liquid and spray supervisor, and optionally, the building site superintendent; and

FIG. 15 is a flow chart describing the primary steps of the method of qualifying real property for reduced property insurance, based on verified on-site spraying of the exposed interior surfaces of wood-frame buildings with clean fire inhibiting chemical (CFIC) liquid during the construction stage of the building, using the system network of the present invention.

FIG. 16 is a schematic representation of a mass timber building under construction, in which the early building fire-outbreak/arson-attack detection and elimination system of the present invention shown in FIGS. 3 through 25 is embodied, including a global navigation satellite system (GHSS) with a RTK (real-time kinematic) reference station for high-resolution GPS positioning, a cellular phone and SMS messaging system, a wireless internet gateway, and a thermally imaging drone docking and charging airport mounted above the ground surface;

FIG. 16A is a perspective view of a room completed within the mass timber building under construction, after all of its wood has been Class-A fire-protected using the clean fire inhibiting chemical (CFIC) liquid and spray methods and apparatus disclosed in Applicant's copending U.S. patent application Ser. No. 15/829,914 filed Dec. 2, 2018, and Ser. No. 15/866,456 filed Jan. 9, 2018 incorporated herein by reference, and showing the AI-driven/VR-controllable thermal-imaging fire seeking and suppressing robot system of the present invention ready to respond to a fire-outbreak or arson-attack;

FIG. 17 shows the early building fire-outbreak/arson-attack detection and elimination system of the present invention deployed across a portfolio of wood-framed and mass-timber buildings under construction, wherein within each of which these wood framed buildings, various wireless subsystems and devices are installed and deployed, comprising (i) a wireless network of fire outbreak thermal imaging sensors, (ii) VR-guided fire suppressing robot systems, (iii) VR-enabled control stations for remotely controlling the operation of VR-guided fire suppressing robot systems during fire suppression operations, (v) unmanned thermal imaging aircraft systems (i.e. drones) having high-resolution thermal-imaging digital video image capturing and transmission capabilities, wherein all such subsystems being integrated with and in communication with the data center and internet (TCP/IP) infrastructure of the building intelligence collection, processing and information management system of the present invention, and are tracked in real-time using a GNSS referencing system;

FIG. 18 is a schematic diagram illustrating the flow of various streams of intelligence (i.e. information) gathered by the communication, application and database servers in the data center of the early building fire-outbreak/arson-attack detection and elimination system of the present invention, from the various subsystems that collect building intelligence, including, for example, building fire-outbreak sensing systems, unmanned thermal imaging aircraft systems (i.e. drones), unmanned fire fighting robot systems, hand-held VR-enabled robot navigation and control systems, and weather intelligence servers (e.g. weather reporting and forecasting services);

FIG. 19A is a high-level network diagram showing the primary components of system network supporting the early building fire-outbreak/arson-attack detection and elimination system of the present invention reflected in FIG. 1 including a building intelligence collection, analysis and response network embedded within each wood-framed or mass timber building under construction, and each comprising client and server systems interconnected therewith via TCP/IP, to the data center of the system network, supporting cellular phone and SMS messaging systems deployed on the Internet, Web-enabled client machines (e.g. mobile computers, smartphones, laptop computers, workstation computers, etc.), email server systems, hand-held VR-enabled control stations for remotely controlling VR-navigated and controlled fire fighting robot systems deployed inside the buildings;

FIG. 19B is a high-level network diagram showing the various client systems and users thereof connected to the system network supporting the early building fire-outbreak/arson-attack detection and elimination system of the present invention reflected in FIG. 1 including, for example, (i) Web-enabled client machines (e.g. mobile computers, smartphones, laptop computers, workstation computers, etc.), (ii) VR-enabled control stations for remotely controlling VR-navigated and controlled fire fighting robot systems deployed inside wood-framed or mass timber buildings under construction, (iv) VR-enabled control stations for remotely controlling VR-navigated and controlled thermal-imaging aircraft systems deployed about specified buildings under construction;

FIG. 20A is a schematic network diagram illustrating in greater detail the wireless network of passive infra-red (PIR) thermal-imaging fire outbreak and arson attack sensors deployed on a wood-framed or mass timber building under construction, illustrating the use of passive infra-red (PIR) thermal-imaging sensors connected together in a wireless mess mesh implemented using conventional IEEE 802.15.4-based networking technologies to interconnect these wireless subsystems into subnetworks and connect these subnetworks to the internet infrastructure of the system of the present invention;

FIG. 20B is a perspective view of a wireless passive infra-red (PIR) thermal-imaging fire-outbreak and arson-attack sensors used in wireless thermal-imaging fire-outbreak and arson-attack detection network supporting the early building fire-outbreak/arson-attack detection and elimination system of the present invention;

FIG. 20C1 is schematic representation of the long-range optics supported within the wireless PIR thermal-imaging fire outbreak and arson attack sensing module of FIG. 20B, along with GPS-tracking and GPS/time/date-stamping, for monitoring narrow areas including corridors for thermal activity and motion;

FIG. 20C2 is schematic representation of the curtain optics supported within wireless PIR thermal-imaging fire outbreak and arson attack sensing module of FIG. 20B, along with GPS-tracking and GPS/time/date-stamping, for monitoring possible intrusion locations for thermal activity and motion;

FIG. 20C3 is schematic representation of the area optics supported within the wireless PIR thermal-imaging fire outbreak and arson attack sensing module of FIG. 20B, along with GPS-tracking and GPS/time/date-stamping, for monitoring particular areas with specific ranges for thermal activity and motion;

FIG. 20D is a schematic block diagram showing an illustrative embodiment or realization of the wireless PIR thermal-imaging fire-outbreak and arson attack sensor used in the early building fire-outbreak/arson-attack detection and elimination system of the first illustrative embodiment, wherein various components are arranged and configured about a microprocessor and flash memory (i.e. control subsystem), including passive infra-red (PIR) thermal imaging sensors, a GPS antenna, a GPS signal receiver, voltage regulator, an Xbee antenna, an Xbee radio transceiver, a voltage regulator, an external power connector, a charge controller, a battery, thermistors, a power switch, a voltage regulator, external and internal temperature sensors, power and status indicator LEDs, programming ports, a digital/video camera, and other sensors, as shown;

FIG. 21A is a perspective view of an airborne/flying unmanned IR thermal-imaging drone subsystem deployed in the early building fire-outbreak/arson-attack detection and elimination system, comprising an aircraft body housing four vertically-mounted symmetrically arranged propeller-type rotors, supporting vertical take off (VTO) and pitched flight over buildings under construction while (i) measuring the thermal profile of fires burning in a building under construction, and (ii) capturing digital video images within the field of view (FOV) of its onboard camera subsystem during its course of travel, thereby collecting information for processing and generation of GPS-indexed time-stamped fire thermal profile maps of the building under construction including before, during and after fire outbreaks and arson attacks, in accordance with the principles and teachings of the present invention;

FIG. 21B is a system block diagram for the unmanned thermal imaging drone aircraft system of the present invention PIR thermal-imaging subsystem, a flight/propulsion subsystem enabling vertical take off (VTO) flight using multi-rotor systems, a collision avoidance subsystem, an inertial navigation & guidance subsystem, a digital imaging (i.e. video camera) subsystem, a data communication subsystem, an altitude measurement and control subsystem, an auto-pilot subsystem, a GPS navigation subsystem, and a control subsystem for controlling and/or managing the other subsystems during system operation;

FIG. 21C is a schematic representation of the system the unmanned thermal imaging drone aircraft system shown in FIGS. 21A and 21B, comprising a number of subsystems including a thermal-imaging camera subsystem, a flight/propulsion subsystem enabling vertical take off (VTO) flight using multi-rotor systems, a collision avoidance subsystem, an inertial navigation & guidance subsystem, a digital imaging (i.e. video camera) subsystem, a data communication subsystem, an altitude measurement and control subsystem, thermal profiling subsystems, an auto-pilot subsystem, a GPS navigation subsystem, and a control subsystem for controlling and/or managing the other subsystems during system operation;

FIG. 22A is a perspective enlarged view of the wood-framed building under construction shown in FIG. 1, showing a sheltering system for the thermal-imaging drones of the present invention, shown arranged in its closed mode, with its hinged housing portions closed about its unmanned thermal imaging drone aircraft supported on its landing support platform;

FIG. 22B is a perspective enlarged view of the building shown in FIG. 1, showing the thermal imaging drone sheltering dome system arranged in its open mode, with its hinged housing portions opened and removed away from the unmanned thermal imaging drone aircraft supported on its landing support platform;

FIG. 22C is a perspective enlarged view of the building shown in FIG. 1, showing the thermal imaging drone sheltering dome system arranged in its open mode, with the unmanned thermal-imaging drone aircraft flying above the wood-framed building in which an arson fire is burning;

FIG. 23A is a first perspective view of the AI-guided/VR-navigated thermal-imaging fire seeking and suppressing robot system of the present invention, showing its tanker style body containing a supply of clean anti-fire (AF) liquid (e.g. Hartindo AF31 anti-fire liquid), spray nozzle gun controlled by thermal-images captured and analyzed in real-time to seek, find, track and suppress fire outbreaks and arson strikes within the wood-framed building, in accordance with the principles of the present invention;

FIG. 23B is a second perspective view of the AI-guided/VR-navigated thermal-imaging fire seeking and suppressing robot system shown in FIG. 23A;

FIG. 24 is a third perspective view of the AI-guided/VR-navigated thermal-imaging fire seeking and suppressing robot system shown in FIG. 23A, show in operation eliminating a detected fire outbreak or arson strike within the interior of a wood-framed or mass timber building being defended using the Class-A fire protection methods described in FIGS. 3A through 15, wherein the spray nozzle is automatically tracked onto the blazing arson fire and spraying a field-constrained stream of AF liquid to eliminate the thermally-tracked fire in an early manner inside the defended building;

FIG. 25A is a perspective view of the thermal-imaging guided (or VR-guided) fire seeking and suppressing robot system of the present invention depicted in FIGS. 23A, 23B, 24, showing its anti-fire (AF) liquid spraying fire suppression tool mounted to its front end, as well as being fully equipped with side, front and rear navigational camera systems, side, front and rear ranging sensors, a GPS receiver, RTK antenna, a 900 MHZ antenna, and a refuel/recharging port mounted in the rear of the system, including digital video camera systems providing field of views (FOVS) in the front and rear of the robotic vehicle, and having multi-band wireless radio control and communications, GPS-supported navigation and collision avoidance capabilities;

FIG. 25B is a block subsystem diagram for the AI-guided/VR-navigated fire seeking and suppressing robot system of FIGS. 24 and 25A, shown comprising a thermal imaging subsystem, a propulsion/drive subsystem, collision avoidance subsystem, IR digital camera subsystems providing various (fields of views (FOVs), IR LED-based illumination subsystems for illuminating these FOVs, a data communication subsystem, a temperature & moisture measurement subsystem, a VR-guided and auto-pilot subsystem, a GPS navigation subsystem, anti-fire liquid supply and spraying subsystem, and a control subsystem for controlling and/or managing the operation of these subsystems during system operation, as well as allowing the vehicle to be safely operated by a human operator remotely situated in front a VR-guided workstation, wearing VR display goggles or viewing a stereoscopic-display panel;

FIG. 26 is a schematic representation illustrating the thermally-imaging fire seeking and suppressing robot system of the present invention being guided and controlled by an artificial intelligence (AI) system remotely connected to the wireless network and having full access to rich intelligence continuously collected by thermal and multi-spectral imaging drones, and constructed by powerful AI processing algorithms, and stored in databases maintained within system network of the present invention, for guiding automatically deployed thermal-imaging fire seeking and suppression robots, tasked with early thermal-tracking and elimination of fire outbreaks and arson strikes/attacks within a wood-framed or mass timber building;

FIG. 27 is a schematic representation illustrating the thermally-imaging fire seeking and suppressing robot system of the present invention being guided and controlled by a virtual reality (VR) navigation and control system (e.g. workstation or portable device) remotely connected to the wireless network and operated by a human being in a remote location trained to guide and control automatically or semi-automatically deployed thermal-imaging fire seeking and suppression robots, tasked with early thermal-tracking and elimination of fire outbreaks and arson strikes/attacks within a wood-framed or mass timber building, using anti-fire (AF) liquid spray streams directed onto a thermally-tracked building fire;

FIG. 28 is a block subsystem diagram of the virtual reality (VR) navigation and control station of the present invention illustrated in FIG. 27, comprising a stereoscopic 3D display subsystem, a network communication subsystem, data keyboard and mouse, 3D controllers, motion trackers (e.g. head tracker, eye tracker, face-tracker, and 3D gloves), an audio subsystem, VR control console subsystem, a RAID subsystem for local storage, and processor and memory subsystem;

FIG. 29 is a perspective view of a hand-held mobile VR-navigational and control system for remotely controlling the thermally imaging fire seeking and suppressing robot system shown in FIGS. 27 and 28;

FIG. 30 is a perspective view of a completed section of a wood-framed building that has been defended using clean fire inhibiting chemical (CFIC) liquid using the Class-A fire-protection spray methods of the present invention disclosed in FIGS. 2 through 15, and installation of the early fire outbreak and arson strike elimination system of the present invention, including deployment of one or more AI-guided or VR-navigated thermal-imaging fire seeking and suppressing robot systems of the present invention shown in FIGS. 23A through 25B;

FIG. 31 is a perspective view of a completed section of a mass timber building that has been defended using clean fire inhibiting chemical (CFIC) liquid using the Class-A fire-protection spray methods of the present invention disclosed in FIGS. 2 through 15, and installation of the early fire outbreak and arson strike elimination system of the present invention, including deployment of one or more AI-guided or VR-navigated thermal-imaging fire seeking and suppressing robot systems of the present invention shown in FIGS. 23A through 25B;

FIG. 32 is a first perspective view of the AI-guided/VR-navigated thermal-imaging fire seeking and suppressing drone aircraft system of the present invention, showing its compact tanker body containing a supply of clean anti-fire (AF) liquid (e.g. Hartindo AF31 anti-fire liquid), spray nozzle gun controlled by thermal-images captured and analyzed in real-time to seek, find, track and suppress fire outbreaks within the wood-framed building,

FIG. 32A is a second perspective view of the AI-guided/VR-navigated thermal-imaging fire seeking and suppressing robot system, shown in operation eliminating a detected fire outbreak or arson strike within the interior of a wood-framed or mass timber building being defended using the Class-A fire protection methods described in FIGS. 3A through 15, wherein the spray nozzle is automatically tracked onto the blazing arson fire and spraying a field-constrained stream of AF liquid to eliminate the thermally-tracked fire in an early manner inside the defended building;

FIG. 33A is high level block diagram of the AI-guided/VR-navigated thermal-imaging fire seeking and suppressing drone aircraft system of the present invention depicted in FIGS. 32 and 32A, showing its anti-fire (AF) liquid spraying fire suppression tool, a GPS receiver, RTK antenna, a 900 MHZ antenna, and a refuel/recharging port, digital video camera systems providing field of views (FOVS), multi-band wireless radio control and communications, GPS-supported navigation and collision avoidance capabilities;

FIG. 33B is a block subsystem diagram for the AI-guided/VR-navigated fire seeking and suppressing robot system of FIGS. 32, 32A and 33A, shown comprising a GPS-tracked and remotely-monitored AF chemical liquid spray control subsystem, a micro-computing platform or subsystem interfaced with the GPS-tracked and remotely-monitored AF chemical liquid spray control subsystem by way of a system bus, a wireless communication subsystem interfaced to the micro-computing platform via the system bus, and a vehicular propulsion and navigation subsystem employing propulsion subsystem, and AI-driven or VR-assisted navigation sub system;

FIG. 34 is a flow chart describing the primary steps involved in the VR-guided method of detecting and suppressing fire outbreaks and arson strikes inside a wood-framed building under construction defended by the Class-A fire-protection methods disclosed in FIGS. 2 through 13, wherein (a) AI-guided/VR-navigated thermal-imaging fire seeking and suppression robot system are deployed within a defended wood-framed building under construction, and at least one VR-based navigation and control workstation or mobile device is configured with the system network, (b) a fire outbreak or arson attack condition message is received from the system network, and (c) the VR-guided robot navigation and control workstation is used to remotely control the VR-guided fire seeking and suppressing robot system within the wood-framed building under construction, and eliminate the identified fire outbreak/arson attack condition specified in the fire outbreak condition message; and

FIG. 35 is a method of defending a wood-framed and mass timber buildings under construction using automated thermal-imaging fire seeking and suppressing robot systems, comprising the steps of (a) using a wireless thermal imaging fire outbreak sensor network and/or roaming thermal-imaging fire seeking robot to detect and locate afire outbreak or arson attack in a wood-framed building under construction, (b) in response to automated detection of fire outbreak or arson attack by the wireless fire outbreak sensor network or roaming thermal imaging fire seeking robot, generate a fire suppression command to an AI-guided or VR-guided thermal-imaging fire seeking and suppressing robot, and (c) sending fire surveillance command to thermally-imaging drone aircraft so that thermal images are captured of the wood-framed building to collect intelligence of thermal maps of the wood-frame building and providing the same to local fire department and chief called to the scene of the fire.

### DETAILED DESCRIPTION OF THE ILLUSTRATIVE EMBODIMENTS OF THE PRESENT INVENTION

Referring to the figures in the accompanying Drawings, the illustrative embodiments of the system and will be described in great detail, wherein like elements will be indicated using like reference numerals.

### Overview on the Early Building Fire-Outbreak and Arson-Attack Detection and Elimination System of the Present Invention

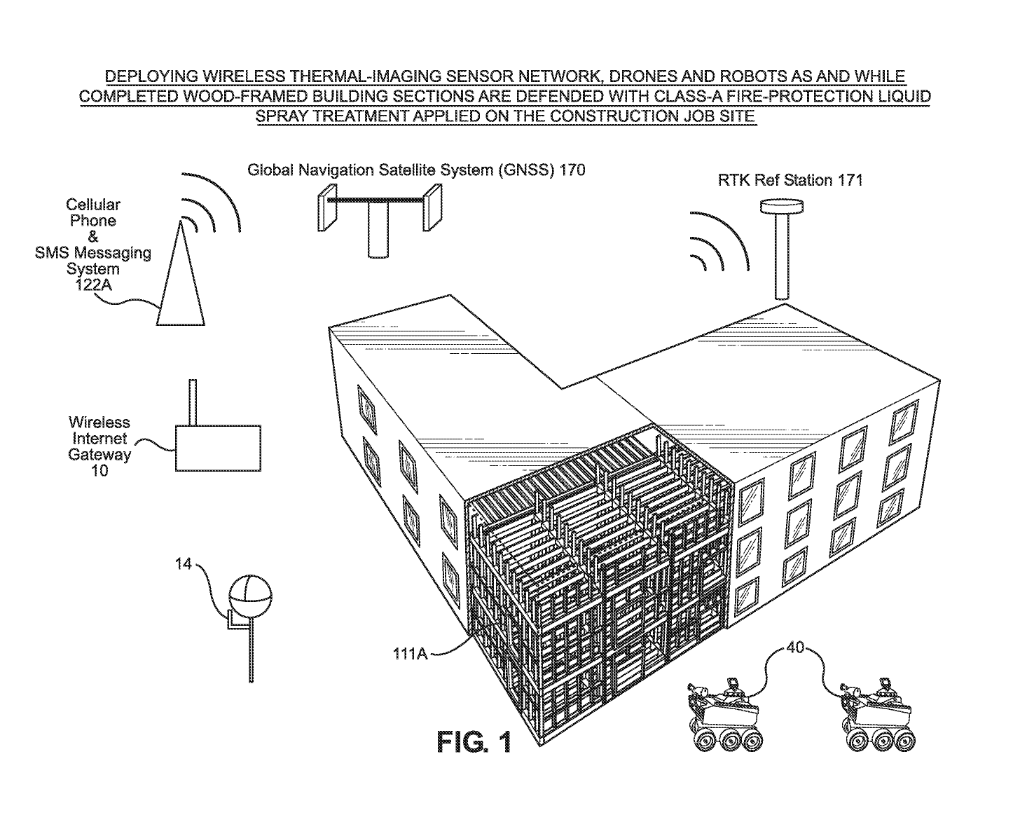

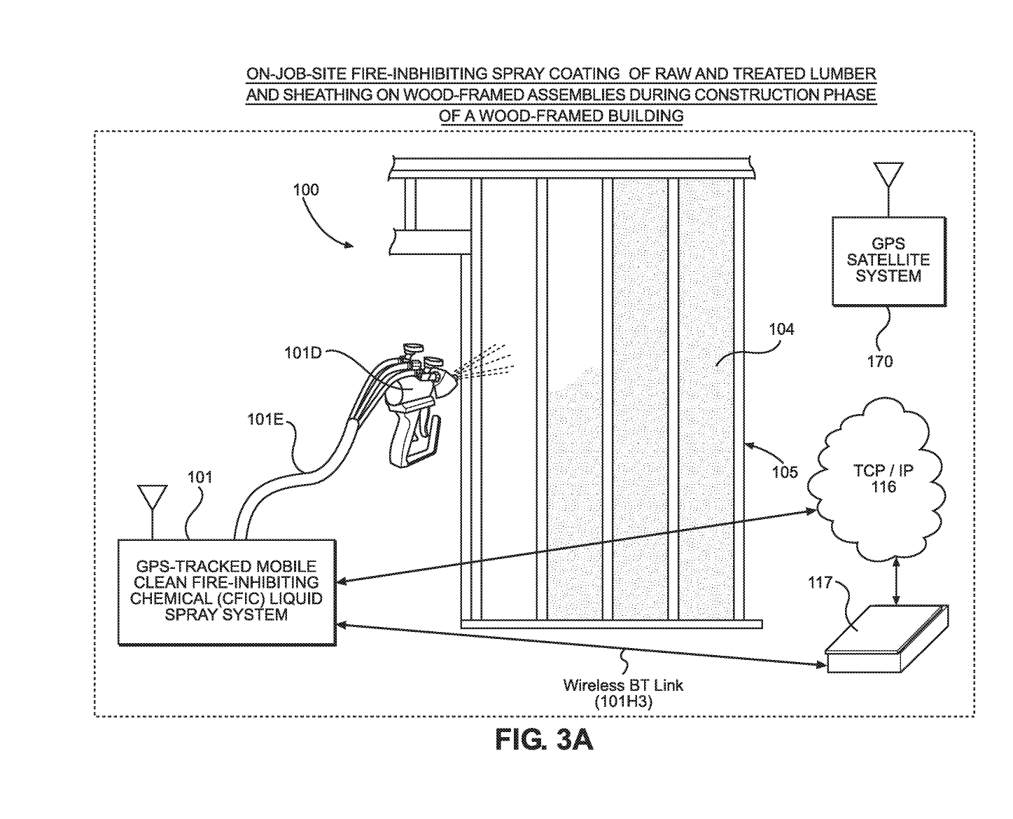

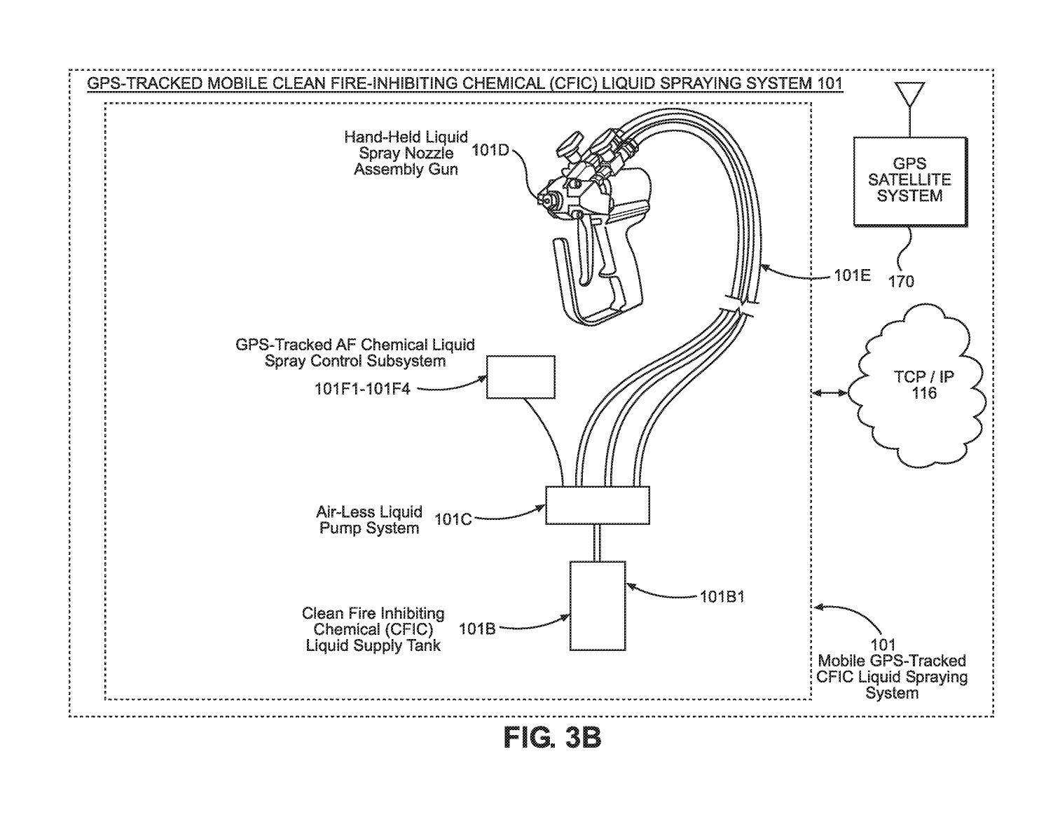

FIG. 1 shows a wood-framed building under construction, in which the early building fire-outbreak/arson-attack detection and elimination system of the present invention shown in FIGS. 3 through 25 is embodied. In general, this system 1 will include some basic high level components to construct a global infrastructure, within which to integrate various subsystems which will be described hereinafter. These basic high level components include: a global navigation satellite system (GHSS) 170 with a RTK (real-time kinematic) reference station(s) 171 for high-resolution GPS positioning, a cellular phone and SMS messaging system 114, a wireless internet gateway 10, and one or more thermally-imaging drone docking and charging airport 14 mounted above the ground surface, as shown.

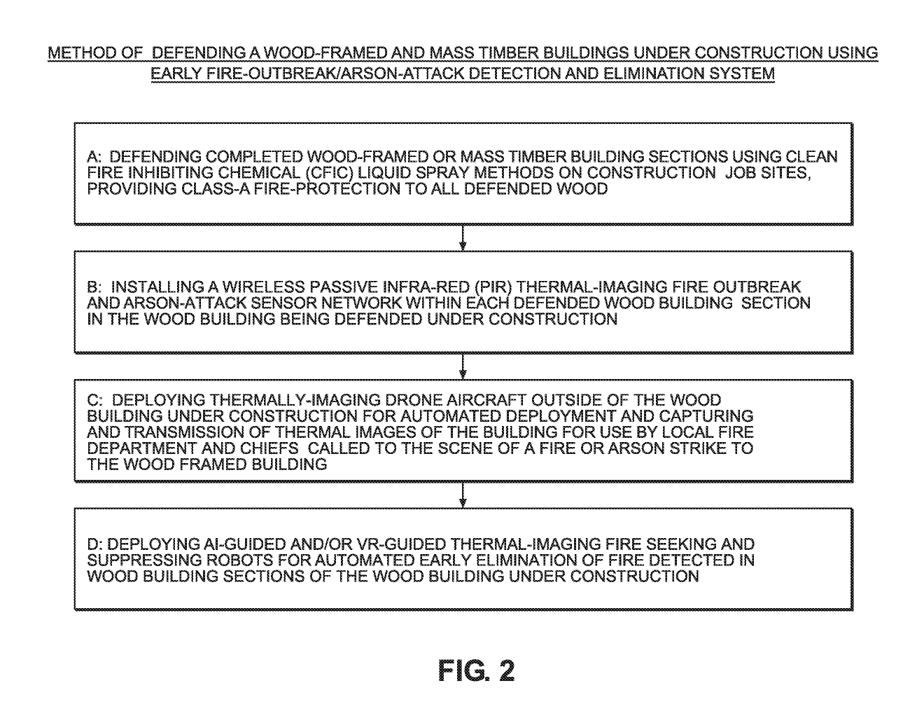

FIG. 2 describes the primary steps involved in practicing the method of defending a wood-framed and mass timber buildings under construction using early fire-outbreak/arson-attack detection and elimination system of the present invention.

As shown in FIG. 2, the method comprises the following steps: (a) defending completed wood-framed or mass timber building sections using clean fire inhibiting chemical (CFIC) liquid spray methods on construction job sites, providing Class-A fire-protection to all defended wood; (b) installing a wireless passive infra-red (PIR) thermal-imaging fire outbreak and arson-attack sensor network 13N within each defended wood building section in the wood building 111A, 111B being defended under construction; (c) deploying thermally-imaging drone aircraft vehicles 20 outside of the wood building under construction for automated deployment and capturing and transmission of thermal images of the building when a fire breaks out or arson strikes, for use by local fire department and chiefs when called to the scene of a fire or arson strike to the wood framed building; (d) deploying AI-guided and/or VR-guided thermal-imaging fire seeking and suppressing robots 40 for automated early elimination of fire detected in wood building sections of the wood building under construction; and (e) deploying AI-guided and/or VR-guided flying thermal-imaging fire seeking and suppressing drone aircraft 60 for automated early elimination of fire detected in wood building sections of the wood building under construction.

Once this system is installed, the follow method is practiced in accordance with the spirit of the present invention to defend wood-framed and mass timber buildings under construction using automated thermal-imaging network 13N, and AI and VR-guided fire seeking and suppressing robot and drone systems.

As shown in FIG. 36, the method comprises: (a) using a wireless thermal imaging fire outbreak sensor network, in combination with roaming thermal-imaging fire seeking robots, to detect and locate a fire outbreak or arson attack in a wood-framed building under construction; (b) in response to automated detection of fire outbreak or arson attack by the wireless fire outbreak sensor network or roaming thermal imaging fire seeking robots, automatically generating a fire suppression command to an AI-guided or VR-guided thermal-imaging fire seeking and suppressing robots and drone vehicles; and (c) sending fire surveillance command to thermally-imaging drone aircraft so that thermal images the wood-framed building are automatically captured and this collected intelligence of thermal maps of the wood-frame building are provided to local fire department and chief called to the scene of the fire, to assist in real-time decision support on how best to respond to the particular building fire at hand.

This novel approach and plan for early detection and elimination of fire outbreaks and arson strikes within wood-framed and mass timber buildings is designed to work well in wood-framed and mass timber buildings in which all interior wood has been prior defended using Class-A fire-protection spray methods disclosed in Applicant's copending U.S. patent application Ser. No. 15/829,914 filed Dec. 2, 2017, incorporated herein by reference in its entirety. This novel approach to detecting and responding quickly to fire outbreaks and arson strikes will be appreciated by those skilled in the art of fighting fires in wood-framed buildings, and who understand that time is of the essence when responding to such fire outbreaks and arson strikes, due to the nature of modern wood materials and engineered wood products.

Typically, conventional fighting practices are not sufficiently responsive, and fire-fighting forces are not able to arrive on the scene quickly enough to eliminate fire outbreaks by arson strikes against wood-framed and mass timber building construction projects. In contrast, the approach taught by the present invention will enable a new level of responsiveness and allow construction companies, managers, and local fire departments to work with unprecedented level of efficiency and automation to detect and eliminate fires before they allowed to grow and consume the entire wood-framed building, which often times cost as high as a billion or more dollars. Expectedly, the present invention should provide significant improvements in the way fire outbreaks and arson strikes in wood-framed and mass timber buildings will be detected and eliminated during the construction phase of the building process so as to significantly reduce losses and save human lives.

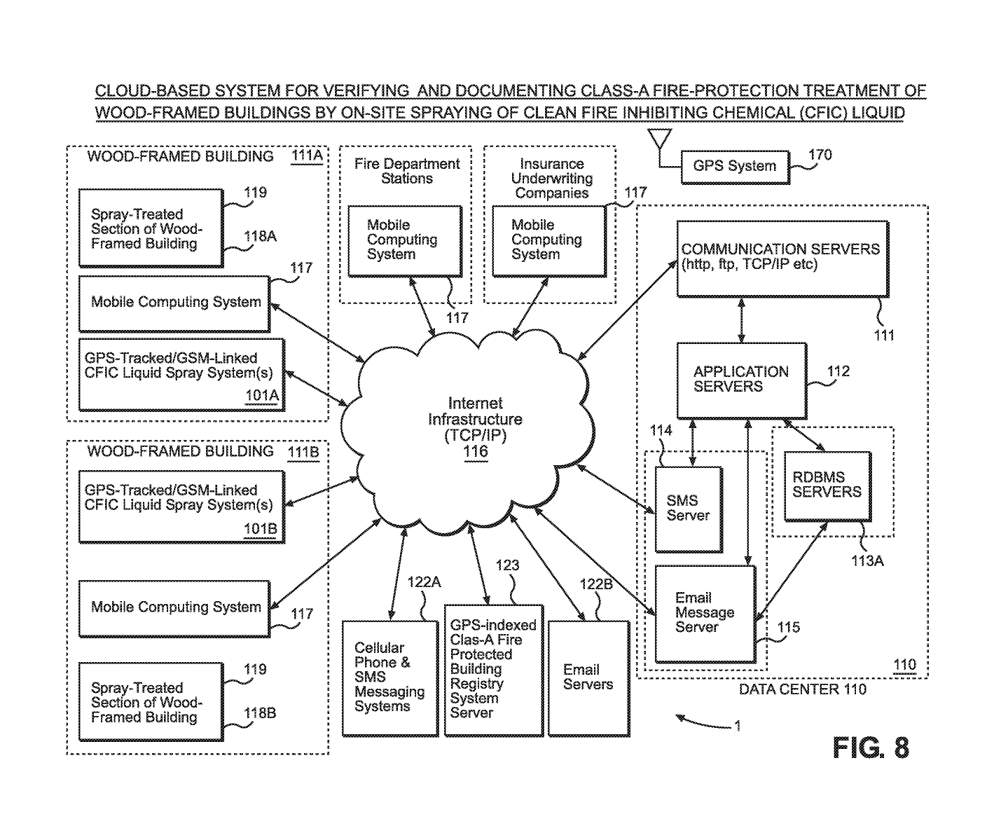

FIG. 3A illustrates the method of and system for the present invention for on-job-site spray-coating clean fire inhibiting liquid chemical (CFIC) liquid over all exposed interior surfaces of raw as well as fire-treated lumber and sheathing used in a completed section of a wood-framed building during its construction phase, disclosed in U.S. patent Ser. No. 15/874,874 filed Jan. 18, 2018, Ser. No. 15/866,456 filed Jan. 9, 2018, Ser. No. 15/866,454 filed Jan. 9, 2018, and Ser. No. 15/829,914 filed Dec. 2, 2017, wherein each said US patent application is incorporated herein by reference. As shown, a GPS-tracked mobile clean fire-inhibiting chemical (CFIC) liquid spraying system 101, and the system network illustrated in FIG. 8, are used to apply and document the spraying of a thin CFIC film or coating over all exposed interior wood surfaces, and thereby provide Class-A fire-protection over all lumber and sheathing used in the wood-framed building construction, along with a complete chain of evidence and documentation to qualify the owner of the Class-A fire-protected wood-framed building for lower fire insurance premiums, and provide local fire departments with valuable building information when fighting fires that may break out in such Class-A fire-protected wood-framed buildings.

FIG. 3B showing the primary components of the air-less liquid spraying system for spraying environmentally-clean Class-A fire-protective liquid coatings, comprising: (i) an air-less type liquid spray pumping subsystem 101C having a reservoir tank 101B for containing a volume of clean fire inhibiting chemical (CFIC) liquid; (ii) a hand-held liquid spray nozzle gun 101D for holding in the hand of a spray-coating technician; and (iii) a sufficient length of flexible tubing, preferably supported on a carry-reel assembly, if necessary, for carrying the CFIC liquid from the reservoir tank of the liquid spray pumping subsystem 101C, to the hand-held liquid spray gun during spraying operations carried out inside the wood-framed building during the construction phase of the building project. This Class-A fire-protection spray method can also be used to spray and protect lumber stockpiles on the construction site to reduce the risk that such lumber material and EWPs will be allowed to burn upon attempted ignition by arson attack or accident.

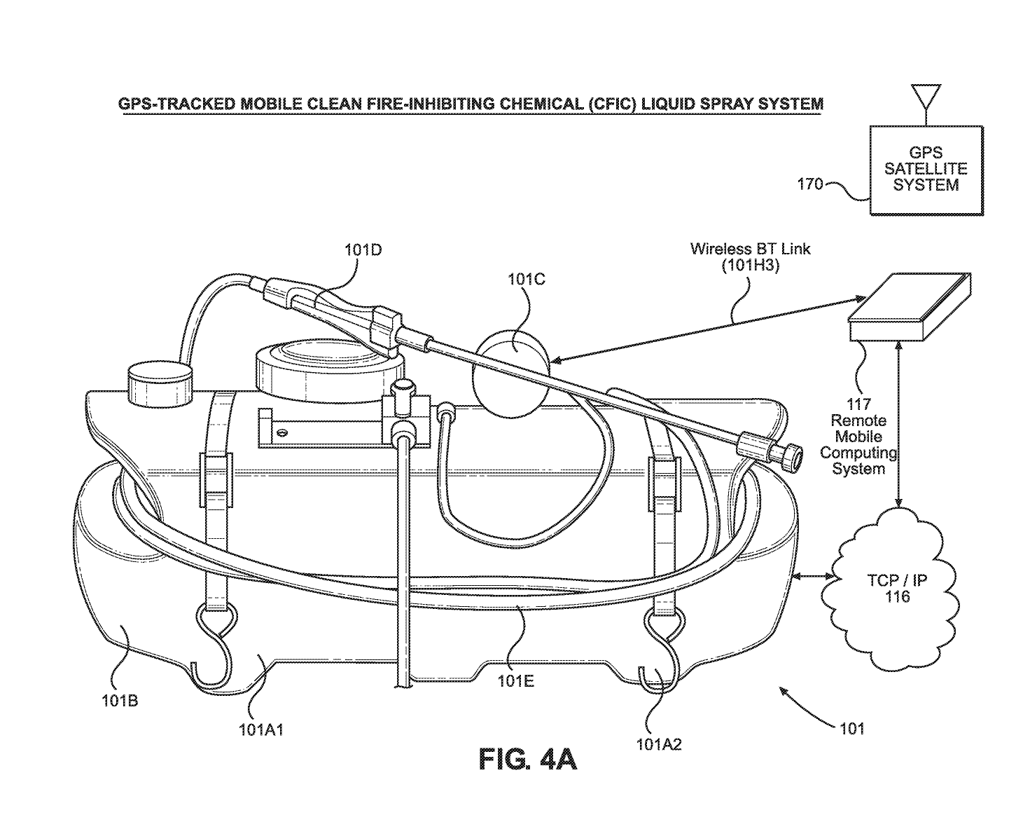

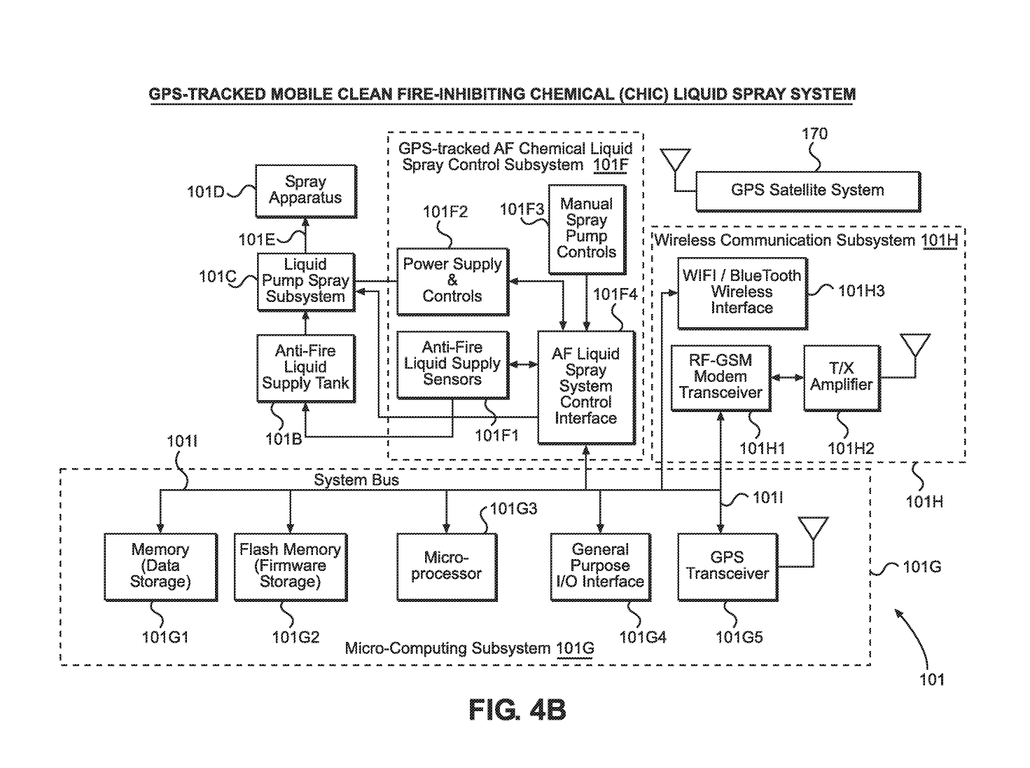

FIG. 4A shows an exemplary embodiment of the mobile GPS-tracked CFIC liquid spraying system of the present invention 101 supported on a set of wheels, with integrated supply tank 101B and rechargeable-battery operated electric spray pump 101C, for deployment at private and public properties having building structures, for spraying the same with CFIC liquid in accordance with the principles of the present invention.

FIG. 4B shows the GPS-tracked mobile CFIC liquid spraying system 101 shown in FIG. 4A, comprising a GPS-tracked and remotely-monitored CFIC liquid spray control subsystem interfaced with a micro-computing platform for monitoring the spraying of CFIC liquid from the system when located at specific GPS-indexed location coordinates, and automatically logging and recording such CFIC liquid spray application operations within the network database system.

As shown in FIG. 4B, the GPS-tracked mobile anti-fire liquid spraying system 101 comprises a number of subcomponents, namely: a GPS-tracked and remotely-monitored AF chemical liquid spray control subsystem 101F; a micro-computing platform or subsystem 101G interfaced with the GPS-tracked and remotely-monitored AF chemical liquid spray control subsystem 101F by way of a system bus 101I; and a wireless communication subsystem 101H interfaced to the micro-computing platform 101G via the system bus 20I. As configured, the GPS-tracked mobile CFIC liquid spraying system 101 enables and supports (i) the remote monitoring of the spraying of CFIC liquid from the system 101 when located at specific GPS-indexed location coordinates, and (ii) the logging of all such GPS-indexed spray application operations, and recording the data transactions thereof within a local database maintained within the micro-computing platform 101G, as well as in the remote network database 9C1 maintained at the data center 110 of the system network 109.

As shown in FIG. 4B, the micro-computing platform 101G comprises: data storage memory 2101G1; flash memory (firmware storage) 2101G2; a programmable microprocessor 2101G3; a general purpose I/O (GPIO) interface 101G4; a GPS transceiver circuit/chip with matched antenna structure 2101G5; and the system bus 101I which interfaces these components together and provides the necessary addressing, data and control signal pathways supported within the system 101.

As shown in FIG. 4B, the wireless communication subsystem 101H comprises: an RF-GSM modem transceiver 101H1; a T/X amplifier 101H2 interfaced with the RF-GSM modem transceiver 101H1; and a WIFI and Bluetooth wireless interfaces 101H3.

As shown in FIG. 4B, the GPS-tracked and remotely-controllable CFIC liquid spray control subsystem 101F comprises: anti-fire chemical liquid supply sensor(s) 101F1 installed in or on the anti-fire chemical liquid supply tank 101B to produce an electrical signal indicative of the volume or percentage of the CFIC liquid supply tank containing CFIC liquid at any instant in time, and providing such signals to the CFIC liquid spray system control interface 101F4; a power supply and controls 101F2 interfaced with the liquid pump spray subsystem 101C, and also the CFIC liquid spray system control interface 101F4; manually-operated spray pump controls interface 101F3, interfaced with the CFIC liquid spray system control interface 101F4; and the CFIC liquid spray system control interface 101F4 interfaced with the micro-computing subsystem 101G, via the system bus 101I. The flash memory storage 101G2 contains microcode that represents a control program that runs on the microprocessor 101G3 and realizes the various GPS-specified CFIC chemical liquid spray control, monitoring, data logging and management (e.g. logistics) functions supported by the system 101.

In the preferred embodiment, the CFIC liquid is preferably Hartindo AF31 Total Fire Inhibitor, developed by Hartindo Chemicatama Industri of Jakarta, Indonesia, and commercially-available from Newstar Chemicals (M) SDN. BHD of Selangor Darul Ehsan, Malaysia, http://newstarchemicals.com/products.html. When so treated, combustible products will prevent flames from spreading, and confine fire to the ignition source which can be readily extinguished, or go out by itself. In the presence of a flame, the chemical molecules in both dry and wet coatings, formed with Hartindo AF31 liquid, interferes with the free radicals (H+, OH−, O) involved in the free-radical chemical reactions within the combustion phase of a fire, and breaks these free-radical chemical reactions and extinguishes the fire's flames.

In general, any commercially-grade airless liquid spraying system may be used and adapted to construct the GPS-tracked mobile system 101 for spraying Class-A fire-protective liquid coatings on wood-framed building construction sites, and practice the method and system of the present invention, with excellent results. Many different kinds of commercial spray coating systems may be used to practice the present invention, and each may employ an electric motor or air-compressor to drive its liquid pump. For purposes of illustration only, the following commercial spray systems are identified as follows: the Xtreme XL™ Electric Airless Spray System available from Graco, Inc. of Minneapolis, Minn.; and the Binks MX412 Air-Assisted/Compressor-Driven Airless Spray System from Carlisle Fluid Technologies, of Scottsdale, Ariz.

Countless on-site locations will exist having various sizes and configurations requiring the on-job-site spray-based fire-protection method of the present invention. FIG. 51A illustrates a first job-site of multi-apartment wood-framed building under construction prepared and ready for clean fire inhibiting chemical spray coating treatment in accordance with the principles of the present invention. FIG. 51B illustrates a second job-site of multi-apartment wood-framed building under construction prepared and ready for clean fire inhibiting chemical spray coating treatment in accordance with the principles of the present invention.

The on-job-site spray method and system involves spraying a clean fire inhibiting chemical (CFIC) liquid on all new construction lumber and sheathing to prevent fire ignition and flame spread. The method also recommends spraying exterior walls or the exterior face of the roof, wall and floor sheathing with CFIC liquid. The method further recommends that factory-applied fire-protective lumber be used on exterior walls, and fire-protected sheathing be used on the exterior face of the roof, wall and floor sheathing, as it offers extra UV and moisture protection. As disclosed herein, there are many different options available to architects and builders to meet such requirements within the scope and spirit of the present invention disclosed herein.

In the illustrative embodiment, Hartindo AF31 Total Fire Inhibitor (from Hartindo Chemicatama Industri of Jakarta, Indonesia http://hartindo.co.id, or its distributor Newstar Chemicals of Malaysia) is used as the CFIC liquid 101C to spray-deposit the CFIC surface coating onto treated wood/lumber and sheathing products inside the wood-framed building under construction. A liquid dye of a preferred color from Sun Chemical Corporation http://www.sunchemical.com can be added to Hartindo AF31 liquid to help the spray technicians visually track where CFIC liquid has been sprayed on wood surfaces during the method of treatment. The clinging agent in this CFIC liquid formulation (i.e. Hartindo AF31 liquid) enables its chemical molecules to cling to the surface of the CFIC-coated wood so that it is quick to defend and break the combustion phase of fires (i.e. interfere with the free radicals driving combustion) during construction and before drywall and sprinklers can offer any defense against fire. However, a polymer liquid binder, available from many manufacturers (e.g. BASF, Polycarb, Inc.) can be added as additional cling agent to Hartindo AF31 liquid, in a proportion of 1-10% by volume to 99-90% Hartindo AF31 liquid, so as to improve the cling factor of the CFIC liquid when being sprayed in high humidity job-site environments. Alternatively, liquid DecTan Chemical from Hartindo Chemicatama Industri, which contains a mixture of vinyl acrylic copolymer and tannic acid, can be used a cling agent as well when mixed the same proportions, as well as an additional UV and moisture defense on exterior applications. These proportions can be adjusted as required to achieve the cling factor required in any given building environment where the spray coating method of the present invention is being practiced. This way, in the presence of a flame, the chemical molecules in the CFIC-coating on the surface of the fire-protected lumber, interfere with the chemical reactions involving the free radicals (H+, OH−, O−) produced during the combustion phase of a fire, and break the fire's chemical reaction and extinguish its flame. This is a primary fire suppression mechanism deployed or rather implemented by the CFIC-coatings deposited on wood surfaces in accordance with the various principles of invention, disclosed and taught herein.

Preparing the Job-Site of a Wood-Framed Building Under Construction for Clean Fire Inhibiting Chemical (CFIC) Liquid Spray Coating Treatment Applied in Accordance with the Principles of the Present Invention

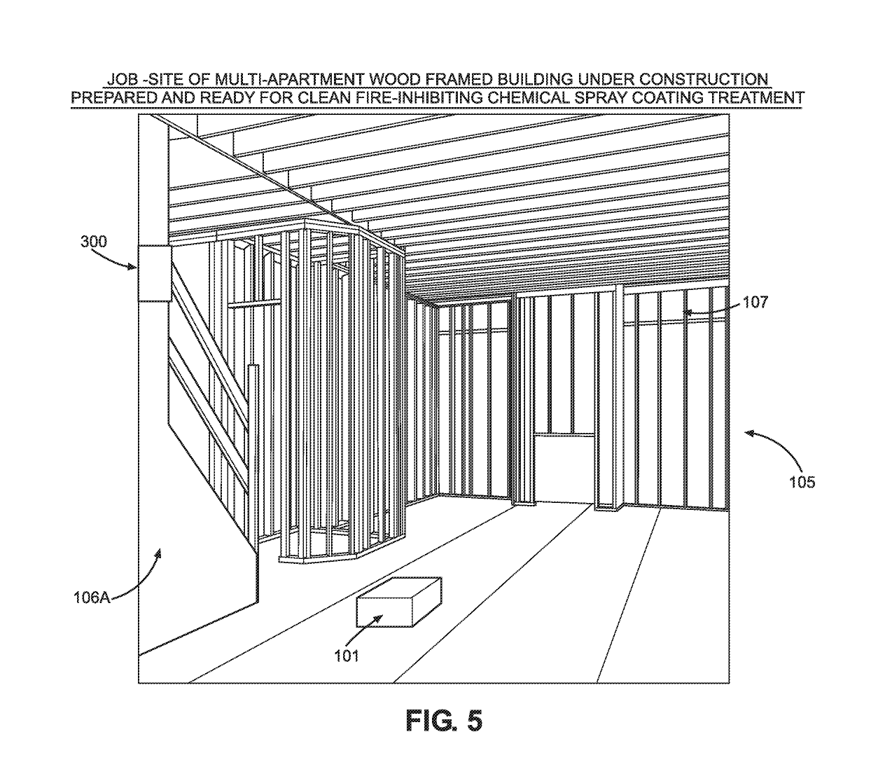

FIG. 5 shows a first job-site of multi-apartment wood-framed building under construction prepared and ready for clean fire inhibiting chemical (CFIC) liquid spray coating treatment applied in accordance with the principles of the present invention.

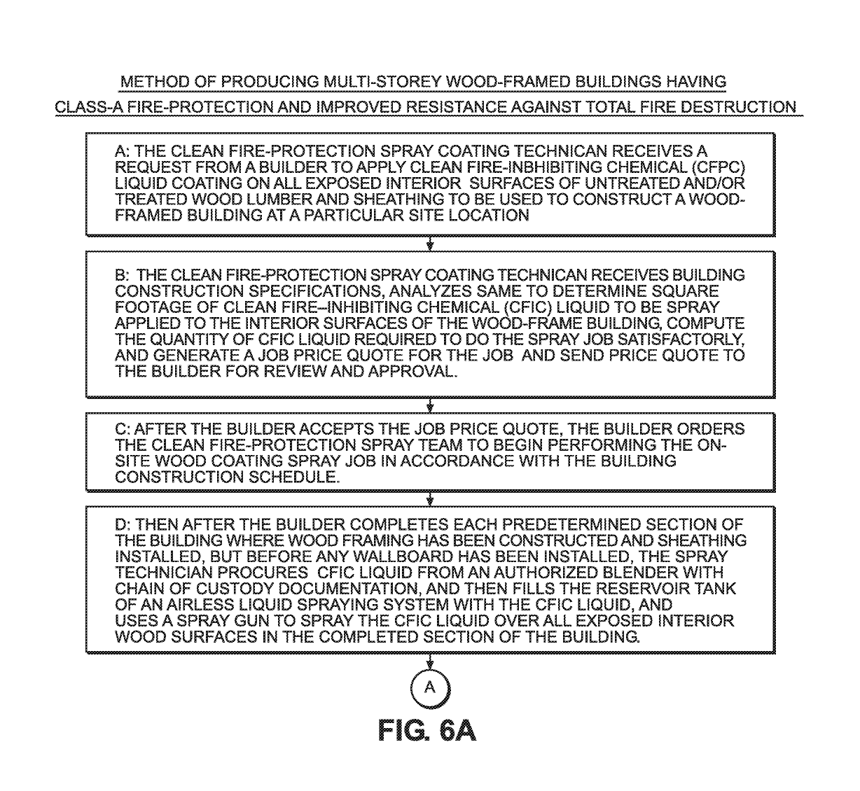

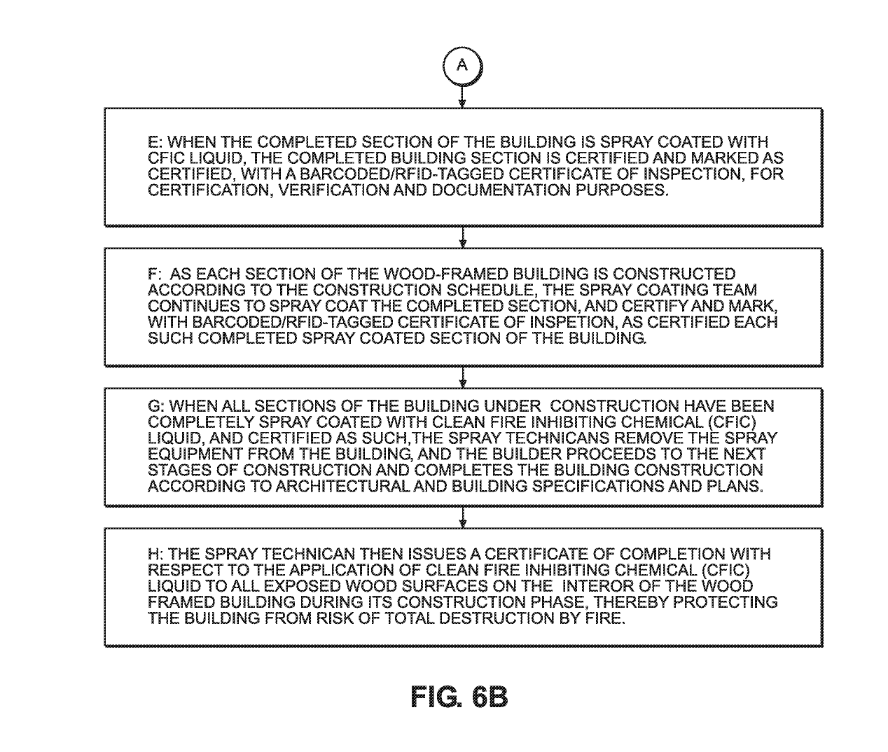

FIGS. 6A and 6B describes the steps carried out when practicing the method of producing Class-A fire-protected multi-story wood-framed buildings having improved resistance against total fire destruction.

As shown in FIGS. 6A and 6B, the method comprising the steps of (a) a fire-protection spray coating technician receives a request from a builder to apply clean fire inhibiting chemical (CFIC) liquid coating on all interior surfaces of the untreated and/or treated wood lumber and sheathing to be used to construct a wood-framed multi-story building at a particular site location; (b) the fire-protection spray coating technician receives building construction specifications, analyze same to determine the square footage of clean fire inhibiting chemical (CFIC) coating to be spray applied to the interior surfaces of the wood-framed building; compute the quantity of CFIC liquid required to do the spray job satisfactorily, and generate a job price quote for the spray job and send to the builder for review and approval; (c) after the builder accepts the job price quote, the builder orders the fire-protection spray coating team to begin performing the on-site wood coating spray job, in accordance with the building construction schedule, so that after the builder completes each predetermined section of the building, where wood framing has been constructed and sheathing installed, but before any wallboard has been installed, clean fire-inhibiting chemical (CFIC) liquid is supplied to an airless liquid spraying system, for spray coating all interior wood surfaces with a CFIC coating; (d) when the section of the building is spray coated with clean fire-protection chemical coating, the section is certified and marked as certified for visual inspection; (e) as each section of the wood-framed building is constructed according to the construction schedule, the spray coating team continues to spray coat the completed section, and certify and mark as certified each such completed spray coated section of the building under construction; (f) when all sections of the building under construction have been completely spray coated with clean fire-inhibiting chemical (CFIC) liquid materials, and certified as such, the spray technicians remove the spray equipment from the building, and the builder proceeds to the next stages of construction and completes the building construction according to architectural and building specifications and plans; and (g) the spray technician then issues a certificate of completion with respect to the application of clean fire inhibiting chemical (CFIC) liquid to all exposed wood surfaces on the interior of the wood-framed building during its construction phase, thereby protecting the building from risk of total destruction by fire.

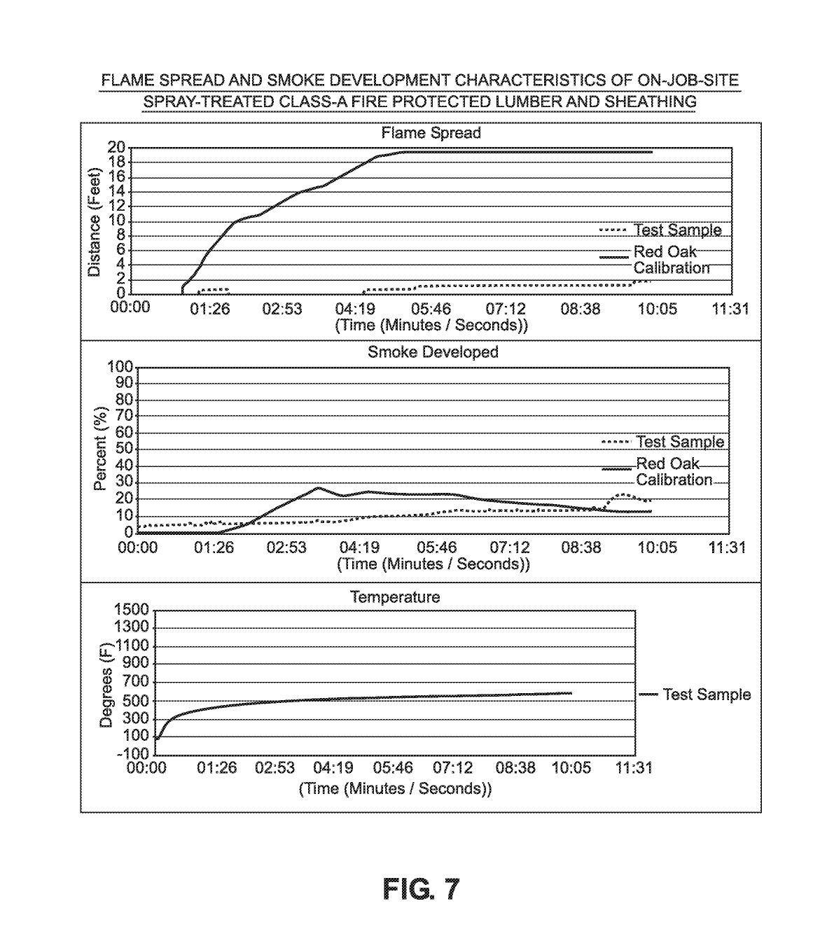

FIG. 7 shows the flame spread and smoke development indices obtained through testing of on-job-site CFIC spray-treated Class-A fire-protected lumber and sheathing produced using the method of the illustrative embodiment described in FIGS. 2 through 13, and tested in accordance with standard ASTM E2768-1.

FIG. 8 shows the Internet-based (i.e. cloud-based) system of the present invention 1 supporting the certification, verification and documenting Class-A fire-protection spray-treatment of a wood-framed building using on-site spraying of a clean fire inhibiting chemical (CFIC) liquid. As shown, the system comprises: (i) a data center 110 with web, application and database servers 111, 112 and 113 for supporting a web-based site for hosting images of certificates stamped on spray-treated wood surfaces, and other certification documents; and (ii) mobile smart-phones 117 used to capture digital photographs and video recording of spray-treated wood-framed building sections during the on-site fire-protection spray process supported using mobile GPS-tracked CFIC-liquid spray systems 101, and uploading the captured digital images to the data center 110, for each spray treatment project, so that insurance companies, builders, and other stakeholders can review such on-site spray completion certifications, and other information relating to the execution and management (e.g. logistics) of such fire-protection spray-treatment projects during the building construction phase of wood-framed buildings.

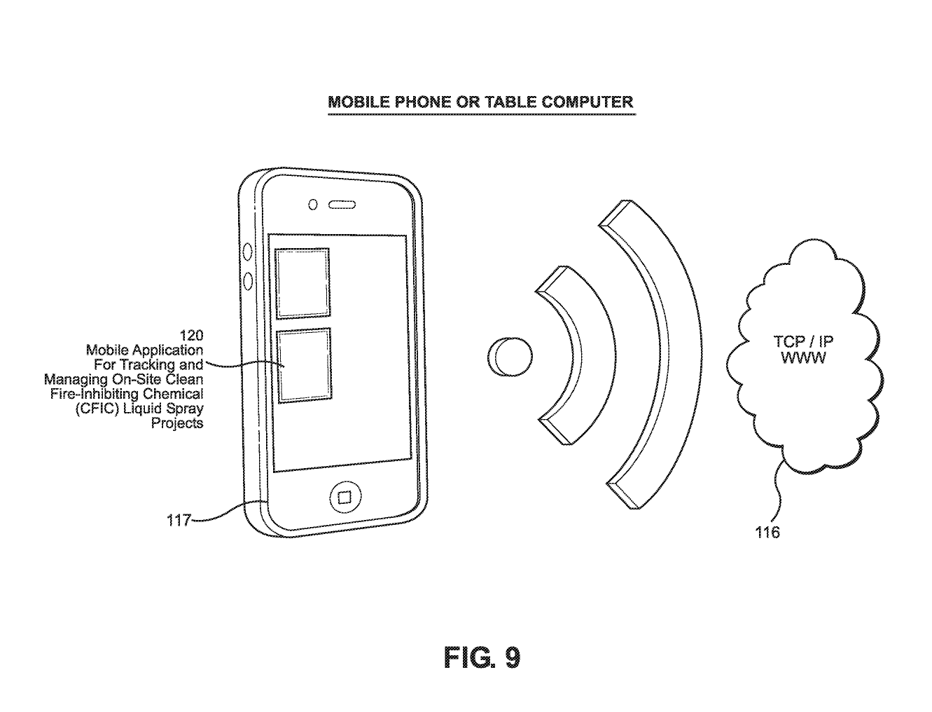

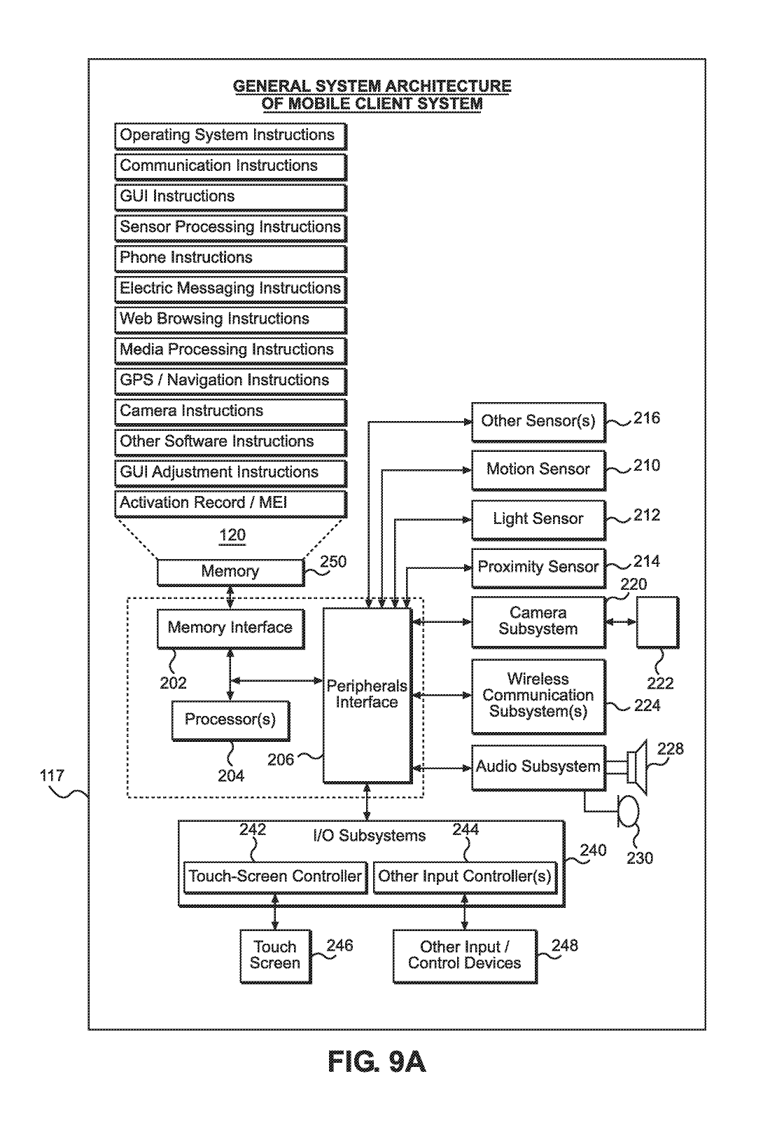

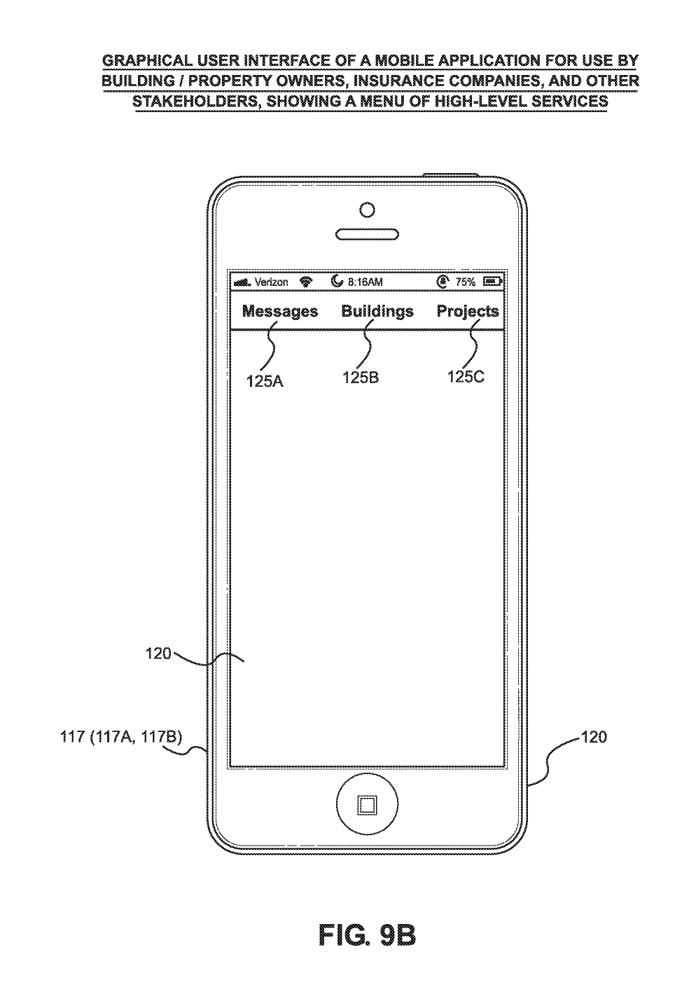

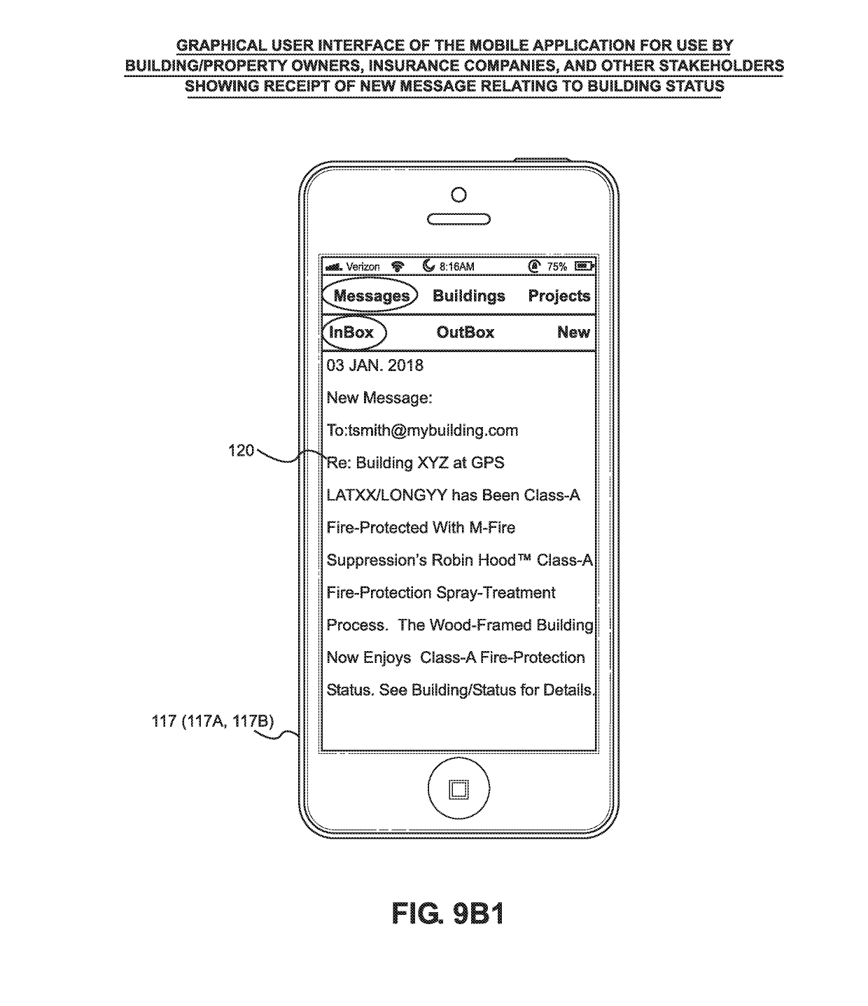

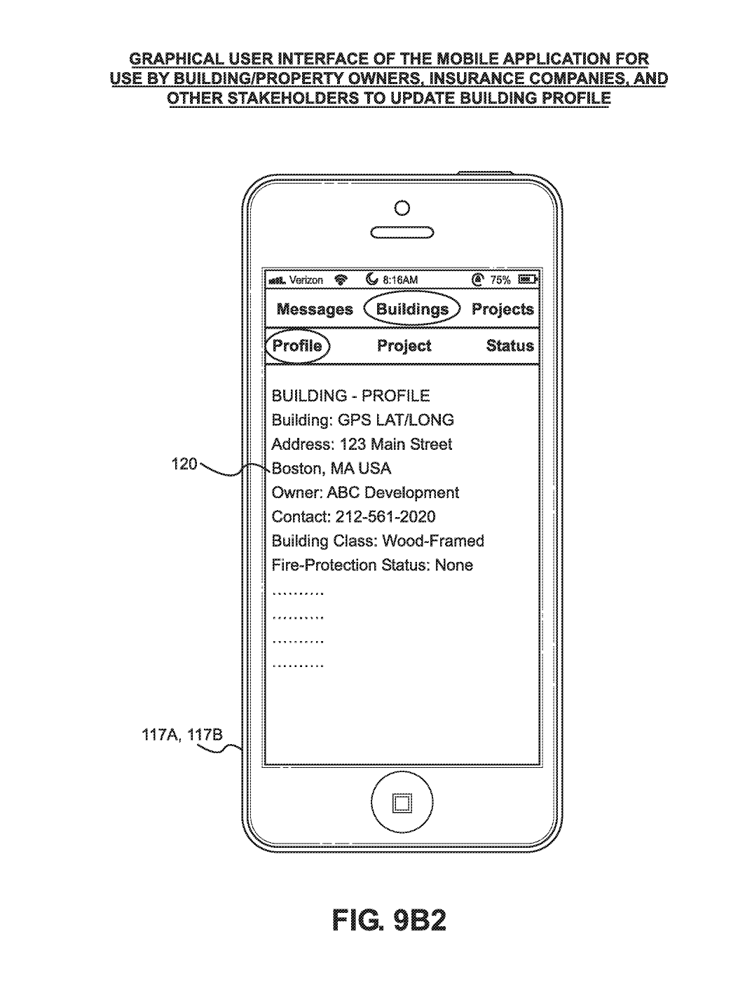

FIG. 9 shows a mobile client computing system 117 used in the system shown in FIG. 8, supporting a mobile application 120 installed on the mobile computing system 117 for the purpose of tracking and managing projects involving on-site clean fire inhibiting chemical (CFIC) liquid spray treatment of wood-framed buildings during the construction phase so as to ensure Class-A fire-protection of the wood employed therein.

FIG. 9A shows the mobile client computing system 117 in FIG. 8, showing the components supported by each client computing system 117.

FIG. 9B shows a graphical user interface of a mobile application 120 configured for use by building/property owners, insurance companies, and other stakeholders, showing a menu of high-level services supported by the system network 1.

FIG. 9B1 shows a graphical user interface of the mobile application 120 configured for use by building/property owners, insurance companies, and other stakeholders showing receipt of new message (via email, SMS messaging and/or push-notifications) relating to building status from messaging services supported by the system network 1.

FIG. 9B2 shows a graphical user interface of the mobile application 120 configured for use by building/property owners, insurance companies, and other stakeholders to update building profile using profile services supported by the system network 1.

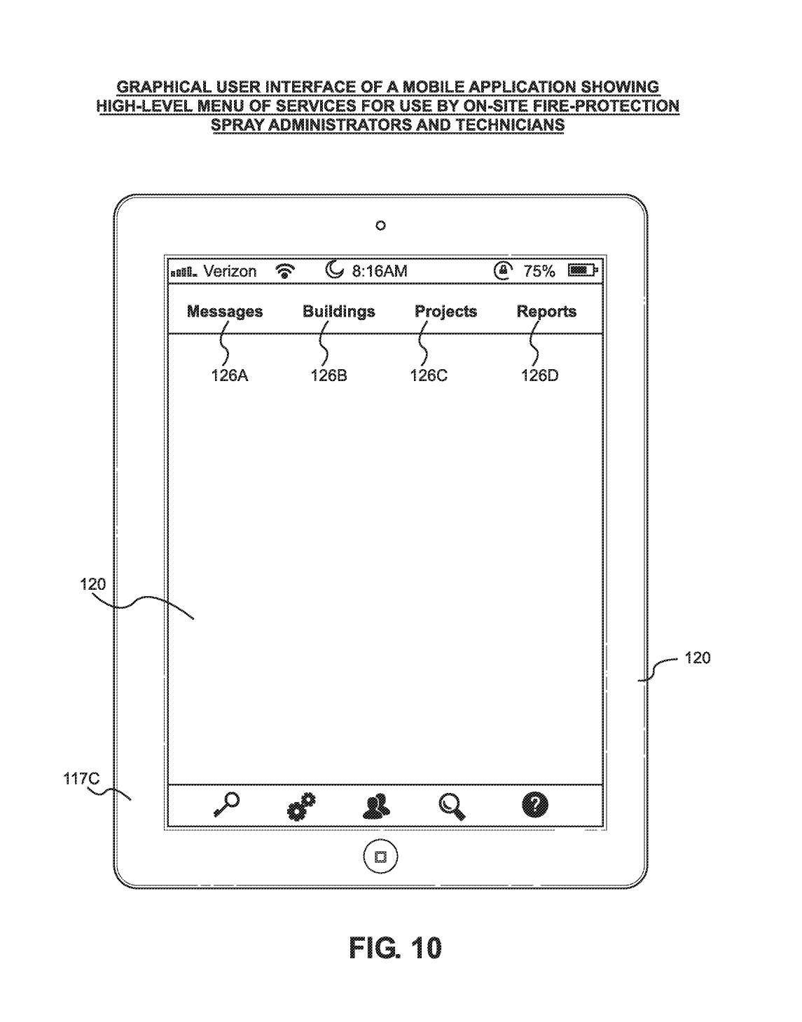

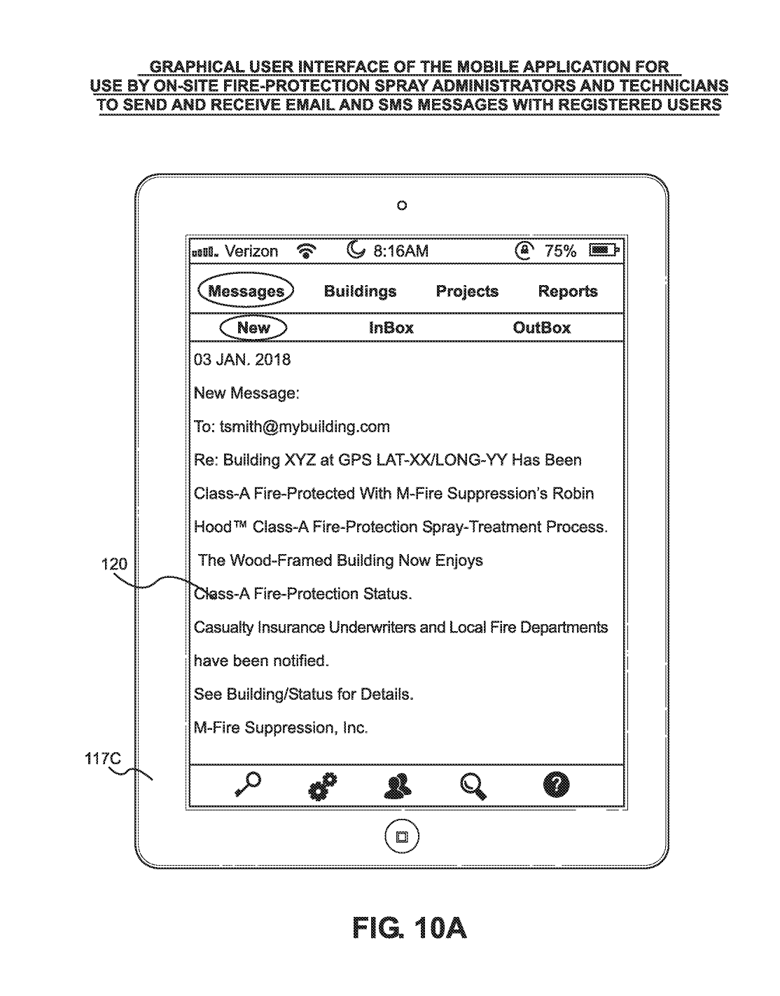

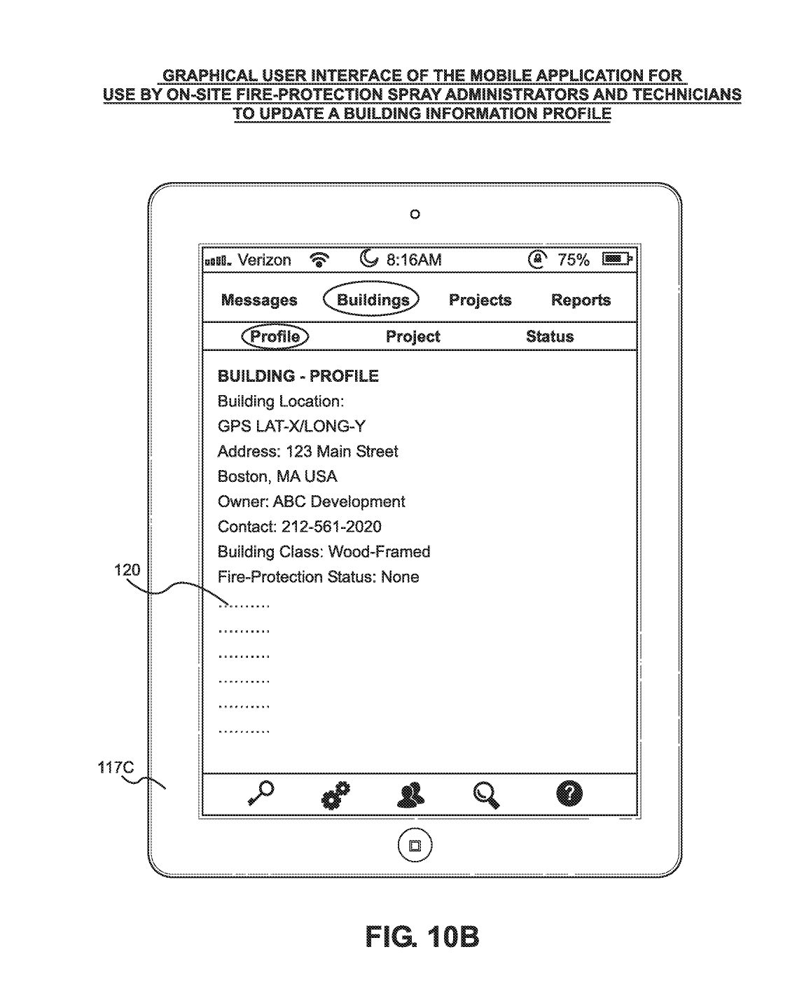

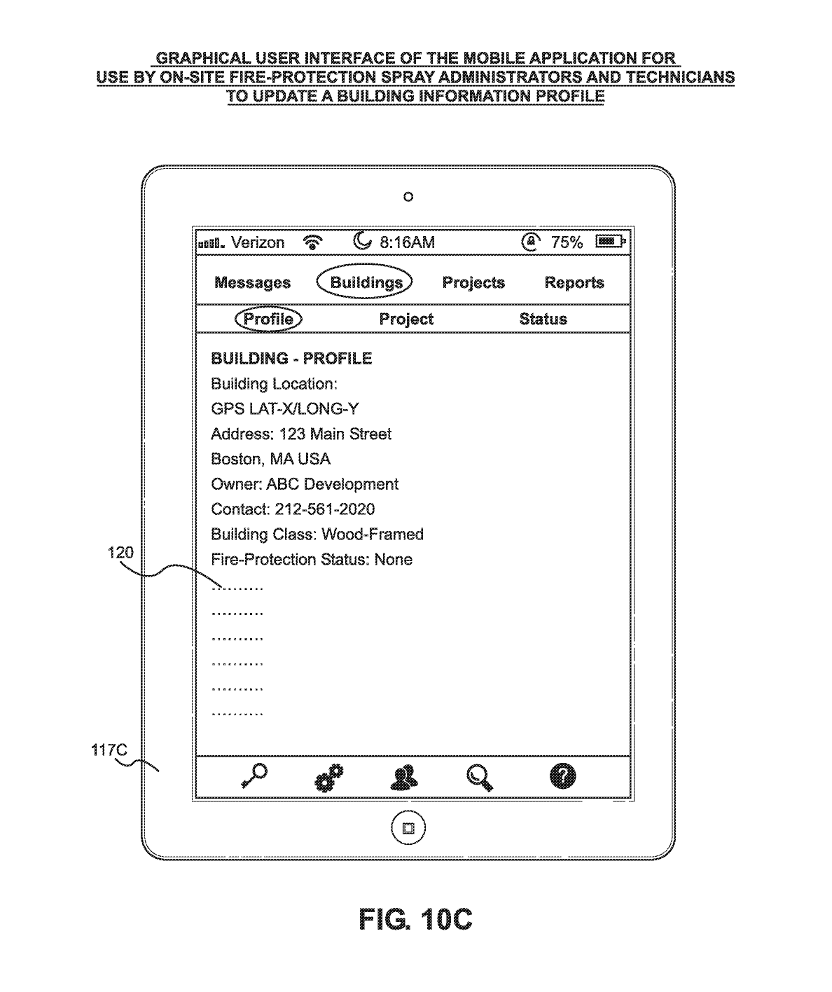

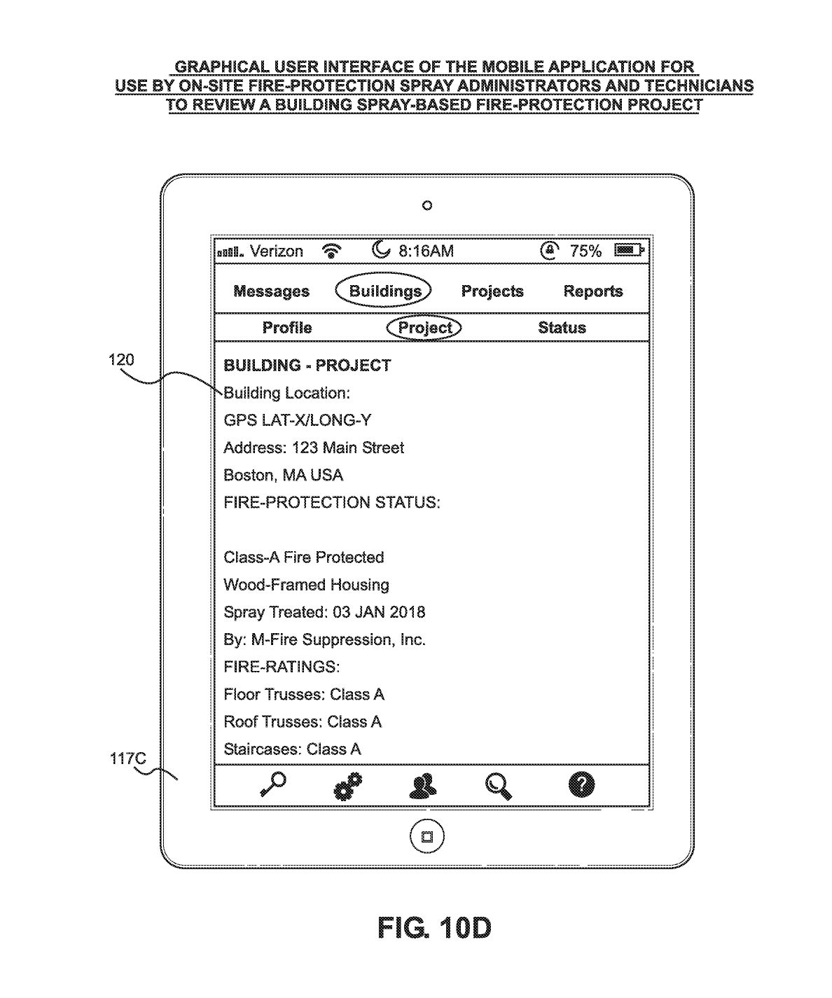

FIG. 10 show a graphical user interface of the mobile application showing a high-level menu of services configured for use by on-site fire-protection spray administrators and technicians supported by the system network 1.

FIG. 10A show a graphical user interface of the mobile application 120 configured for use by on-site fire-protection spray administrators and technicians to send and receive messages (via email, SMS messaging and/or push-notifications) with registered users, using messaging services supported by the system network of the present invention.

FIG. 10B show a graphical user interface of the mobile application 120 configured for use by on-site fire-protection spray administrators and technicians to update a building information profile using the building profile services supported by the system network 1.

FIG. 10C shows a graphical user interface of the mobile application 120 configured for use by on-site fire-protection spray administrators and technicians to review a building spray-based fire-protection project using services supported by the system network 1.

FIG. 10D show a graphical user interface of the mobile application 120 configured for use by on-site fire-protection spray administrators and technicians to review the status of any building registered with the system network 1 using services supported by the system network of the present invention.

Other GUIs are shown in the above referenced US patent applications for supporting the various services provided to the various stakeholders across the enterprise.

### Specification of a Method of Verifying and Documenting On-Site Spray-Applied Class-A Fire-Protection Over Wood-Framed Buildings During Construction Using the On-Site Wood-Frame CFIC Liquid Spraying System

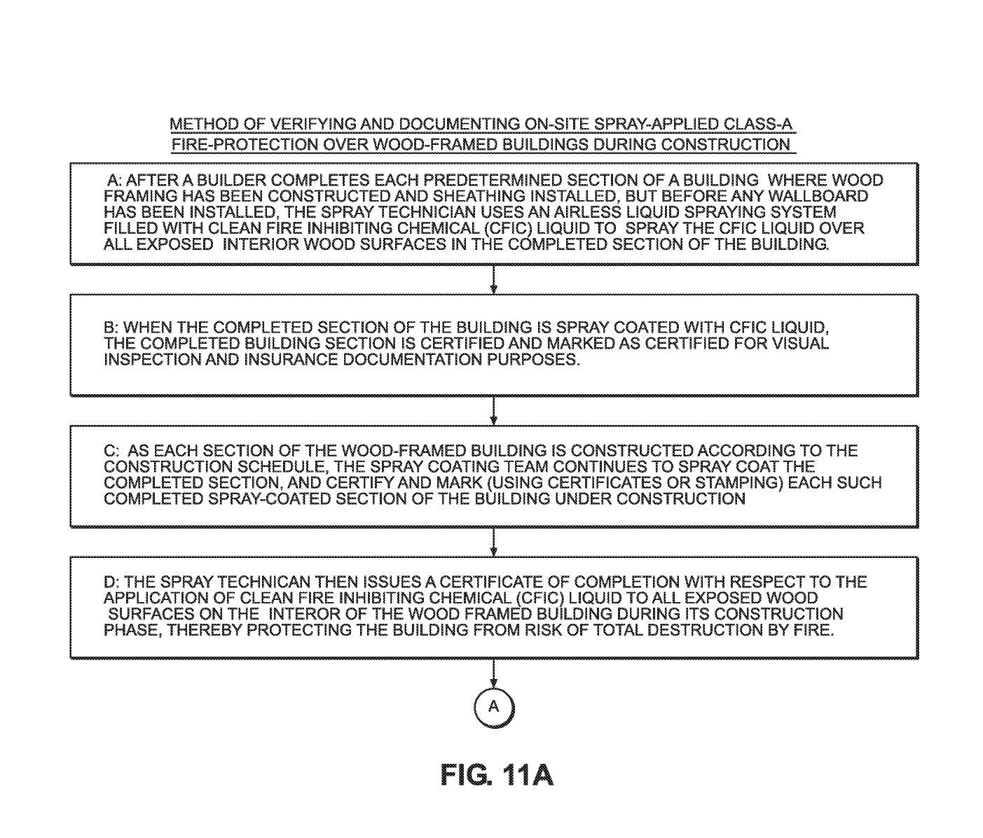

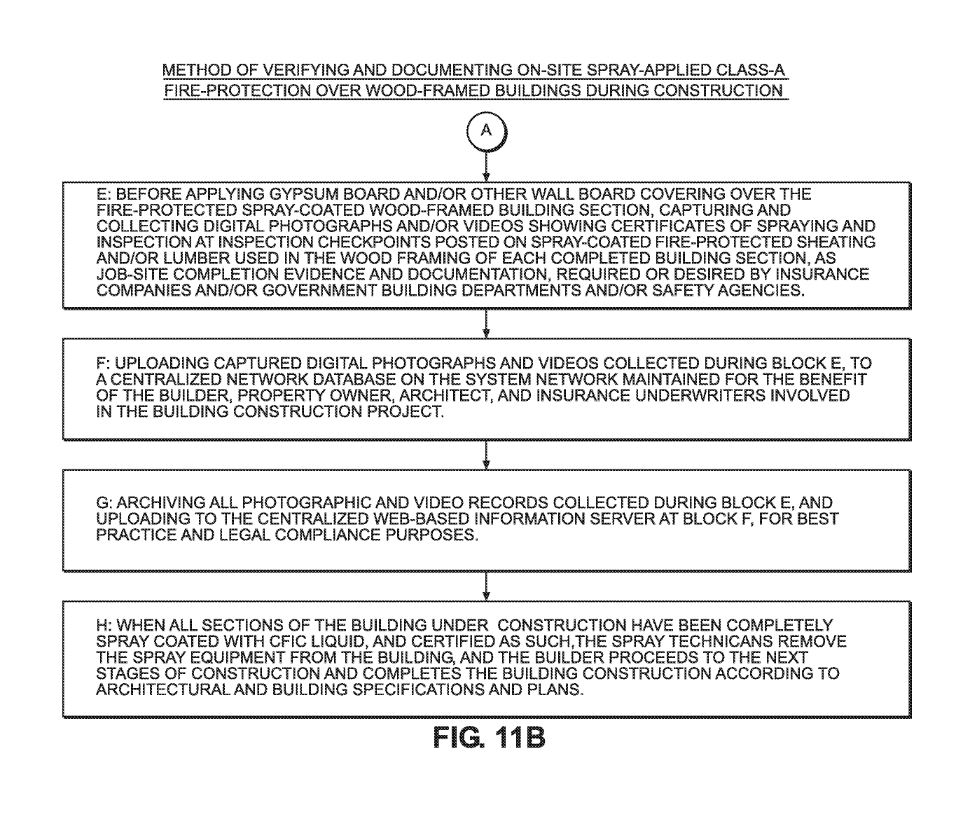

FIGS. 11A and 11B describe a method of verifying and documenting on-site spray-applied Class-A fire-protection over wood-framed buildings during construction using the on-site wood-frame CFIC liquid spraying system 100 shown in FIGS. 2 through 13. A description of this method is appropriate at this juncture.

As indicated at Block A in FIG. 11A, after a builder completes each predetermined section of a wood-framed building where wood-framing has been constructed and (plywood or OSB) sheathing installed, but before any wallboard has been installed, the spray technician uses an airless liquid spraying system 101 filled with clean fire inhibiting chemical (CFIC) liquid to spray the CFIC liquid over all exposed interior wood surfaces in the completed section of the wood-framed building.

As indicated at Block B in FIG. 11A, when the completed section of the wood-framed building is spray coated with CFIC liquid, the completed wood-framed building section is certified and marked as certified, with a posted barcoded/RFID-tagged certification of inspection 300 (at inspection checkpoints), then certified and verified with signatures by the spray applicator and on-site manager, and digitally documented by scanning and data capturing as shown in FIGS. 51A and 51B, and uploading to the system network server 113A, for subsequent visual inspection and insurance documentation purposes.

As indicated at Block C in FIG. 11A, as each section of the wood-framed building is constructed according to the construction schedule, the spray coating team continues to spray coat the completed section with CFIC liquid (e.g. Hartindo AF31), and certify and mark using barcoded/RFID-tagged certificates of inspection 300 at posted inspection checkpoints, each such completed spray coated section 118 (118A, 118B, 118C) of the building under construction.

As indicated at Block D in FIG. 11B, the spray technician then issues a time/date stamped “certificate of completion” with respect to the application of clean fire inhibiting chemical (CFIC) liquid to all exposed wood surfaces on the interior of the wood-framed building during its construction phase, thereby providing the wood-framed building with Class-A fire-protection and defense against risk of total destruction by fire.

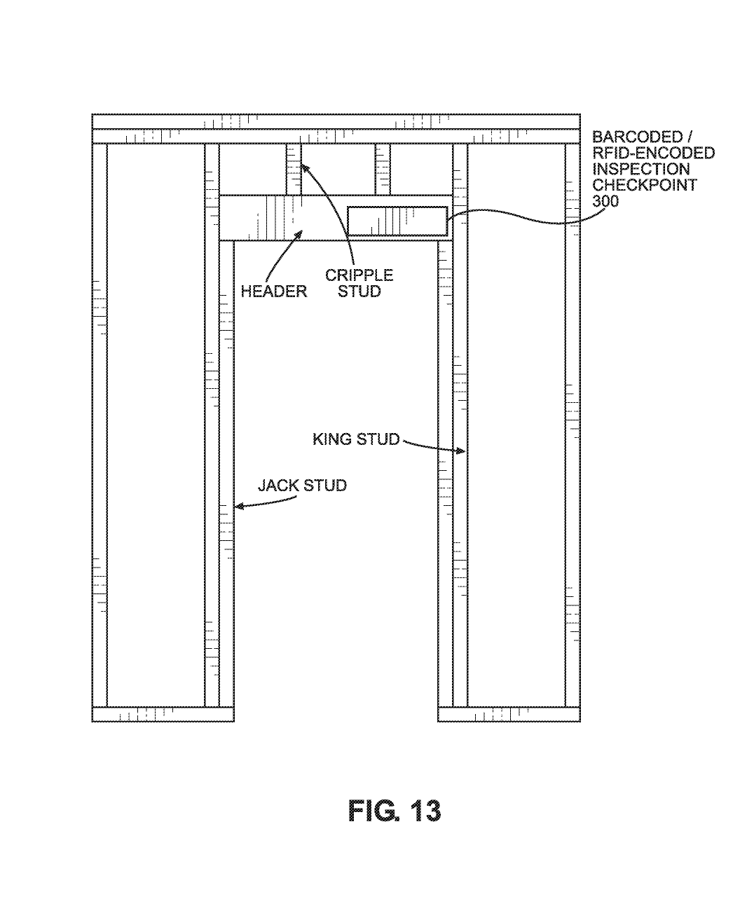

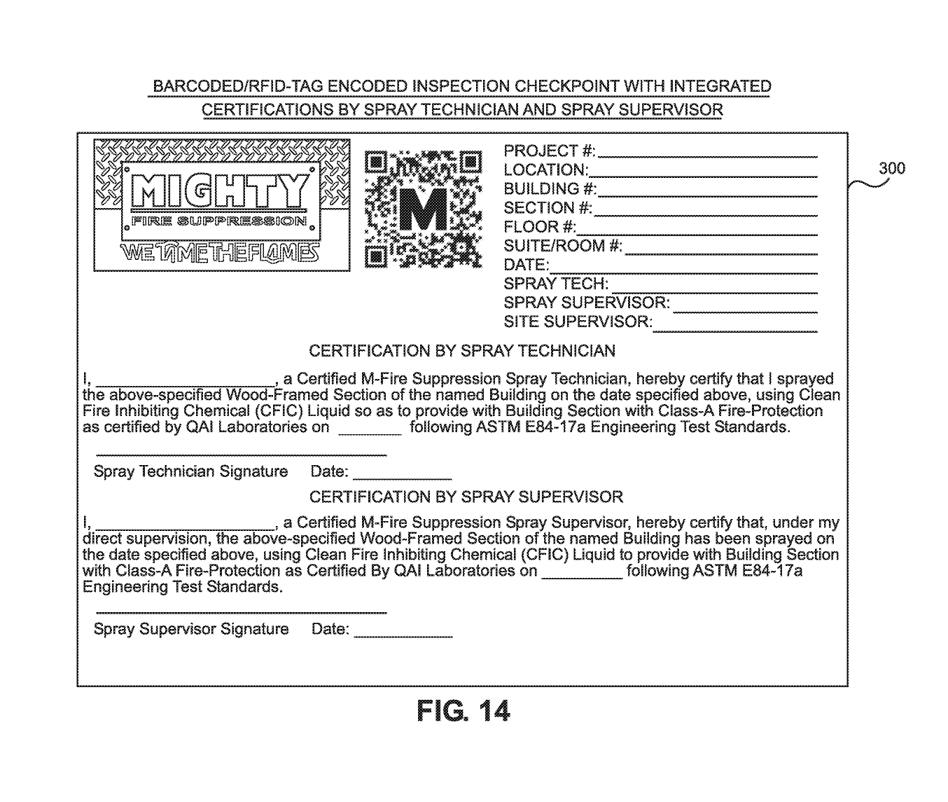

As indicated at Block E in FIG. 11B, before applying gypsum board and/or other wall board covering over the fire-protected spray-coated wood-framed building section 118, the mobile application 120 on mobile computing device 117 is used to capture and collect digital photographs and/or videos showing barcoded/RFID-tagged inspection checkpoints 300 (with integrated signed certificates of spraying and inspection) posted on spray-coated fire-protected sheathing and/or lumber used in the wood framing of each completed building section as shown in FIGS. 13 and 14, and signed by the spray technicians and spray supervisor, as visual evidence and job-site completion documentation, required or desired by insurance companies and/or government building departments and/or safety agencies. Preferably, each completed section of the wood-framed building should be assigned a section number by the builder, and if not by the builder, then by the spray application administrator, so that each certificate of completion, stamped on the wood surface of each section of the wood-framed building, and signed and dated by the on-site CFIC liquid spray applicator and on-site manager, will be digitally captured as images and/or AV recordings, and then uploaded to the system network database under the project ID number for project verification and documentation purposes.

As indicated at Block F in FIG. 11B, uploading captured digital photographs and videos collected during Block E to the centralized network database 113A on the system network 100, maintained by the fire-protection spray coating technician company, or its agent, as a valued-added service provided for the benefit of the property/building owner, builder, architect, home-owner and/or insurance companies involved in the building construction project.

As indicated at Block G in FIG. 11B, archiving all photographic and video records collected during Block F and uploading to the centralized web-based information server 111 at Block G for best practice and legal compliance purposes.

As indicated at Block H in FIG. 11A, when all sections of the building under construction have been completely spray coated with CFIC liquid, and certified as such, the spray technicians remove the spray equipment from the building, and the builder proceeds to the next stages of construction and completes the building construction according to architectural and building specifications and plans.

By virtue of the Web-based system network 100 described above, it is now possible for professional fire-protection specialists to (i) visually document the spraying of CFIC liquid over all exposed interior wood-surfaces of a wood-framed building under construction so as to achieve Class-A fire-protection, and (ii) after certifying with signatures, the proper on-site spray application of CFIC liquid, and Class-A fire-protection treatment of the wood-framed building, to capture and upload digital photographs and AV-recordings of certificates and related stamps, markings and signatures to a centralized website (e.g. system network database 113A), at which such uploaded and archived digital documents can be reviewed and downloaded when needed by architects, insurance companies, their inspectors, building owners, governmental officials, fire marshals and others who have a stake or interest in the matter of building fire-protection compliance and authentication. This remotely accessible facility, supported by the system network 100 of the present invention, provides a valuable and useful service to property/building owners, insurance underwriters, financial institutions (e.g. banks), and others who have great stakes in ensuring that particular wood-framed buildings have been properly Class-A fire-protected using the spray-treatment methods of the present invention described in great detail hereinabove.

Specification of an Exemplary Embodiment of the System Network of the Present Invention Used During the Management of the Logistical Operations and Certifications Made and Documented During Class-A Fire-Protection Spray Treatment of Wood-Framed Buildings During the Construction Phase

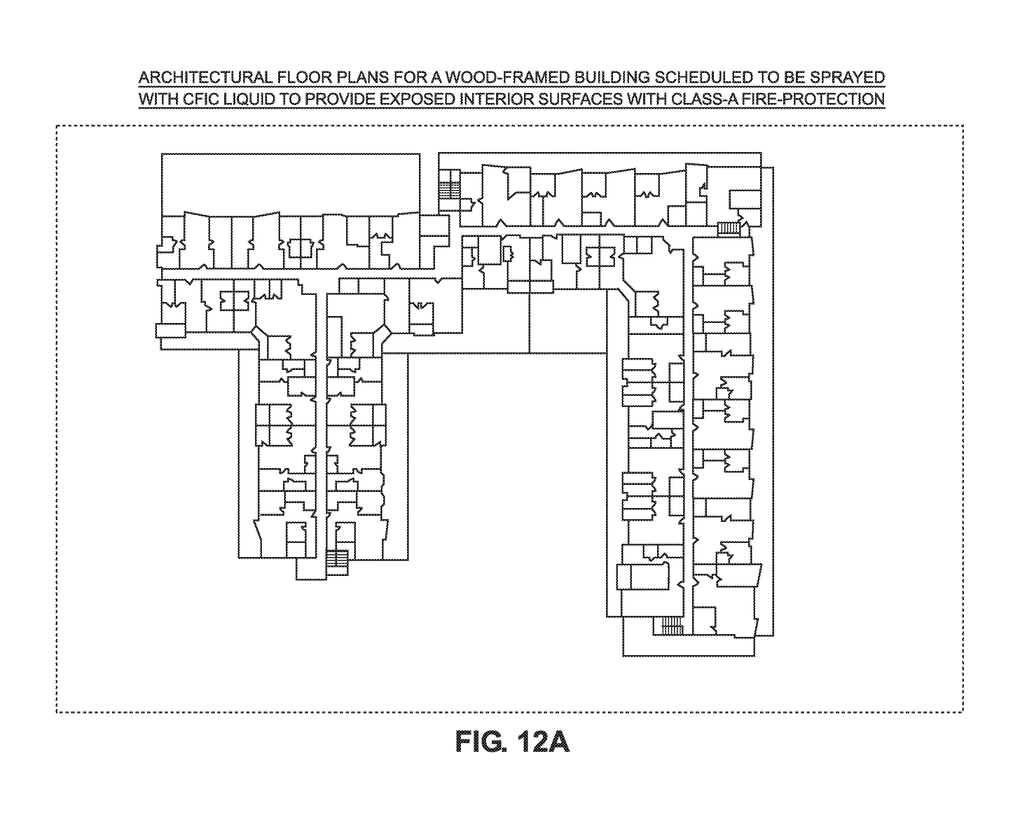

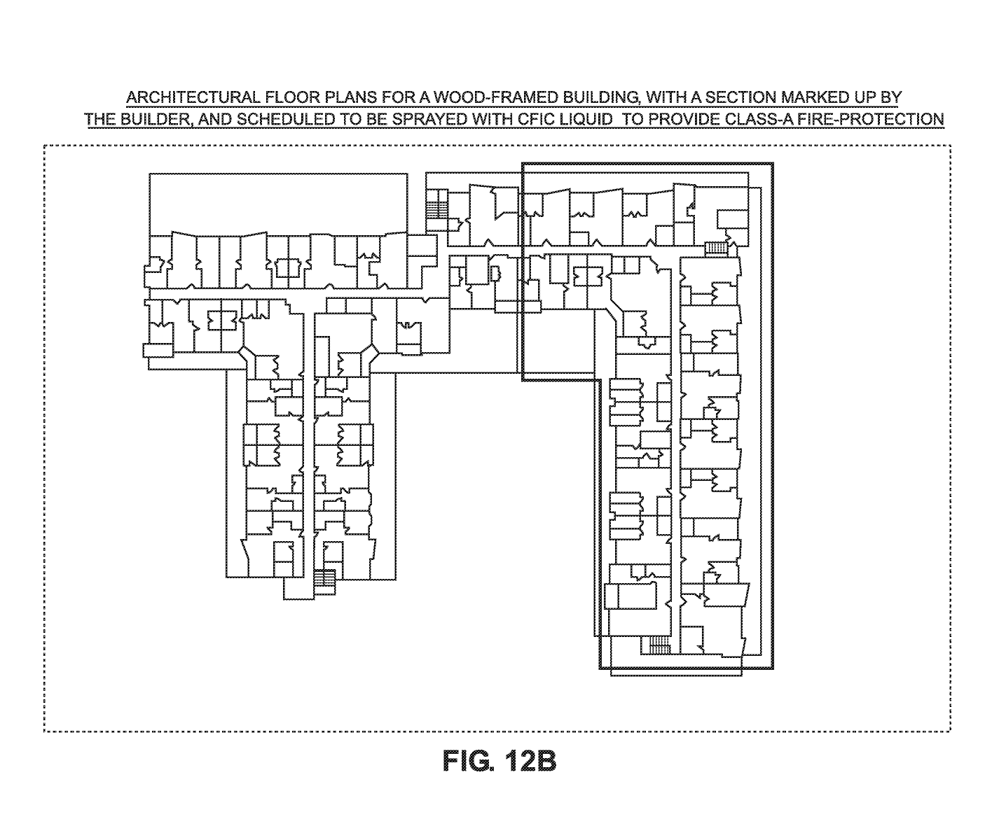

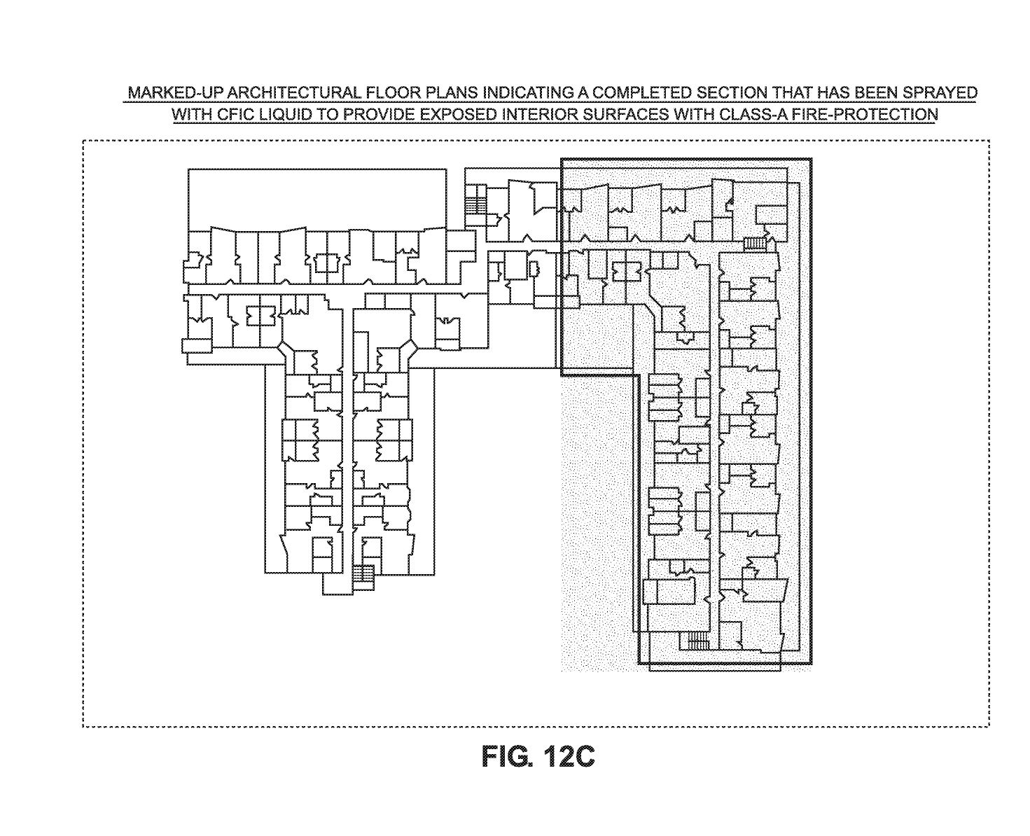

The system network 100 of the present invention has been described in great detail above in connection with ways in which to verify and document the CFIC liquid spray treatment of wood-framed buildings on job sites during the construction phase, so that the various stakeholders will have remote access to a secure database 113A containing photographic and audio-visual recording documentation, relating to certifications, verifications and documentation of each CFIC liquid spray project managed using the system network 100 of the present invention. However, when practicing the present invention, it is understood there will be many different ways to implement the useful concepts embraced by such inventions, when deploying and using a system network 100 to manage such operations across any enterprise of local, national or global scope. To help teach those with ordinary skill in the art to practice the present invention, an illustrative embodiment will be described at this juncture with reference to FIGS. 12A through 14.

FIG. 12A is a schematic representation of an architectural floor plans for a wood-framed building scheduled to be sprayed with CFIC liquid to provide exposed interior surfaces with Class-A fire-protection.

FIG. 12B is a schematic representation of architectural floor plans for a wood-framed building, with a section marked up by the builder, and scheduled to be sprayed with CFIC liquid to provide Class-A fire-protection.

FIG. 12C is a schematic representation of marked-up architectural floor plans indicating a completed section that has been sprayed with CFIC liquid to provide exposed interior surfaces with Class-A fire-protection.

FIG. 12A shows architectural floor plans for a wood-framed building scheduled to be sprayed with CFIC liquid to provide exposed interior surfaces with Class-A fire-protection. These floor plans will be uploaded and stored in the network database 113A in the document folder/directory of the project. FIG. 12B shows architectural floor plans for an exemplary wood-framed building, with a section marked up by the builder (indicated in dark thick lines), and scheduled to be sprayed with CFIC liquid to provide Class-A fire-protection. FIG. 12C shows marked-up architectural floor plans indicating a completed section that has been sprayed with CFIC liquid to provide exposed interior surfaces with Class-A fire-protection. All such marked-up floor plans will also be stored in the network database 113A as part of the project's document package, as will be explained in greater detail herein below.

On the exemplary system network 100, the following stakeholders will be supported and use the mobile application 120 (or web-browser equivalent) during a spray project on a building construction site for the following purposes:
Project Coordinator—To initiate the project and track progress of the projects
CFIC Supply Chain Manager—To start the chain of custody for the supply of CFIC materials in shipping CFIC totes (i.e. CFIC liquid concentrate in totes for diluting with water at job sites, or CFIC dry power in totes for mixing with water at job sites)
Site Spray Manager—To continue the chain of custody and electronically notify the site spray technician where they need to spray and then review to see if it has been sprayed
Site Spray Technicians—To continue the chain of custody and indicate sprayed areas
Spray Administrator Management—To review progress of the projects
Building Owners (i.e. Customers or site superintendent)—To continue the chain of custody and to order the spray contractor to spray parts or sections of their buildings
Insurance companies—To review real time progress on when their insured buildings are protected.
Fire fighters—To check if a building fire, to which they are responding, has been defended from fire using CFIC liquid spray treatment disclosed and taught herein.

The system network 100 and its distribution of mobile computing devices (running mobile application 120 or web-browser equivalents) will have the capability to list all spray projects linked to the user, wherein each project contains numerous project details and information of different relevance to different stakeholders. In the illustrative embodiment, all projects will be searchable by customer name then project name. The building owners (often referred to as the “customer” with respect to the spray contractor) will only be able to access their projects, not the projects of others which will be maintained confidential on the system network. The mobile application 120 will be able to send push-notifications where required, and users will choose what notifications they want to receive. For example, the customer's insurance company will have the option to only be notified when a portion of the building has been sprayed, or when only an entire floor has been sprayed.

Upon creating a new project on the system network 100, the spray project coordinator will use the mobile application 120 to add various information items regarding the project, in the network database 113A, including, for example: Customer Name (e.g. Building Owner Name); Project Name; Site Address; Superintendent's name and title, mobile number, email address; number of buildings associated with the project.

The mobile application 120 will then start with building 1 or building A, and prompt the user for the following information: Identify Building Type—by choosing a type from a drop down menu (i.e. apartment, townhouse, house, etc). If the Building Type is an apartment, then the user will be asked to describe the building (i.e. 3, 4 or 5 stories, square footage, total number of suites).

Mobile application 120 has the capability to import one or more pdf documents of each floor plan of the building into the project folder on the network database 113A, as shown in FIG. 62A. At this stage, the mobile application 120 will ask the user to import one or more pdf document(s) of the floor plan of each floor in the building, and will ask to identify the building, floor, and provide other information for subsequent use and marking. In particular, the application servers 112 will support advanced pdf document processing software enabling the users to index imported building floor plans to indicate the precise location where barcoded/RFID-tagged inspection checkpoints 300 (with integrated certificates of spraying, certificates of inspection, etc.) shown be posted during the project, as shown in FIGS. 62 and 63, for purposes of illustration.

The mobile application 120 will also request from the spray project coordinator, a Project Start Date when spray technicians should be begin spraying, in coordination with the construction schedule. Once the project has been created, the mobile application 120 will automatically send a push notification to: CFIC liquid supply manager; building site coordinator; and spray administrators. Each user will be invited to project, with certain rights and privileges as determined and set by the spray project administrator (i.e. fire-protection provider administrator).

When the CFIC totes are ready to be filled or shipped, the mobile application 120 will prompt the CFIC Supply Manager user for various items of information relating to CFIC material required on certain building sites, in connection with specific projects. The user will navigate to the project on the mobile application 120, and will store the CFIC tote information that multiple CFIC totes are required per project. For purposes of the present invention, the term “tote” shall mean any device fashioned to contain and hold a predetermined quantity of CFIC material, whether in dry power form, or concentrated liquid form, and may include bags, containers, bottles, or any other type of vessel capable of perform functions of containment and carrying. Estimates of CFIC material, based on the size of the building spray job, can be calculated using tables and other knowledge possessed by the CFIC supply chain manager, and may be automated using AI-based processes. In an illustrative embodiment, the user will select one of the following buttons; Add a CFIC Tote; Ship A CFIC Tote. If the user selects “add a CFIC tote” then they will be prompted for the following; the date (chosen from a calendar), the CFIC tote number, the size of the CFIC tote, dye (yes or no) mold protection (yes or no). If the user wants to “ship a CFIC tote”, then the user navigates to the project and selects the “ship a CFIC tote” button and chooses the CFIC tote the user wants to ship from a drop-down menu. The user will then pick a date from a calendar. The user will have to enter the ship date and the arrival date and name of the shipping carrier.

Once the CFIC Tote arrives at building job-site, the building site supervisor will log into the system network via the mobile application 120, and perform the following system network operations. The building site supervisor (i.e. customer) will navigate to the project on the mobile application 120, and sign off that the CFIC tote has arrived at the job site, with its locks intact and that CFIC tote has not been tampered. The site supervisor will use his/her finger to sign this confirmation in the mobile application 120.

When the building owner (i.e. customer) wants to request a completed portion or section of a wood-framed building to be sprayed-treated with CFIC liquid, the Building site supervisor will perform the following system network operations. The building site supervisor use the mobile application 120 to navigate to their project and enter the portion of their building they want sprayed with CFIC liquid. The building site supervisor will indicate the date the request was made, building number, the floor and the suites they want sprayed and date they want it sprayed. The mobile application 120 will send a notification via the mobile application 120 to the project coordinator, to let them know the request has been made. The spray project coordinator will use the mobile application 120 to either accept the requested spray date, or propose a new spray date to the building site supervisor. If the spray project coordinator (i.e. fire protection provider) accepts the proposed spray date, then a confirmation will be sent to the building site superintendent via the system network using the mobile application 120.

Once the spray contractors (i.e. fire protector providers) arrive on-site of the building and are ready to spray CFIC liquid as requested, the site spray technician will perform the following operations in the system network 100 using the mobile application 120. The site spray technician will mix a CFIC tote (e.g. by adding water to a tote contain CFIC liquid concentrate, or by adding water to the tote containing AAF31 powder and dye, if the project requires dye). If the project requires mold protection, then that will be added at the time the CFIC tote is mixed on site), and the spray technicians will sign in to the mobile application 120, navigate to the project page, and click on “on-site CFIC tote preparation”. The spray technicians will choose the CFIC tote number from the drop-down list (previously created by the CFIC supply manager) and then enter the date, by clicking on a calendar date. The spray technicians will indicate if they have added dye, and or mold protection to the CFIC material.

When the spray date arrives, the building site superintendent will do a walk through of the intended spray area (i.e. floor plan) and inspect to make sure the area is ready to spray all exposed interior wood surfaces with CFIC liquid. The building site superintendent will attach an RFID tag and/or bar code symbol at each inspection checkpoint 300 marked on the floor plans of the wood-framed building to be spray-treated with CFIC liquid spray, indicated in FIG. 13. Each RFID tag and/or bar code symbol will be encoded with an unique code identifier that is marked on the floor plan, and uniquely associated with the project, and added to the network database 113A on the system network.

Preferably, the spray site superintendent will mount a barcoded/RFID-encoded inspection checkpoint 300 (bearing a certificate of spraying by the spray technician and a certificate of inspection by the spray supervisor and optionally the building site supervisor, printed on a thin flexible plastic sheet, on which a barcode symbol/RFID-tag are mounted) to (i) the entry door header of each room in each unit including the entrance to the unit, as illustrated in FIG. 13, and also (ii) a stud located at every 10′ on one side of the hallway. Expectedly, the location of each barcoded/RFID-tagged inspection checkpoint 300 in any given project will vary. However, placement of such inspection checkpoints 300 should be selected to ensure that inspection is sufficient granular in resolution to not overlook significant areas of a sprayed wood-framed building section under inspection.

As illustrated in FIG. 14, rich barcoded/RFID-tagged inspection checkpoint 300 will include a bar code symbol and RFID tag that has a unique project/inspection-checkpoint identifier (e.g. an alphanumeric character string) encoded into the symbology used in the barcode symbol and RFID tag identifier, and this project/inspection-checkpoint identifier will be used to identify subfolders or subdirectories where collection data, information and documents are stored in the project folder on the network database 113A, maintained on the system network 100. The project/inspection-checkpoint identifier will be read during each scan/read of the barcoded/RFID-tag inspection checkpoint 300, and used by the mobile application to access the appropriate inspection checkpoint folder in the project folder where all such certifications of spraying, inspection and oversight, and photos, and videos are stored and archived for posterity.

At the beginning of each spray session, the spray technician will log into the system network 100 using the mobile application 120, then navigate to the project page, select his name from a drop down or scrolling list, and indicate when he started spraying by clicking on a date and hour, minutes, seconds. The spray technician may also need to scan his barcoded ID card using the mobile application 120 for proper authentication and/or authorization purposes. He may also choose to record the presence of other members of his spray crew using the mobile application and their barcoded user ID cards and network ID numbers. The spray technician will then proceed to spray each assigned section of the building, and after spraying each wood-framed building section, the spray technician will approach the barcoded/RFID-tagged inspection checkpoint 300 in the spray area, and read, sign and date the certification of spraying on the checkpoint substrate, mounted on the header surface illustrated in FIGS. 13 and 14. The spray technician should diligently read, sign and date each and every certificate of spraying at the inspection checkpoint 300, and treated as a condition of professionalism, duty, and employment, given the responsibility being entrusted to the individual with such operations.

FIG. 13 shows a wood-framed door panel showing the studs and header above a doorway, on which the barcoded/RFID-tag encoded inspection checkpoint of the present invention 300, realized on a piece of thin flexible plastic material and supporting a barcode symbol and RFID-tag encoded to the spray project at hand, and bearing printed certifications by a spray technician and spray supervisor, and optionally by the building site superintendent shown in greater detail in FIG. 14.

FIG. 14 shows the barcoded/RFID-tag encoded inspection checkpoint shown in FIG. 13, with integrated certifications by spray technician liquid and spray supervisor, and optionally, the building site superintendent.

At the end of the day, the spray technician will log into the system network 100, if already logged out, using the mobile application 120, and indicate the time when he finished spraying and indicate which suites on the floor plan pdf were sprayed with CFIC liquid. This will be done by drawing on his mobile computing device 117 (e.g. Apple iPad or Apple iPhone), by shading the PDF of the floor plan, over the appropriate suites and hallways, which were in fact sprayed with CFIC liquid during his work session that date. This is the same floor plan that was previously loaded on the mobile application 120 by the customer/building owner, but with the spray technicians markings added to the floor plan to indicate sections which have been spray treated with CFIC liquid.

At the end of each day or during the course of the day, the spray site superintendent will review the CFIC liquid spraying work performed on the job site that date, to ensure that the spray work has been completed properly.

The spray supervisor will visit each checkpoint 300, and read, sign and date the certificate of inspection at the inspection checkpoint 300 after performing a diligent inspection at and around the checkpoint where spraying occurred earlier that day. At each barcoded/RFID-tagged inspection checkpoint 300 on the plan, the spray site supervisor will also scan each and every barcoded/RFID-tag inspection checkpoint 300, and confirm with the system network 100 that the spray work at each inspection checkpoint has been completed properly. This process will involve displaying GUI screens on the mobile application 120 and checking off all suites/units and hallways have been completed and sprayed with CFIC liquid, and uploading such information to the project folder on the network database 113A on the system network 100. The process can also include capturing digital photos and AV-recordings of the site in the vicinity of each barcoded/RFID-tagged inspection checkpoint, verifying and documenting the certifications at each inspection checkpoint signed by the spray-technician after CFIC liquid spraying, and then uploading these captured digital photos and AV recordings to the project under the inspection checkpoint ID, within the network database 113A maintained by the system network 100.

Also, it is desired that the building site superintendent visit each checkpoint and read, sign and date the certificate of inspection/oversight by the building superintendent on the job site on that date. The building site superintendent should also use the mobile application 120 to capture digital images and videos of this certificate and competed inspection checkpoint, and surrounding areas treated with CFIC liquid by the spray technician. Images and video recordings of the spray technician and supervisor can be included at each and every barcoded/RFID-tagged inspection checkpoint 300 and uploaded to the project folder, under the barcoded/RFID-tagged inspect checkpoints 300 assigned to the project.

The above steps above will be repeated every time the spray crew arrives at the building site until the project is complete.

Each time a CFIC tote is mixed at the job site by the spray technician, he/she will spray six 1-foot long 2×4's test boards (301A, 301B) covering all sides (3 for spray administrator and 3 for the customer). The sample test boards 301 will be marked with the tote number. Alternatively, CFIC liquid sprayed test boards 301 can be made at or near barcode/RFID-tagged inspection checkpoints 300 in the building, and marked with the barcode/RFID ID number, and date they were sprayed. The fact that these sample test boards 301 were created will be recorded using the mobile application 120 in either the CFIC tote supply record section of each project, or under a barcode symbol/RFID-tag ID section of the project. Digital images and videos of these sprayed test boards 301 can be captured and uploaded to project folder in the network database 113A maintained on the system network 100.

At the completion of the project, the spray site superintendent will check the box that the project is complete. The spray site superintendent will request the building project superintendent to sign that the project has been completed, and such documentation will be made part of the project files stored in the network database 113A on the system network 100. A physical certificate of completion document can be signed and dated and scanned into pdf format and stored in the project file in the network database 113A, using the mobile application 120 deployed on the system network 100. Once the project has been completed, the system network 100 will send a notification to the local fire department, the insurance underwriting company, the building owner (i.e. customer), and the spray project coordinator. The system network will automatically organize all documents, data and information collected during the course of the project, and compile for presentation to various parties including the building owner, and property insurance underwriters.

The site spray technician will then collect all the sprayed samples 301A, 301B stored in barcoded storage sleeves 302A, 302B and deliver the first set of test samples 301A to the building site superintendent or the building's architect, while providing the second set of the sprayed test samples 301B to the spray supervisor to transport and archive in storage, as part of the fire protection provider's legal and business records. The spray technician will certify that he has provided the first set of sprayed test samples in storage sleeves to the building site superintendent, and the second set of sprayed test samples to the spray site superintendent. The building site superintendent will sign that he has received the sprayed test samples in their barcoded storage sleeves. The second set of sprayed test samples can be shipped to the fire protection provider's warehouse for archival purposes.

Method of Qualifying a Wood-Framed Building for Reduced Property Insurance Based on Verified and Documented Spray-Based Clean Fire Inhibiting Chemical (CFIC) Liquid Treatment of all Exposed Interior Wood Surfaces of the Wood-Framed Building During the Construction Phase Thereof

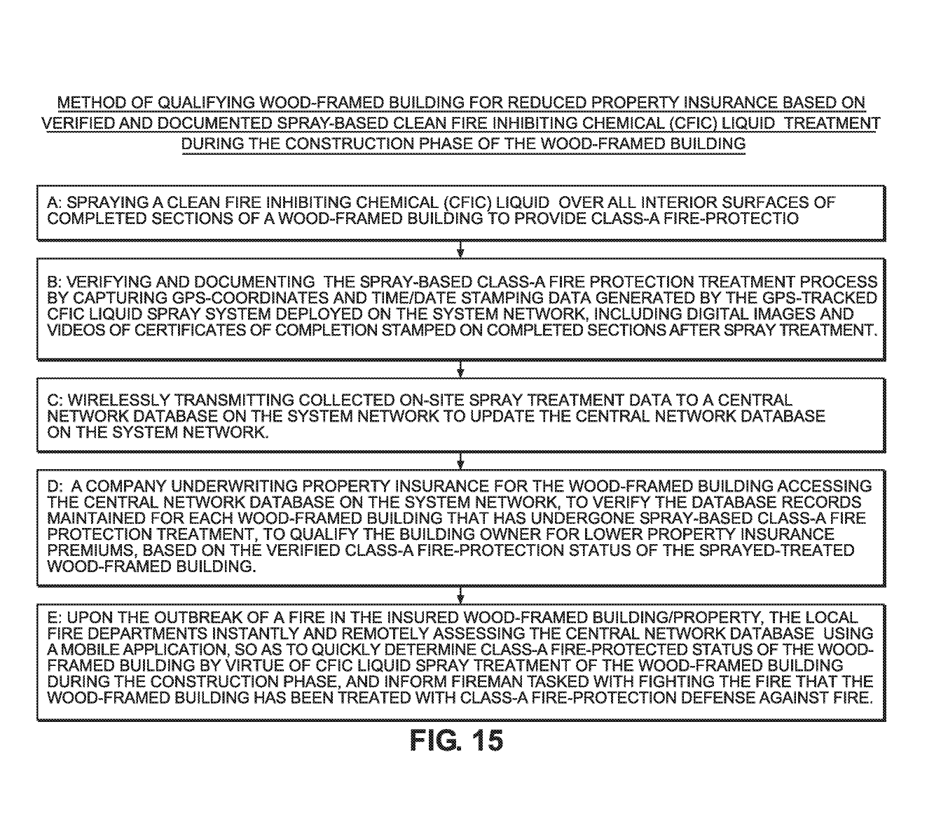

FIG. 15 describes the method of qualifying real property for reduced property insurance, based on verified on-site spraying of the exposed interior surfaces of wood-frame buildings with clean fire inhibiting chemical (CFIC) liquid during the construction stage of the building, using the system network of the present invention.

FIG. 15 shows the high-level steps required to practice the method of qualifying a wood-framed building for reduced property insurance based on verified and documented spray-based clean fire inhibiting chemical (CFIC) liquid treatment of all of the exposed interior surfaces of the wood-framed building, after each completed section.

As indicated at Block A in FIG. 15, a clean fire inhibiting chemical (CFIC) liquid is sprayed all over all interior surfaces of each completed sections of a wood-framed building to provide Class-A fire-protection, as described above in FIGS. 3 through 13, using the GPS-tracked/GSM-linked mobile clean fire-inhibiting chemical (CFIC) liquid spraying system 101, shown in FIGS. 3 through 13.

As indicated at Block B in FIG. 15, the spray-based Class-A fire protection treatment process is verified and documented by capturing (i) GPS-coordinates and time/date stamping data generated by the GPS-tracked CFIC liquid spray system 101 deployed on the system network, and (ii) digital images, and audio-video (AV) recordings of barcoded/RFID-tagged certificates of inspection 300 posted on completed sections after spray treatment, as illustrated in FIGS. 3 and 13, and FIGS. 13 and 14, using the mobile application 120 on mobile computing device 120.

As indicated at Block C in FIG. 15, the collected on-site spray treatment verification data is wirelessly transmitted to a central network database 113A on the system network to update the central network database on the system network 109.

As indicated at Block E in FIG. 15, a company underwriting property insurance for the wood-framed building accesses the central network database 113A on the system network, to verify the database records maintained for each wood-framed building that has undergone spray-based Class-A fire protection treatment, to qualify the building owner for lower property insurance premiums, based on the verified Class-A fire-protection status of the sprayed-treated wood-framed building.

As indicated at Block E in FIG. 15, upon the outbreak of a fire in the insured wood-framed building/property, the local fire departments instantly and remotely assess the central network database 113A using a mobile application 120, so as to quickly determine Class-A fire-protected status of the wood-framed building by virtue of CFIC liquid spray treatment of the wood-framed building during the construction phase, and inform fireman tasked with fighting the fire that the wood-framed building has been treated with Class-A fire-protection defense against fire.

### Specification of the Network Architecture of the System Network of the Present Invention

As shown in FIG. 8, the Internet-based system network 1 is shown comprising various system components, including an cellular phone and SMS messaging systems 114, and one or more industrial-strength data centers 110, preferably mirrored with each other and running Border Gateway Protocol (BGP) between its router gateways, and each data center 110 comprising: a cluster of communication servers 112 for supporting http and other TCP/IP based communication protocols on the Internet; cluster of application servers 17; a cluster of email processing servers 115; cluster of SMS servers 114; and a cluster of RDBMS servers 113 configured within an distributed file storage and retrieval ecosystem/system, and interfaced around the TCP/IP infrastructure of the Internet 116 well known in the art.

In general, regardless of the method of implementation employed in any particular embodiment, the system of the present invention will be in almost all instances realized as an industrial-strength, carrier-class Internet-based network of object-oriented system design. Also, the system will be deployed over a global data packet-switched communication network comprising numerous computing systems and networking components, as shown. As such, the information network of the present invention is often referred to herein as the “system” or “system network”. The Internet-based system network can be implemented using any object-oriented integrated development environment (IDE) such as for example: the Java Platform, Enterprise Edition, or Java EE (formerly J2EE); Websphere IDE by IBM; Weblogic IDE by BEA; a non-Java IDE such as Microsoft's .NET IDE; or other suitably configured development and deployment environment well known in the art. Preferably, although not necessary, the entire system of the present invention would be designed according to object-oriented systems engineering (DOSE) methods using UML-based modeling tools such as ROSE by Rational Software, Inc. using an industry-standard Rational Unified Process (RUP) or Enterprise Unified Process (EUP), both well known in the art. Implementation programming languages can include C, Objective C, C⁻, Java, PHP, Python, Google's GO, and other computer programming languages known in the art. Preferably, the system network is deployed as a three-tier server architecture with a double-firewall, and appropriate network switching and routing technologies well known in the art.

Referring to FIG. 8, the system architecture of the present invention is shown comprising: (i) a cluster of communication servers 111 (supporting http and other TCP/IP based communication protocols on the Internet and hosting Web sites) accessed by web-enabled clients (e.g. smart phones, wireless tablet computers, desktop computers, control stations, etc.) used by individuals users, brand managers and team members, and consumers, through the infrastructure of the Internet; (ii) a cluster of application servers 112 for implementing the many core and compositional object-oriented software modules supporting the system network of the present invention, (iii) a scalable, distributed computing and data storage system network, including a cluster of RDBMS servers 18; web-enabled client SMS gateway servers 114 supporting integrated email and SMS messaging, handling and processing services that enable flexible messaging across the system network; and a cluster of email processing servers 115; and other servers, processors, databases, and data centers, arranged and configured in accordance with the principles of the present invention as taught herein.

### Specification of Database Schema for the Database Component Used on the System Network of the Present Invention

During the design and development of the system network, a data schema will be created for the object-oriented system-engineered (DOSE) software component thereof, for execution on a client-server architecture. In general, the software component of the system network will consist of classes, and these classes can be organized into frameworks or libraries that support the generation of graphical interface objects within GUI screens, control objects within the application or middle layer of the enterprise-level application, and enterprise or database objects represented within the system database (RDBMS) 113. Preferably, the RDBMS will be structured according to a database schema comprising enterprise objects, represented within the system database (e.g. RDBMS), and including, for example: building owner; building manager; building insurer; system user ID; building ID, building location; building property value; vehicle ID for unmanned VR-guided fire fighting robot system; vehicle ID for identifying each unmanned thermal imaging aircraft system deployed on the system network; client device ID for identifying each VR-enabled building navigation and control device deployed on the system network; client workstation ID for identifying each VR-enabled computer workstation deployed on the system network for remotely controlling one or more deployed unmanned VR-guided fire thermal imaging aircraft systems; client workstation ID for identifying each VR-enabled computer workstation deployed on the system network for remotely controlling one or more unmanned VR-guided fire fighting robot systems; and many other objects used to model the many different aspects of the system being developed.

These objects and the database schema will be used and reflected in a set of object-oriented software modules developed for the system. Each software module contains classes (written in an object-oriented programming language) supporting the system network of the present invention including, for example, the user registration module, unmanned VR-enabled fire fighting system registration module, remote VR-enabled control-station registration module, hand-held building navigation/inspection system registration module, user account management module, log-in module, settings module, contacts module, search module, data synchronization module, help module, and many other modules supporting the selection, delivery and monitoring of building-related services supported on the system network of the present invention.

### Different Ways of Implementing the Client Machines and Devices on the System Network of the Present Invention

In one illustrative embodiment, the enterprise-level system network of the present invention is supported by a robust suite of hosted services delivered to (i) Web-based client subsystems 117 using an application service provider (ASP) model, and also to (ii) unmanned VR-guided thermal imaging aircraft systems 20, (iii) unmanned/flying AI/VR-guided fire fighting robotic systems 40, and (iv) remotely-situated VR-enabled control-stations 80 for remotely controlling unmanned VR-guided fire fighting robot and drone systems as well as unmanned VR-guided thermal imaging aircraft systems 20, described above.

In this embodiment, the Web-enabled mobile clients 117 can be realized using a web-browser application running on the operating system (OS) of a computing device (e.g. Linux, Application IOS, etc), to support online modes of system operation. It is understood, however, that some or all of the services provided by the system network can be accessed using Java clients, or a native client application running on the operating system (OS) of a client computing device to support both online and limited off-line modes of system operation.

### Specification of System Architecture of an Exemplary Mobile Client System Deployed on the System Network of the Present Invention

FIG. 9A illustrates the system architecture of an exemplary mobile client system (e.g. device) deployed on the system network of the present invention and supporting the many services offered by system network servers. As shown, the mobile device can include a memory interface, one or more data processors, image processors and/or central processing units 204, and a peripherals interface 206. The memory interface 202, the one or more processors 204 and/or the peripherals interface 206 can be separate components or can be integrated in one or more integrated circuits. One or more communication buses or signal lines can couple the various components in the mobile device. Sensors, devices, and subsystems can be coupled to the peripherals interface 206 to facilitate multiple functionalities. For example, a motion sensor 210, a light sensor 212, and a proximity sensor 214 can be coupled to the peripherals interface 206 to facilitate the orientation, lighting, and proximity functions. Other sensors 216 can also be connected to the peripherals interface 206, such as a positioning system (e.g., GPS receiver), a temperature sensor, a biometric sensor, a gyroscope, or other sensing device, to facilitate related functionalities. A camera subsystem 220 and an optical sensor 222, e.g., a charged coupled device (CCD) or a complementary metal-oxide semiconductor (CMOS) optical sensor, can be utilized to facilitate camera functions, such as recording photographs and video clips. Communication functions can be facilitated through one or more wireless communication subsystems 224, which can include radio frequency receivers and transmitters and/or optical (e.g., infrared) receivers and transmitters. The specific design and implementation of the communication subsystem 224 can depend on the communication network(s) over which the mobile device 8B, 8C is intended to operate. For example, a mobile device 100 may include communication subsystems 224 designed to operate over a GSM network, a GPRS network, an EDGE network, a Wi-Fi or WiMax network, and a Bluetooth™ network. In particular, the wireless communication subsystems 224 may include hosting protocols such that the device may be configured as a base station for other wireless devices. An audio subsystem 226 can be coupled to a speaker 228 and a microphone 230 to facilitate voice-enabled functions, such as voice recognition, voice replication, digital recording, and telephony functions. The I/O subsystem 240 can include a touch screen controller 242 and/or other input controller(s) 244. The touch-screen controller 242 can be coupled to a touch screen 246. The touch screen 246 and touch screen controller 242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen 246. The other input controller(s) 244 can be coupled to other input/control devices 248, such as one or more buttons, rocker switches, thumb-wheel, infrared port, USB port, and/or a pointer device such as a stylus. The one or more buttons (not shown) can include an up/down button for volume control of the speaker 228 and/or the microphone 230. Such buttons and controls can be implemented as a hardware objects, or touch-screen graphical interface objects, touched and controlled by the system user. Additional features of mobile computing device can be found in U.S. Pat. No. 8,631,358 incorporated herein by reference in its entirety.

### Method of Defending Mass Timber Building Using the Early Building Fire-Outbreak/Arson-Attack Detection and Elimination System of the Present Invention

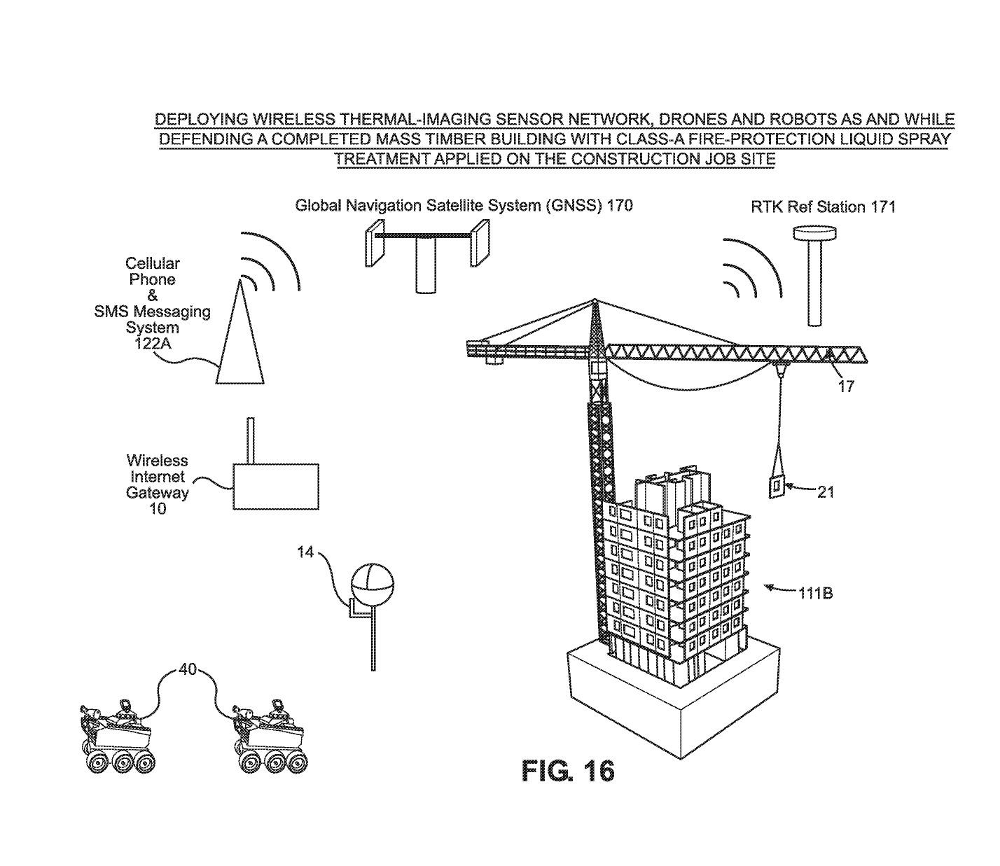

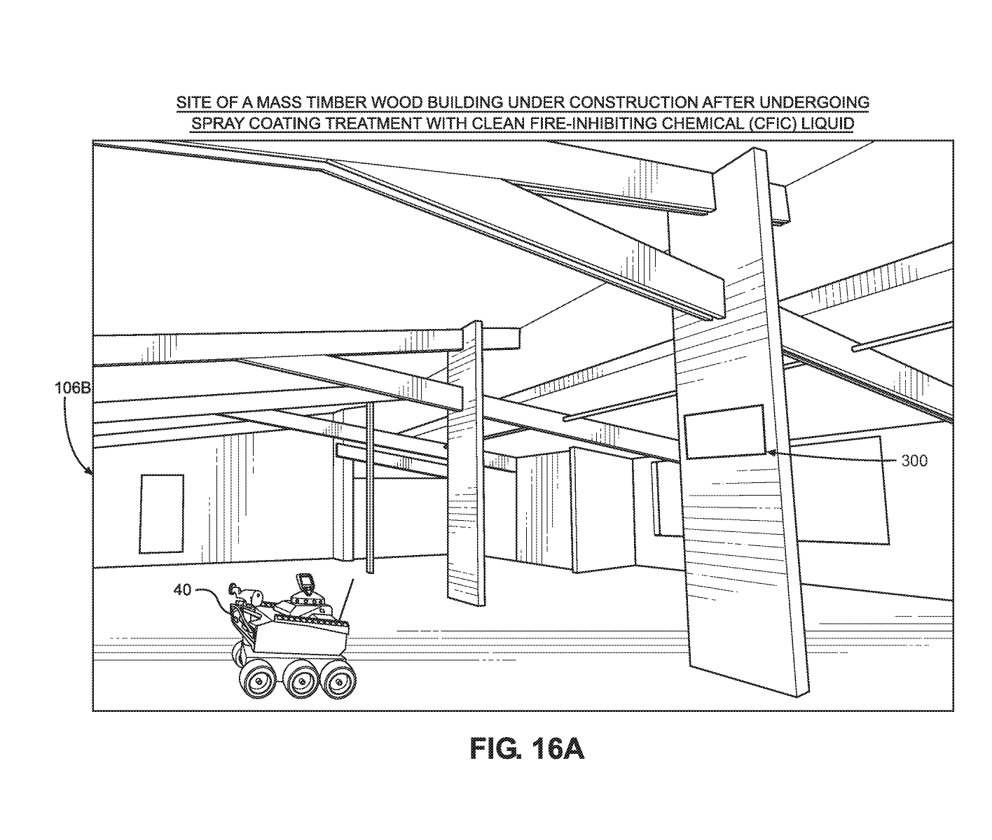

FIG. 16 shows a mass timber building under construction, in which the early building fire-outbreak/arson-attack detection and elimination system of the present invention shown in FIGS. 3 through 25 is embodied, including a global navigation satellite system (GHSS) 170 with a RTK (real-time kinematic) reference station 171 for high-resolution GPS positioning, a cellular phone and SMS messaging system 122A, a wireless internet gateway 10, and a thermally imaging drone docking and charging airport 14 mounted above the ground surface.

FIG. 16A shows a room completed within the mass timber building under construction, after all of its wood has been Class-A fire-protected using the clean fire inhibiting chemical (CFIC) liquid and spray methods and apparatus disclosed in Applicant's copending U.S. patent application Ser. No. 15/829,914 filed Dec. 2, 2017, 2018, incorporated herein by reference, and showing the AI-driven/VR-controllable thermal-imaging fire seeking and suppressing robot system of the present invention ready to respond to a fire-outbreak or arson-attack.

The same the early building fire-outbreak/arson-attack detection and elimination system described above in connection with the wood-framed building described in FIGS. 1 through 15 can be used to protect and defend mass timber buildings of any size or style, and the differences in methods of practice will be minimal.

### Early Fire-Outbreak and Arson-Attack Detection and Elimination System of the Present Invention Deployed Across a Portfolio of Wood-Framed and Mass-Timber Buildings Under Construction

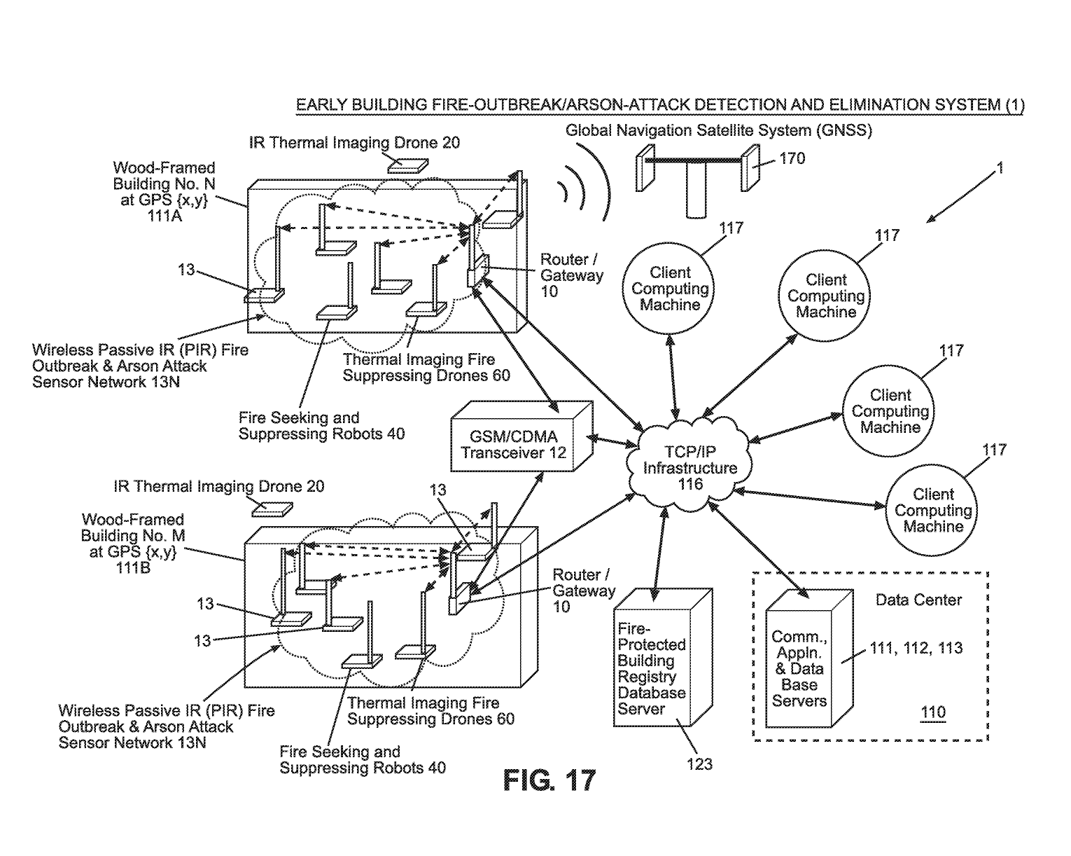

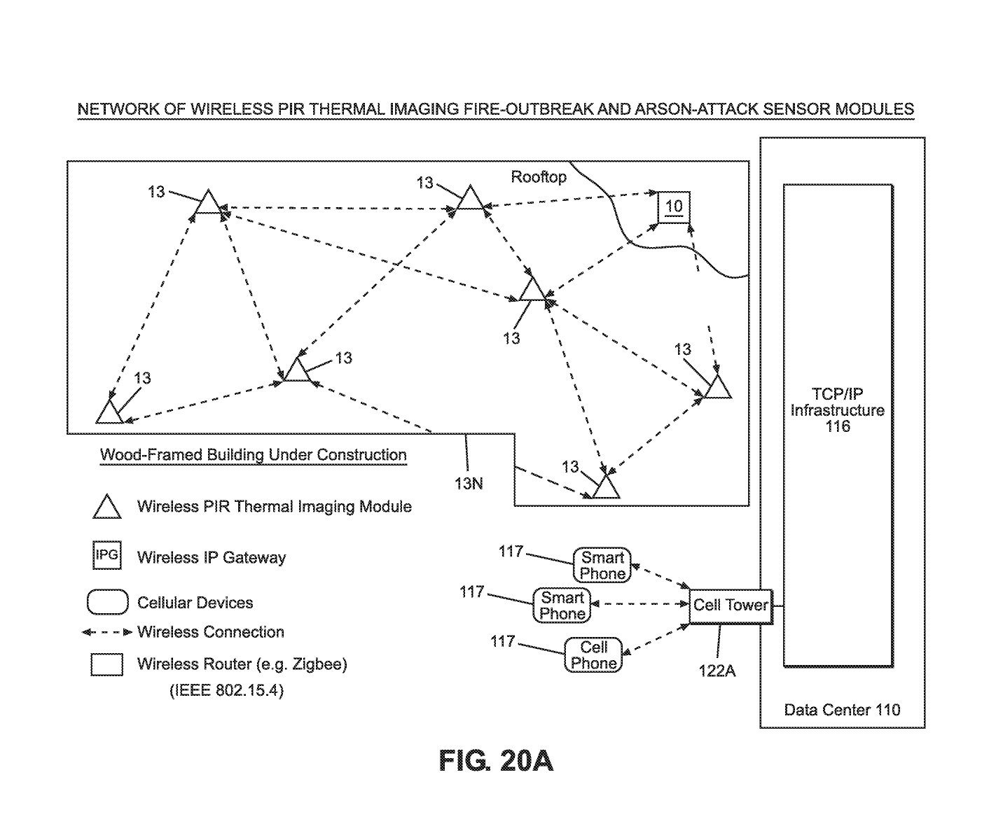

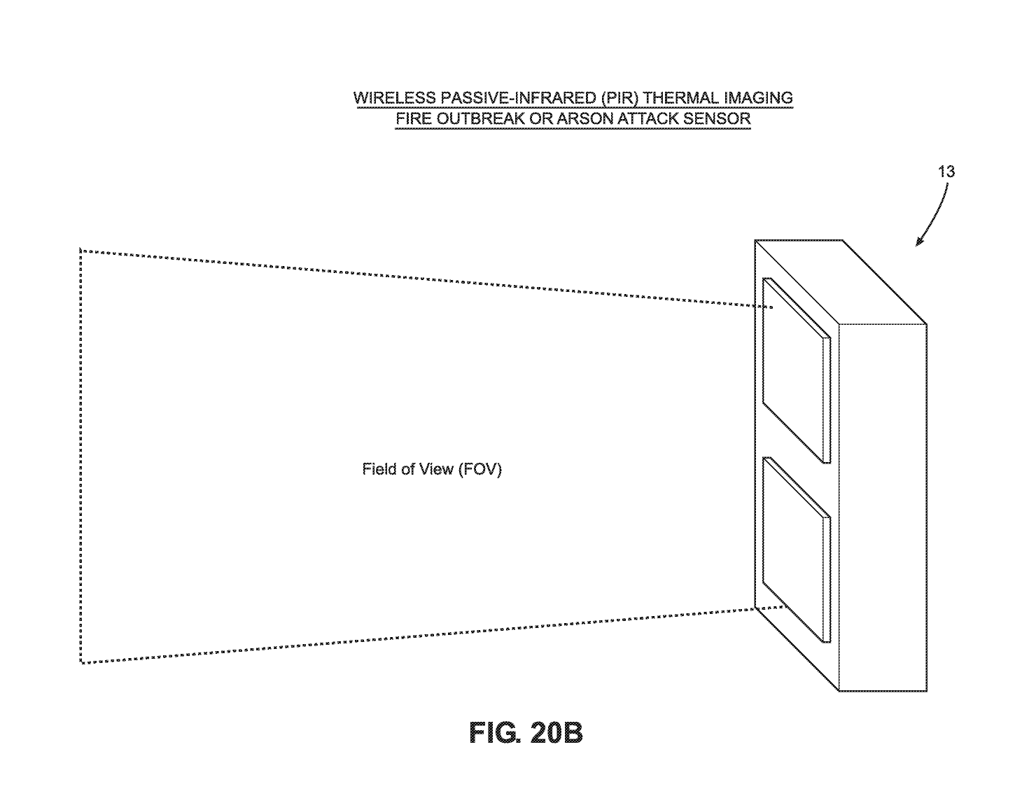

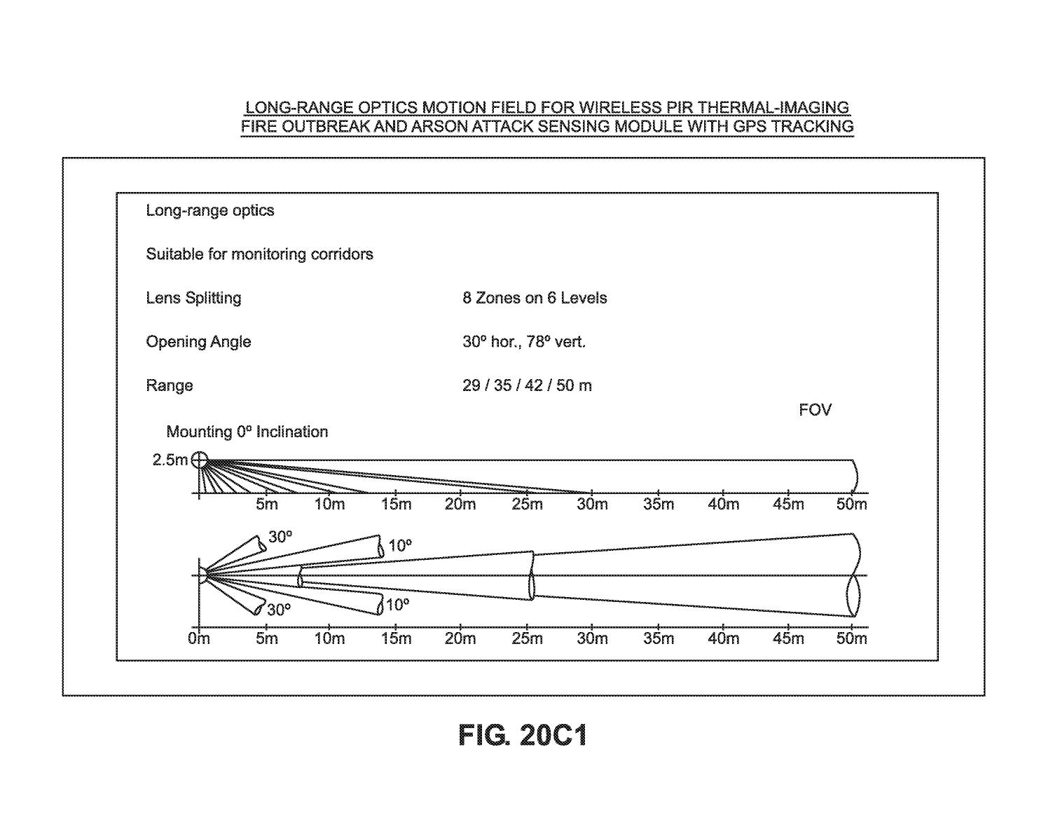

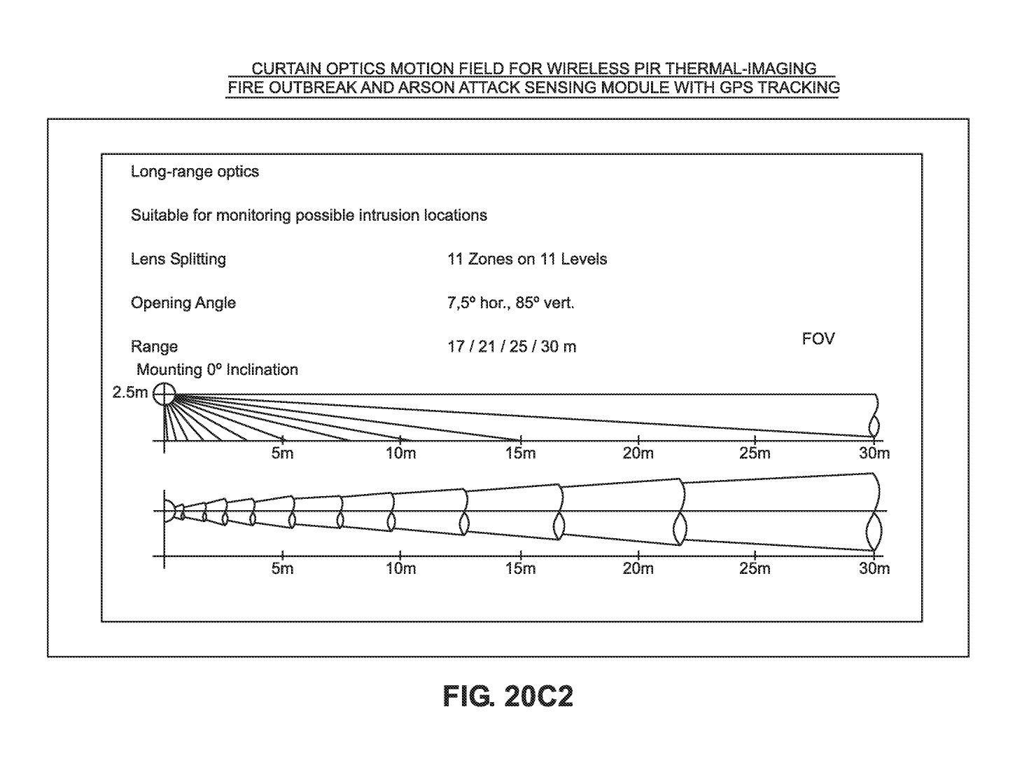

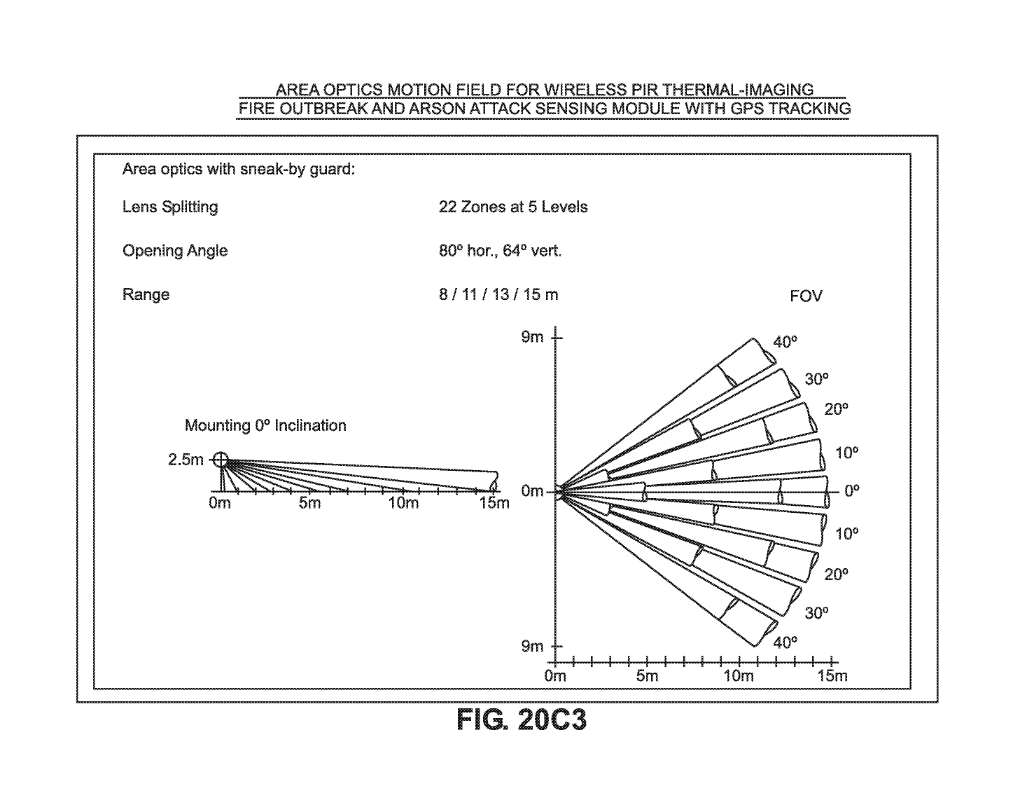

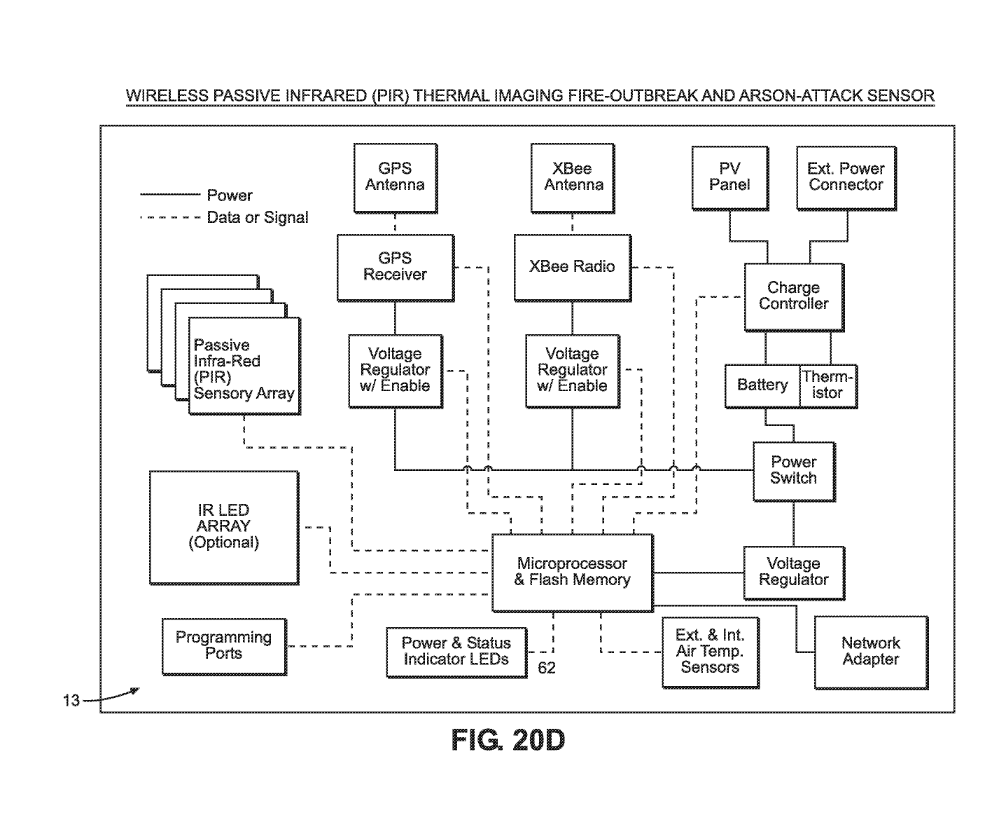

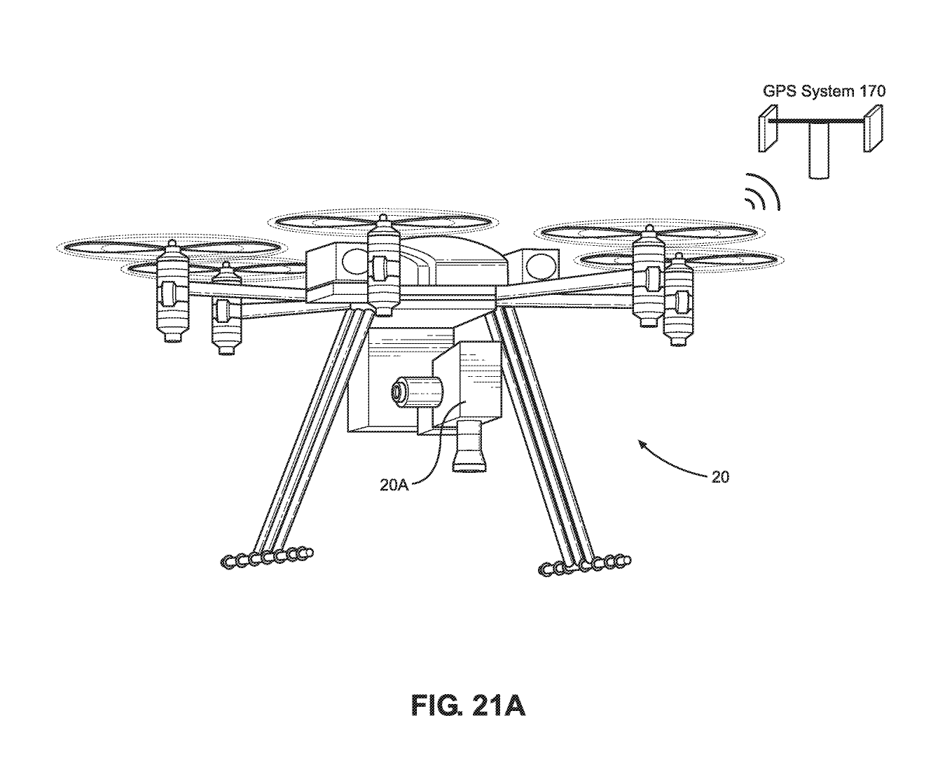

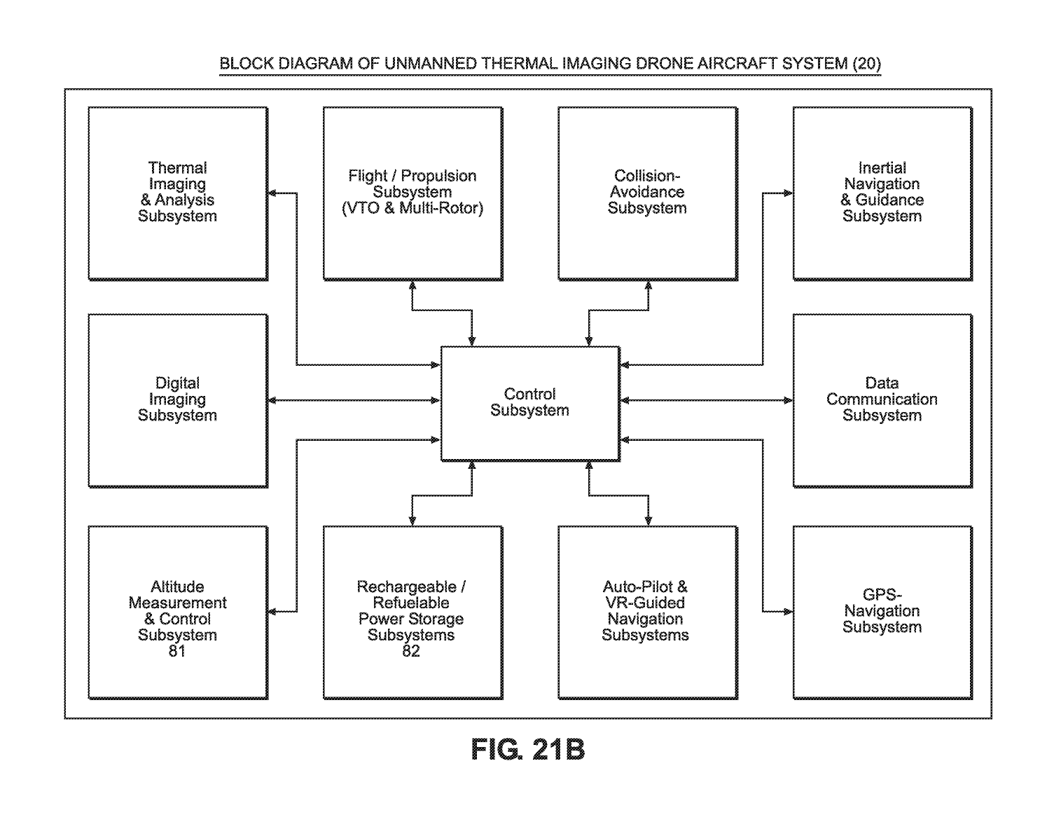

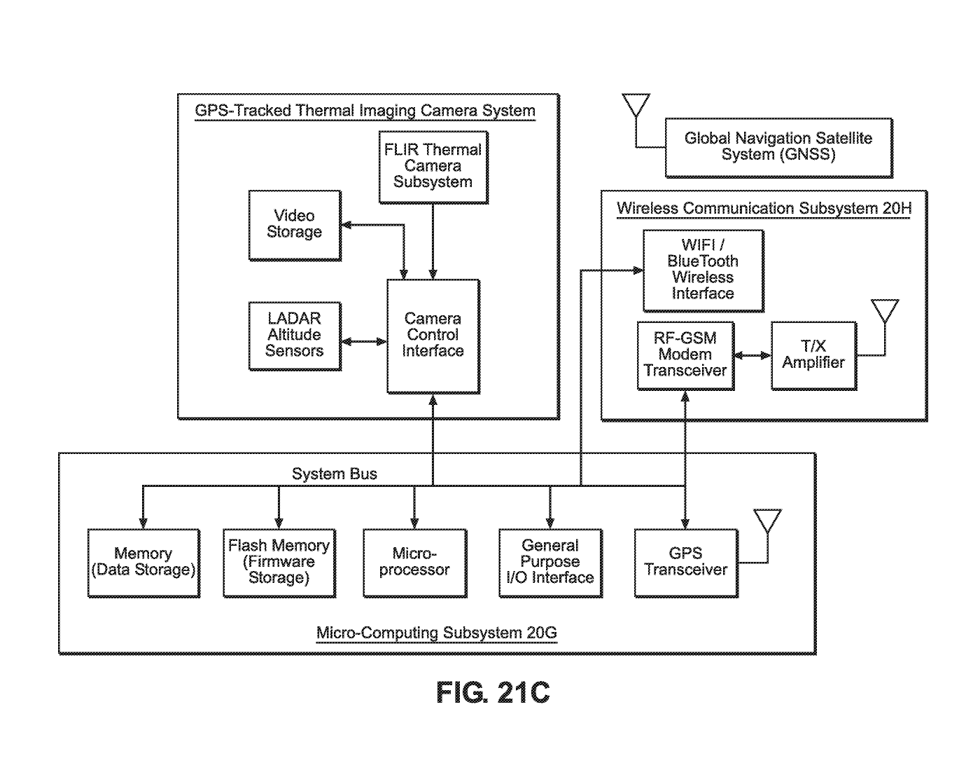

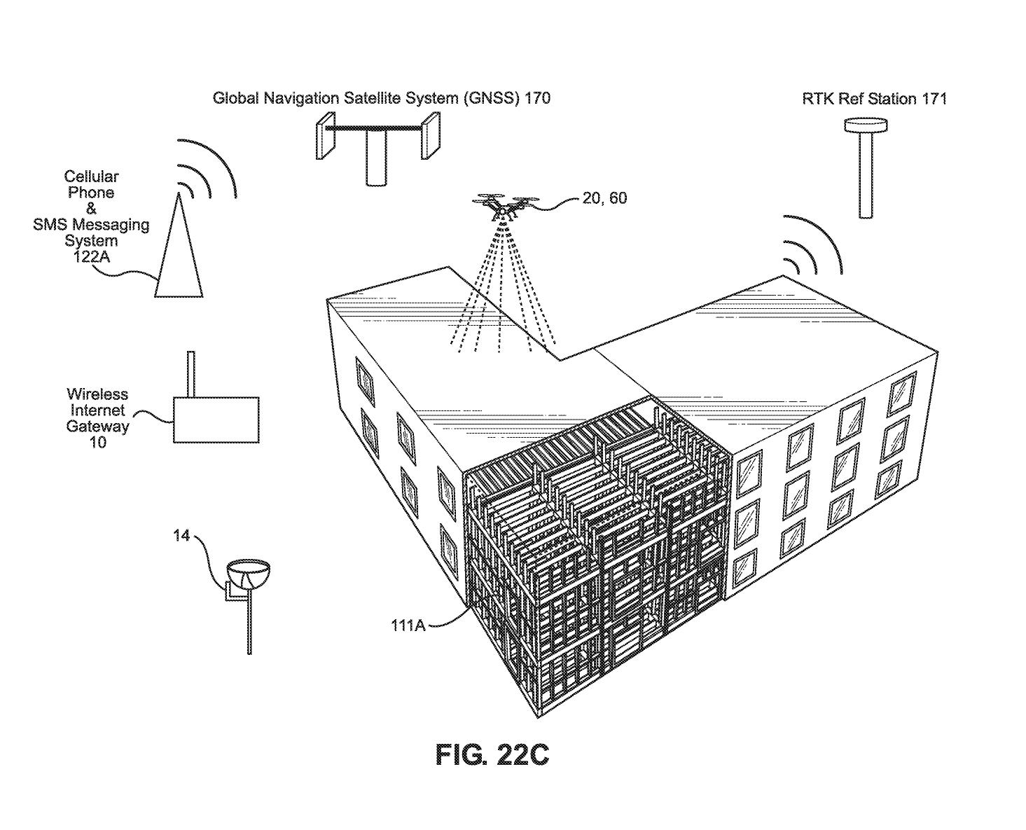

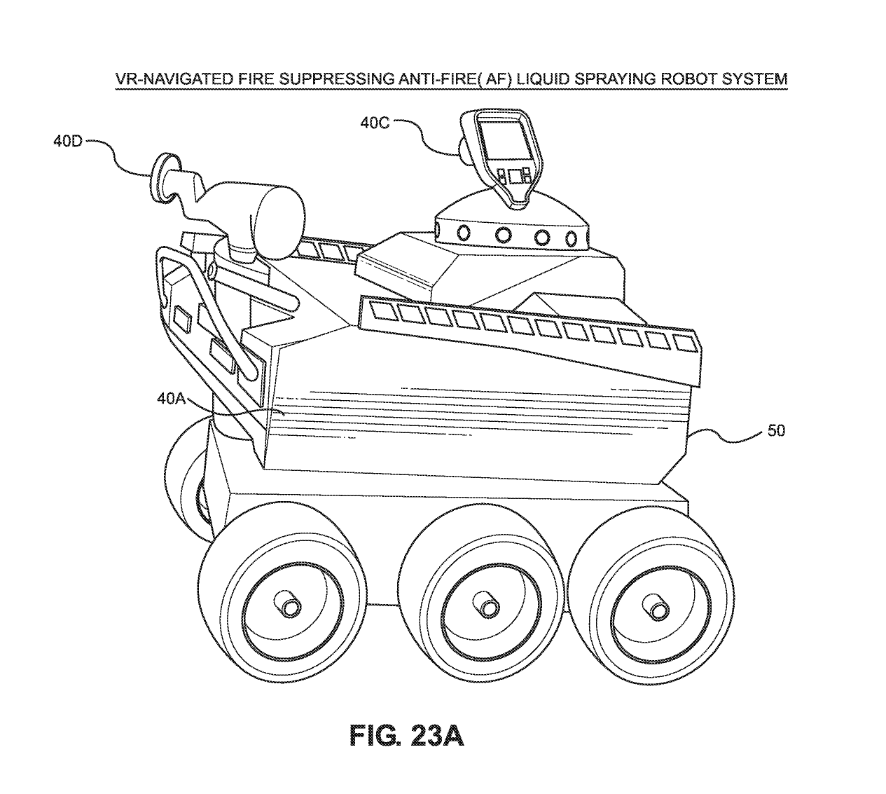

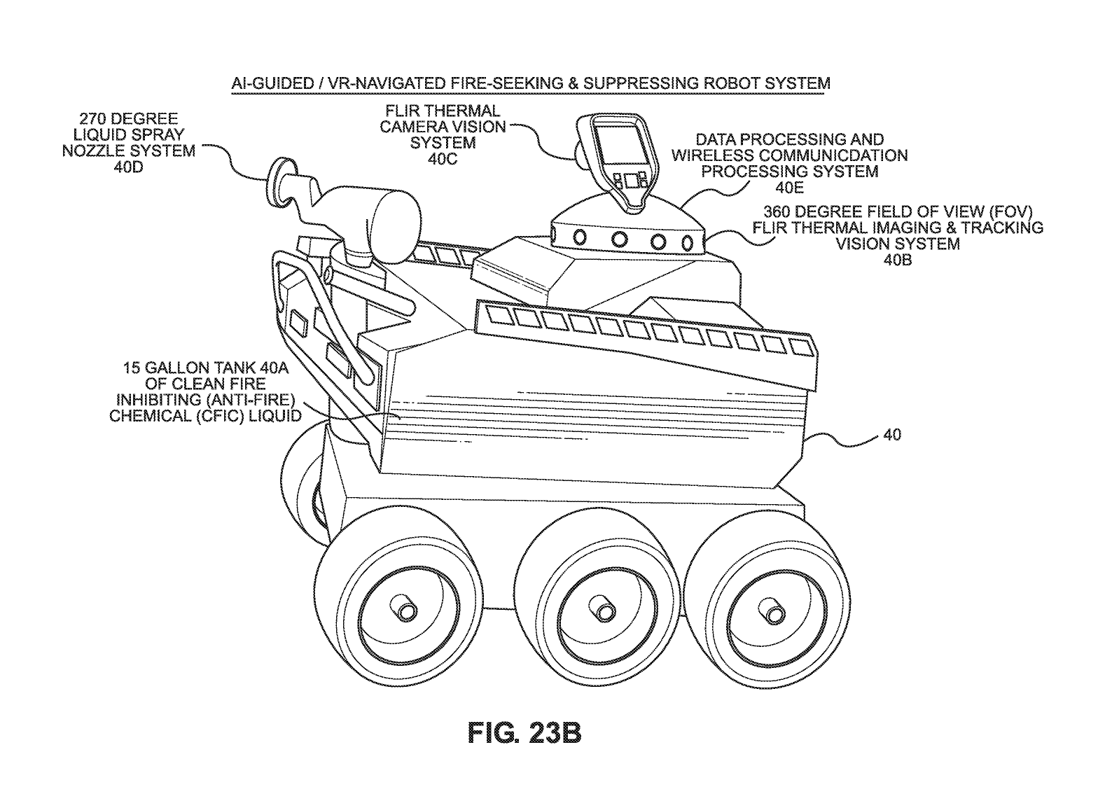

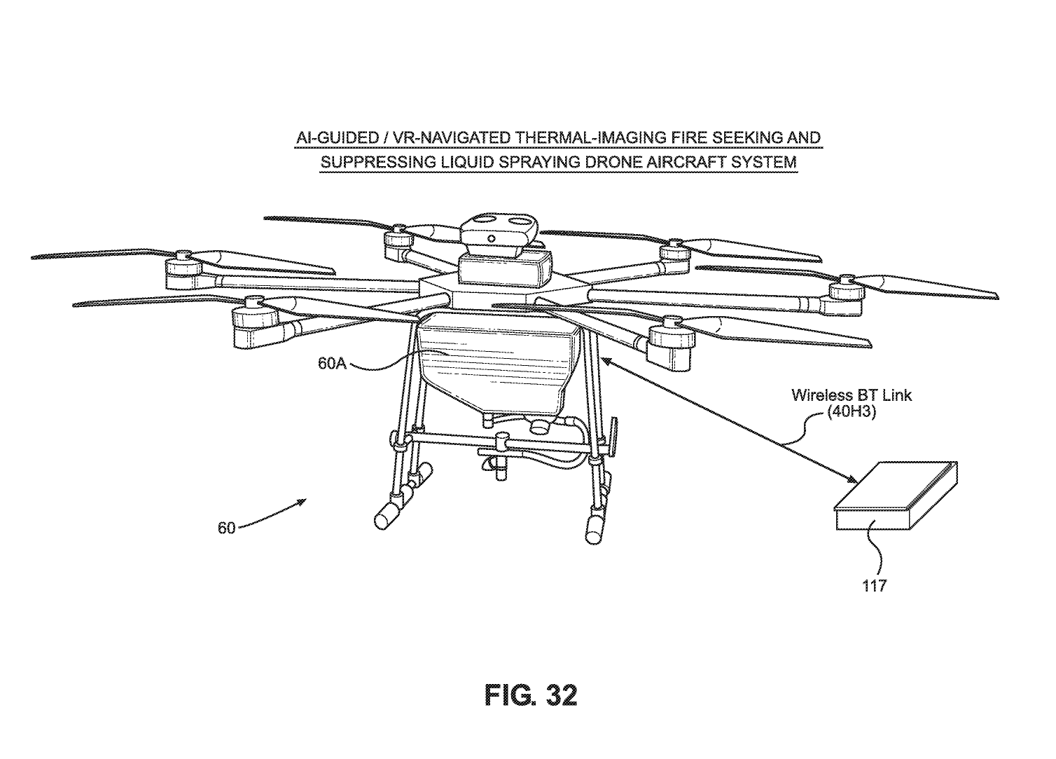

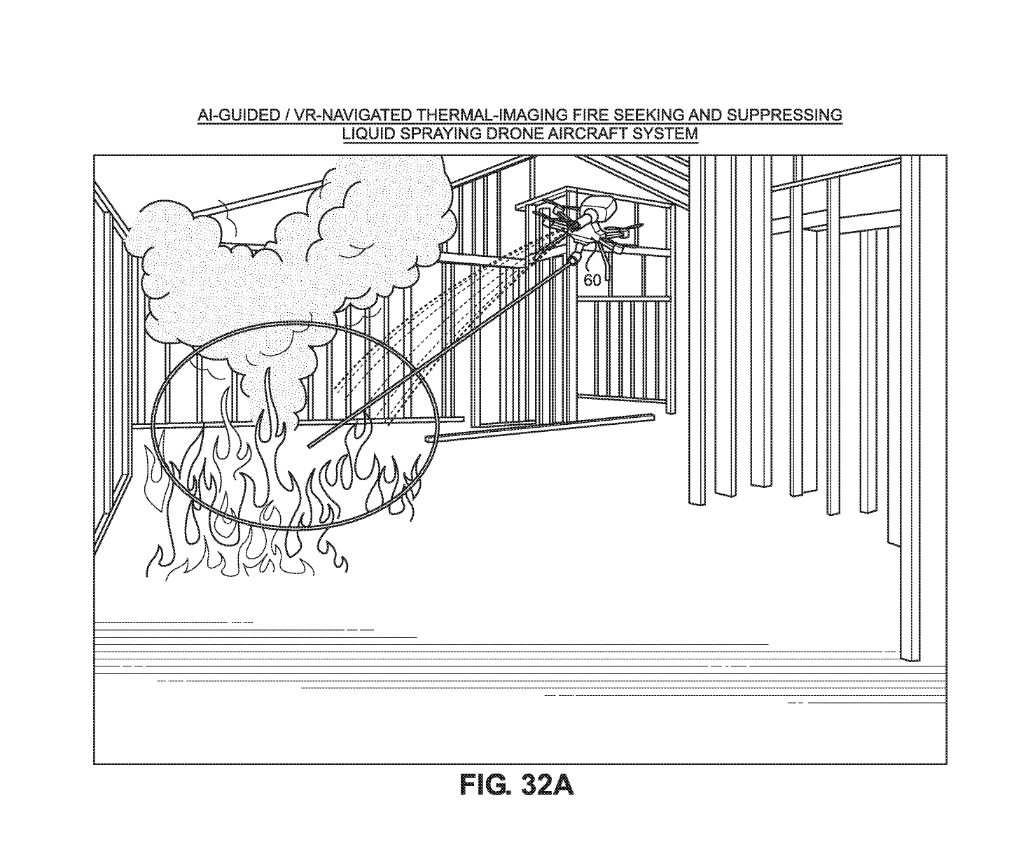

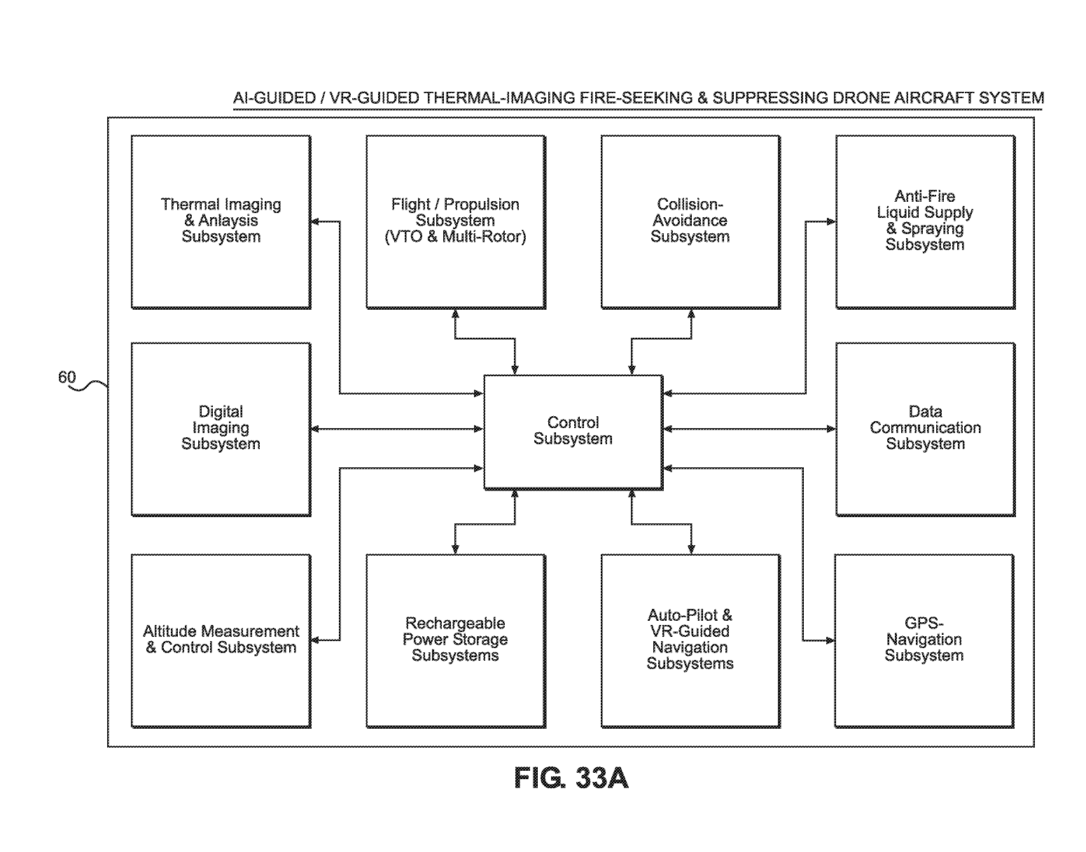

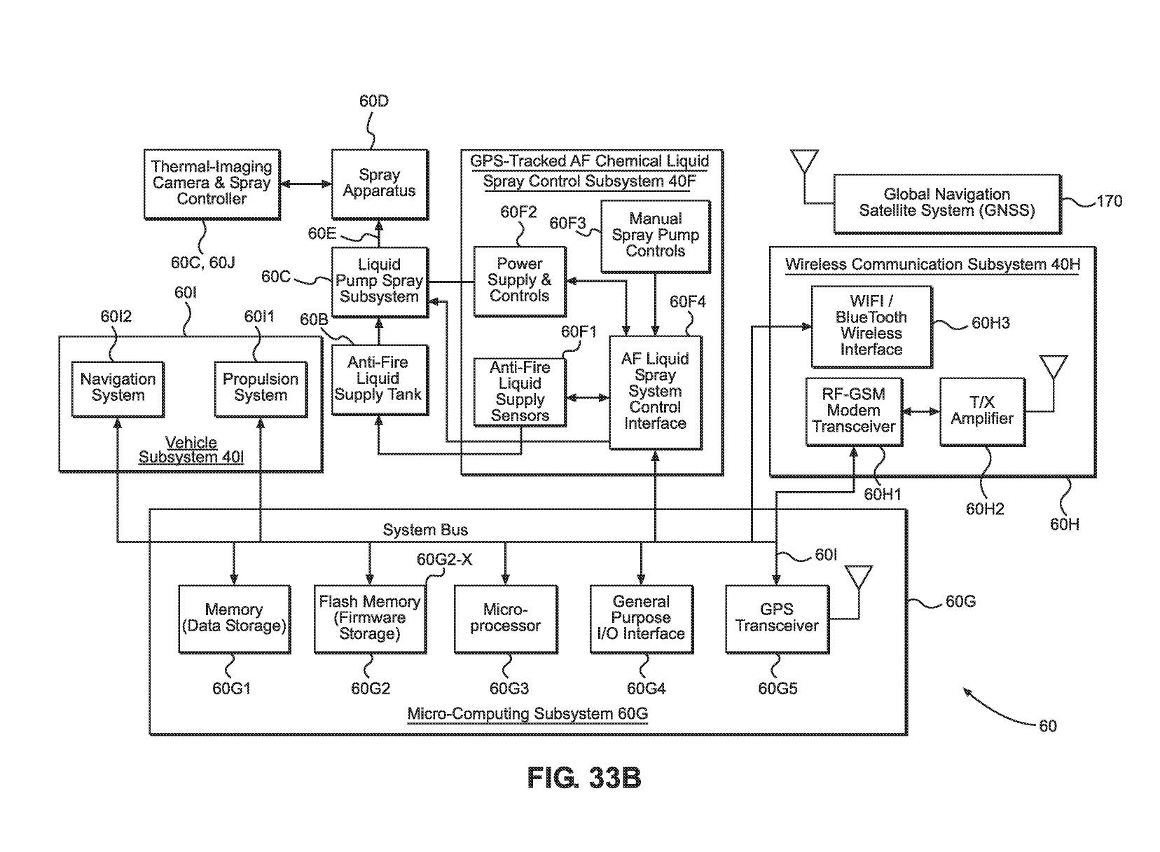

FIG. 17 shows the early fire-outbreak and arson-attack detection and elimination system of the present invention 1 deployed across a portfolio of wood-framed and mass timber buildings under construction. Within each these wood framed and mass timber buildings under construction, various wireless subsystems and devices are installed and deployed, comprising: (i) a wireless network of fire outbreak thermal imaging sensors 13 illustrated in FIGS. 20A through 20D having high-resolution thermal-imaging digital image capturing, GPS/time-date-stamping, and transmission capabilities to system video and image servers; (ii) AI/guided/VR-navigated thermal-imaging drone aircraft systems 20 shown in FIGS. 21A through 21C; (iii) AI/guided/VR-navigated fire seeking and suppressing robot systems 40 shown in FIGS. 23A through 25B having high-resolution thermal-imaging digital video image capturing and transmission capabilities; (iv) AI/guided/VR-navigated fire seeking and suppressing drone aircraft systems 60 shown in FIGS. 32 through 33B having high-resolution thermal-imaging digital video image capturing and transmission capabilities; (v) VR-enabled navigation and control stations (e.g. workstations and mobile form factors) 80 for remotely controlling the operation of VR-guided fire suppressing robot and drone systems 40 and 60 during fire suppression operations; wherein all such subsystems being integrated with and in communication with the data center 110 and internet (TCP/IP) infrastructure of the building intelligence collection, processing and information management system, and are tracked in real-time using a GNSS referencing system 170 and local RTF stations 171 deployed about the wood-framed and mass timber buildings under construction.

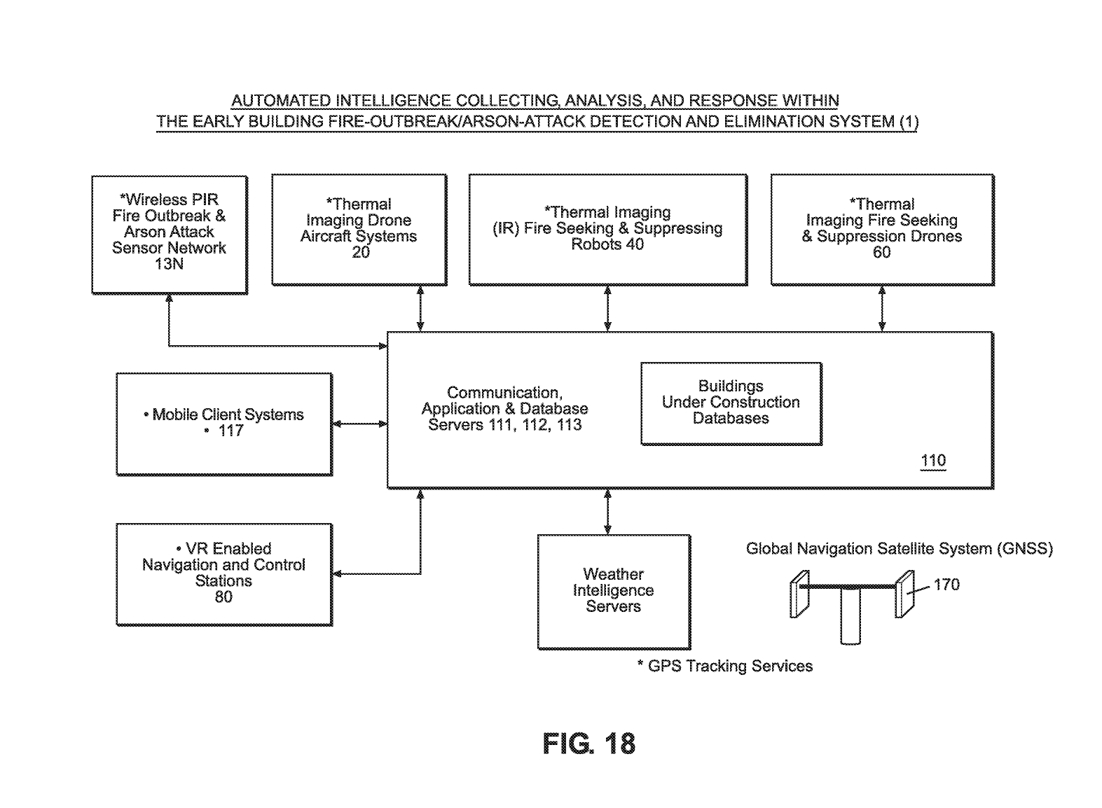

FIG. 18 illustrates the flow of various streams of intelligence (i.e. information) gathered by the communication, application and database servers in the data center 110 of the early building fire-outbreak/arson-attack detection and elimination system, from the various subsystems that collect building intelligence, including, for example, building fire-outbreak sensing module 13, unmanned/flying thermal imaging aircraft systems (i.e. drones) 20, unmanned fire fighting robot systems 40, hand-held VR-enabled robot navigation and control systems 80, and weather intelligence servers (e.g. weather reporting and forecasting services).

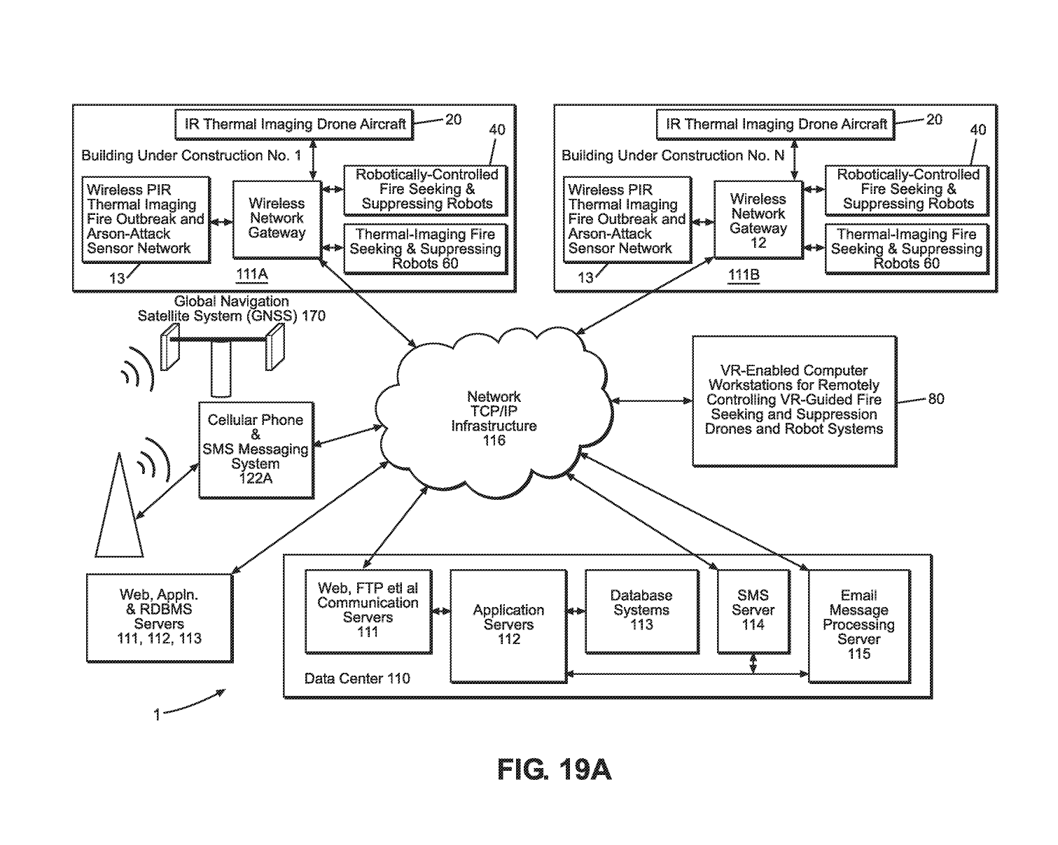

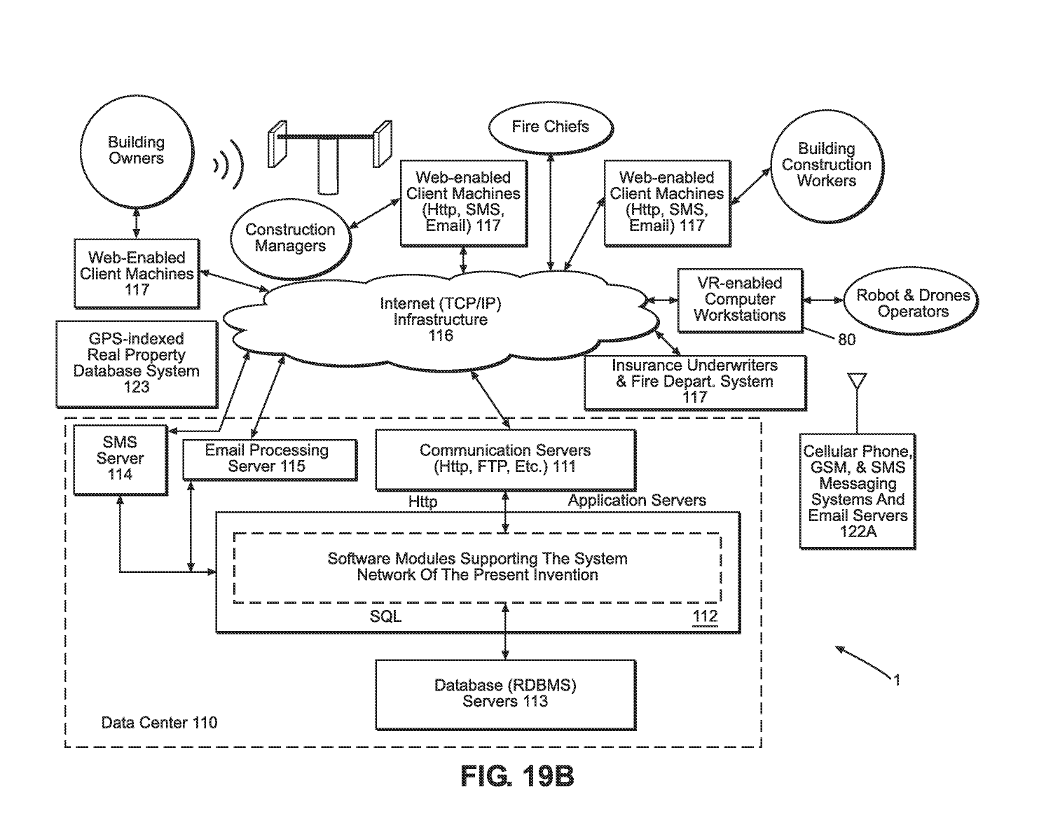

FIG. 19A is a high-level network diagram showing the primary components of system network supporting the early building fire-outbreak/arson-attack detection and elimination system of the present invention reflected in FIG. 1 including a building intelligence collection, analysis and response network embedded within each wood-framed or mass timber building under construction, and each comprising client and server systems interconnected therewith via TCP/IP, to the data center of the system network, supporting cellular phone and SMS messaging systems deployed on the Internet, Web-enabled client machines (e.g. mobile computers, smartphones, laptop computers, workstation computers, etc.), email server systems, hand-held VR-enabled control stations for remotely controlling VR-navigated and controlled fire fighting robot systems deployed inside the buildings;

FIG. 19B showing the various client systems and users thereof connected to the system network 1 supporting the early building fire-outbreak/arson-attack detection and elimination system reflected in FIG. 1 including, for example: (i) Web-enabled client machines (e.g. mobile computers, smartphones, laptop computers, workstation computers, etc.) 117; (ii) VR-enabled control stations 80 for remotely controlling VR-navigated and controlled fire seeking and suppressing robot systems 40 deployed inside wood-framed or mass timber buildings under construction; (iv) VR-enabled navigation and control stations 80 for remotely controlling VR-navigated and controlled thermal-imaging drone aircraft systems 20 and robot systems deployed about specified buildings under construction

### Specification of the Wireless Network of Passive Infra-Red (PIR) Thermal-Imaging Fire Outbreak and Arson Attack Sensor Network Deployed in Each Class-A Fire-Protected and Defended Section of a Wood-Framed and Mass Timber Building

FIG. 20A shows the wireless network of passive infra-red (PIR) thermal-imaging fire outbreak and arson attack sensor network 13N of the present invention deployed in a wood-framed or mass timber buildings under construction. As shown in FIGS. 20B, 20C and 20D, each PIR thermal imaging sensor 13 comprise; various components arranged and configured about a microprocessor and flash memory (i.e. control subsystem), including: one or more passive infra-red (PIR) thermal-imaging sensors connected together with suitable IR optics to project IR signal reception field of view (FOV) before the IR receiving array; a GPS antenna; a GPS signal receiver; voltage regulator; an Xbee antenna; an Xbee radio transceiver; a voltage regulator; an external power connector; a charge controller; a battery; thermistors; a power switch; a voltage regulator; external and internal temperature sensors; power and status indicator LEDs; programming ports; a digital/video camera; and other environment sensors adapted for collecting and assessing building intelligence, in accordance with the spirit of the present invention. In the illustrative embodiment, the fire outbreak detection system has a computing platform, network-connectivity (i.e. IP Address), and is provided with native application software installed on the system as client application software designed to communicate over the system network and cooperate with application server software running on the application servers of the system network, thereby fully enabling the functions and services supported by the system, as described above. In the illustrative embodiment, a wireless mess network is implemented using conventional IEEE 802.15.4-based networking technologies to interconnect these wireless subsystems into subnetworks and connect these subnetworks to the internet infrastructure of the system of the present invention.

FIGS. 20CA, 20C2 and 20C3 show three different variable optics field that can be supported for motion detection and thermal-imaging within the wireless PIR thermal imaging sensor 13 of the present invention shown in FIG. 20B.

FIG. 20C1 illustrates the long-range optics supported within the wireless PIR thermal-imaging fire-outbreak and arson-attack sensing module of FIG. 20B, along with GPS-tracking and GPS/time/date-stamping, for monitoring narrow areas including corridors for thermal activity and motion.

FIG. 20C2 illustrates the curtain optics supported within wireless PIR thermal-imaging fire-outbreak and arson-attack sensing module of FIG. 20B, along with GPS-tracking and GPS/time/date-stamping, for monitoring possible intrusion locations for thermal activity and motion.

FIG. 20C3 illustrates the area optics supported within the wireless PIR thermal-imaging fire-outbreak and arson-attack sensing module of FIG. 20B, along with GPS-tracking and GPS/time/date-stamping, for monitoring particular areas with specific ranges for thermal activity and motion.

Preferably, the optics of the motion and thermal activity sensor 13 is constructed so that the installer can easily select the desired IR optics for the specific motion sensing application at hand—e.g. by selecting a manual externally located optics selector switch provided on the sensor housing, to configure a specific optics arrangement for the sensor in a specific completed section of the wood-framed building. However, in the alternative, several different sensors can be manufactured, each having different IR optics for a specific thermal and motion sensing application at hand, which are selected for use during the installation process. In general, installation of thermal-imaging motion sensors is an ongoing and incremental process as Class-A fire-protection spraying is performed throughout the entire building. As this fire protection process continues, so too does the extension of the wireless thermal-imaging and motion sensing network 13N of the present invention, with the addition of a few additional sensors as each additional section of the building is defended with Class-A fire-protection liquid spray treatment, as described in FIGS. 2 through 13. As this wireless sensor network is extended, additional wireless network routers will be added to extend the range of the wireless network.

Preferably, the optical bandwidth of the IR sensing array used in the thermal and motion sensor 13 of the present invention will be adequate to perform thermal activity analysis operations be simple motion detection, required of any PIR-based motion sensor. Specifically, thermal sensing in the range of the sensor should be similar to the array sensors installed in forward-looking infrared (FLIR) cameras, as well as those of other thermal imaging cameras, use detection of infrared radiation, typically emitted from a heat source (thermal radiation) such as fire, to create an image assembled for video output and other image processing operations to generate signals for use in early fire detection and elimination system of the present invention.

In a less preferred embodiment, one can adapt and modify a PIR motion sensor such as the Honeywell Viewguard PIR Motion Detector (Item Nos. 033435 and 033434) or similar PIR sensor product, to produce the GPS-tracking PIR thermal-imaging motion sensor 13 that outputs the GPS coordinates of the installed sensor and time and data stamping information with thermal image(s) that triggered the specific threshold motion detection algorithms used to detect motion and/or suspicious thermal activity, within the image processing capabilities of the sensor. This motion triggering information will be provided to the surveillance and fire security information servers maintained on the system network 1 for automatically generating and issuing the necessary commands to (i) deployed thermal-imaging drone systems 20, (ii) deployed thermal-imaging fire seeking and suppressing robot systems 40, and (iii) deployed thermal-imaging fire seeking and suppressing drone aircraft vehicles 60.

In general, most streams of digital intelligence captured by the wireless PIR thermal-imaging FLIR sensor network will be time and data stamped, as well as GPS-indexed by a local GPS receiver within the sensing module, so that the time and source of origin of each data package is recorded within the system database. The GPS referencing system supporting the system transmits GPS signals from satellites to the Earth's surface, and local GPS receivers located on each networked device or machine on the system network receive the GPS signals and compute locally GPS coordinates indicating the location of the networked device within the GPS referencing system.

When practicing the wireless network of the present invention, any low power wireless networking protocol of sufficient bandwidth can be used. In one illustrative embodiment, a Zigbee® wireless network would be deployed inside the wood-framed or mass timber building under construction, so as to build a wireless internetwork of a set of wireless PIR thermal-imaging fire outbreak detection systems deployed as a wireless subnetwork deployed within the building under construction. While Zigbee® technology, using the IEEE 802.15.1 standard, is illustrated in this schematic drawing, it is understood that any variety of wireless networking protocols including Zigbee®, WIFI and other wireless protocols can be used to practice various aspects of the present invention. Notably, Zigbee® offers low-power, redundancy and low cost which will be preferred in many, but certainly not all applications of the present invention. In connection therewith, it is understood that those skilled in the art will know how to make use of various conventional networking technologies to interconnect the various wireless subsystems and systems of the present invention, with the internet infrastructure employed by the system of the present invention.

### Specification of Airborne/Flying Unmanned IR Thermal-Imaging Drone Subsystem Deployed in the Early Building Fire-Outbreak/Arson-Attack Detection and Elimination System

FIG. 21A shows an airborne/flying unmanned IR thermal-imaging drone subsystem deployed in the early building fire-outbreak/arson-attack detection and elimination system. As shown, the system 20 comprises: an aircraft body housing four vertically-mounted symmetrically arranged propeller-type rotors, supporting vertical take off (VTO) and pitched flight over buildings under construction while (i) measuring the thermal profile of fires burning in a building under construction, and (ii) capturing digital video images within the field of view (FOV) of its onboard camera subsystem during its course of travel. By this process, information is collected for processing and the generation of GPS-indexed time-stamped fire thermal profile maps of the building under construction including before, during and after fire outbreaks and arson attacks, in accordance with the principles and teachings of the present invention.

As shown in FIG. 21B, the unmanned thermal imaging drone aircraft system 20 comprises: a PIR thermal-imaging subsystem 20A with FLIR functionalities; a flight/propulsion subsystem enabling vertical take off (VTO) flight using multi-rotor systems; a collision avoidance subsystem; an inertial navigation & guidance subsystem; a digital imaging (i.e. video camera) subsystem; a data communication subsystem; an altitude measurement and control subsystem; an auto-pilot subsystem; a GPS navigation subsystem; and a control subsystem for controlling and/or managing the other subsystems during system operation.

As shown in FIG. 21C, the unmanned thermal imaging drone aircraft system 20 of FIGS. 21A and 21B, comprises: a GPS-tracked thermal imaging camera subsystem 20A; a micro-computing platform or subsystem 20G interfaced with the GPS-tracked and remotely-monitored AF chemical liquid spray control subsystem 30F by way of a system bus 20I; a wireless communication subsystem 20H interfaced to the micro-computing platform 20G via the system bus 20I; and a vehicular propulsion and navigation subsystem 20I employing a propulsion subsystem 20I1 and AI-driven or manually-driven navigation subsystem 20I2.

As configured in the illustrative embodiment, the thermal imaging drone system 20 enables and supports (i) the remote thermal monitoring of a wood-framed building or section thereof located at specific GPS-indexed location coordinates, and (ii) the logging of all such GPS-indexed thermal imaging operations, and recording the data transactions thereof within a local database maintained within the micro-computing platform 20G, as well as in the remote network database 113 maintained at the data center 110 of the system network.

As shown in FIG. 21C, the micro-computing platform 20G comprises: data storage memory 20G1; flash memory (firmware storage) 20G2; a programmable microprocessor 20G3; a general purpose I/O (GPIO) interface 20G4; a GPS transceiver circuit/chip with matched antenna structure 20G5; and the system bus 20I which interfaces these components together and provides the necessary addressing, data and control signal pathways supported within the system 20. As such, the micro-computing platform 20G is suitably configured to support and run a local control program 30G2-X on microprocessor 30G3 and memory architecture 30G1, 30G2 which is required and supported by the enterprise-level mobile application 12 and the suite of services supported by the system network 1 of the present invention.

As shown in FIG. 21C, the wireless communication subsystem 20H comprises: an RF-GSM modem transceiver 20H1; a T/X amplifier 20H2 interfaced with the RF-GSM modem transceiver 20H1; and a WIFI interface and a Bluetooth wireless interface 20H3 for interfacing with WIFI and Bluetooth data communication networks, respectively, in a manner known in the communication and computer networking art.

As shown in FIG. 21C, the GPS-tracked thermal imaging camera subsystem 20J comprises: an FLIR thermal camera subsystem 20J1: a camera control interface 20J2; a LADAR altitude sensor 20J4; and video storage 20J3, configured as shown. The flash memory storage 20G2 contains microcode for a control program that runs on the microprocessor 20G3 and realizes the various GPS-specified thermal imaging analysis, processing, control, monitoring, data logging and management functions supported by the system 20.

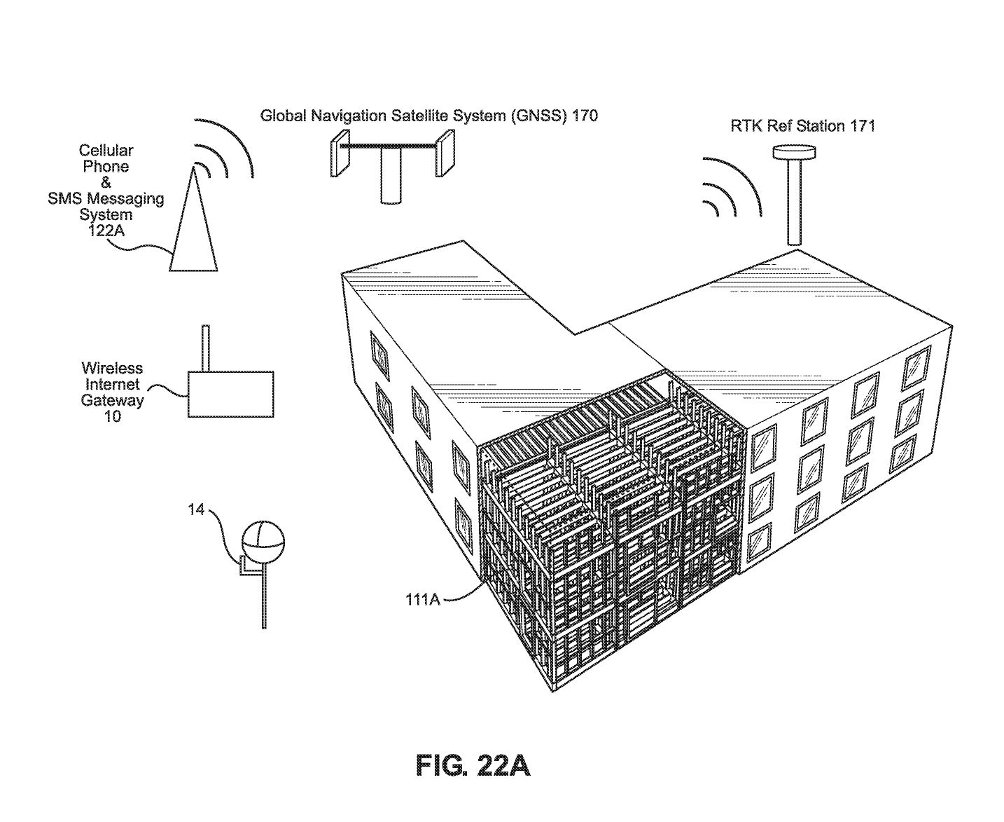

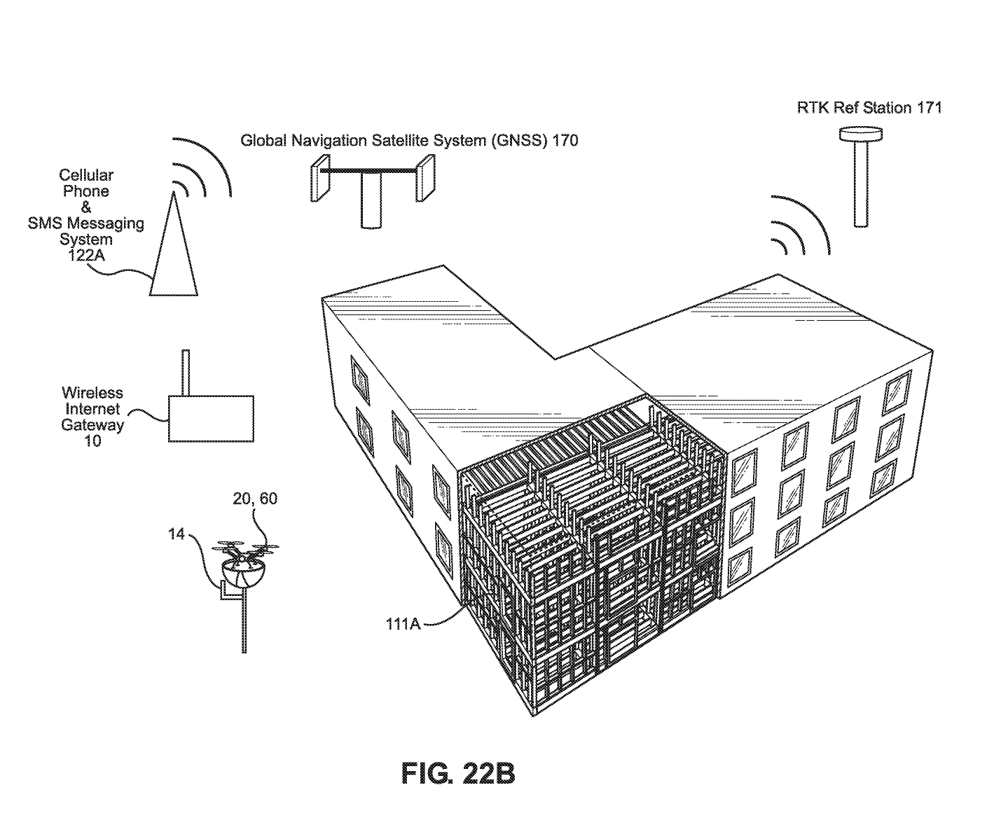

FIG. 22A shows the wood-framed building under construction shown in FIG. 1, with a sheltering system 14 for the thermal-imaging drones of the present invention, described above. As shown in FIG. 22A, the shelter system is arranged in its closed mode, with its hinged housing portions closed about its unmanned thermal imaging drone aircraft supported on its landing support platform. FIG. 22B shows the building with its thermal imaging drone sheltering dome system 14 arranged in its open mode, with its hinged housing portions opened and removed away from the unmanned thermal imaging drone aircraft 20 supported on its landing support platform. FIG. 22C shows the building shown with the thermal imaging drone sheltering dome system 14 arranged in its open mode, with the unmanned thermal-imaging drone aircraft flying 20 above the wood-framed building in which an arson fire is burning. Shelter systems can be used for all unmanned flying drones deployed on the system network.

### Specification of the AI-Guided/VR-Navigated Thermal-Imaging Fire Seeking and Suppressing Robot System of the Present Invention

FIGS. 23A and 23B show the AI-guided/VR-navigated thermal-imaging fire seeking and suppressing robot system of the present invention 40, with its tanker style body 40A containing a supply of clean anti-fire (AF) liquid (e.g. Hartindo AF31 anti-fire liquid), spray nozzle gun 40D controlled by thermal-images captured and analyzed in real-time by its onboard FLIR thermal imaging camera subsystem 40C, so as to seek, find, track and suppress fire outbreaks within the wood-framed building, in accordance with the principles of the present invention.

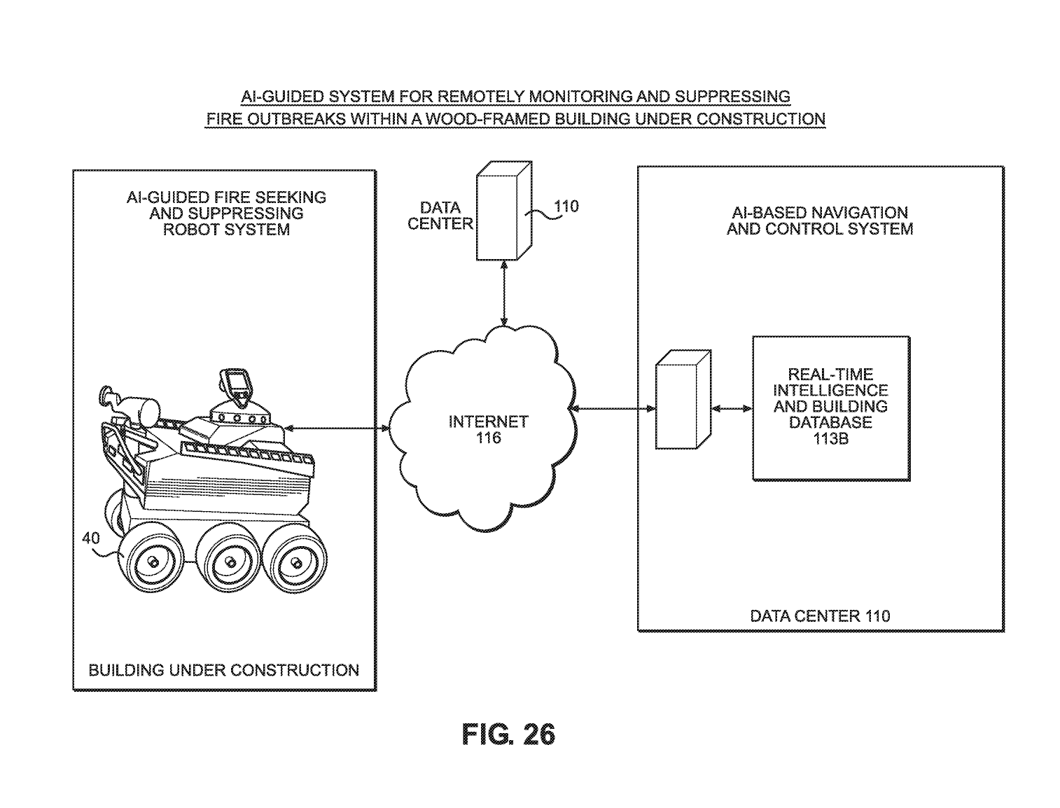

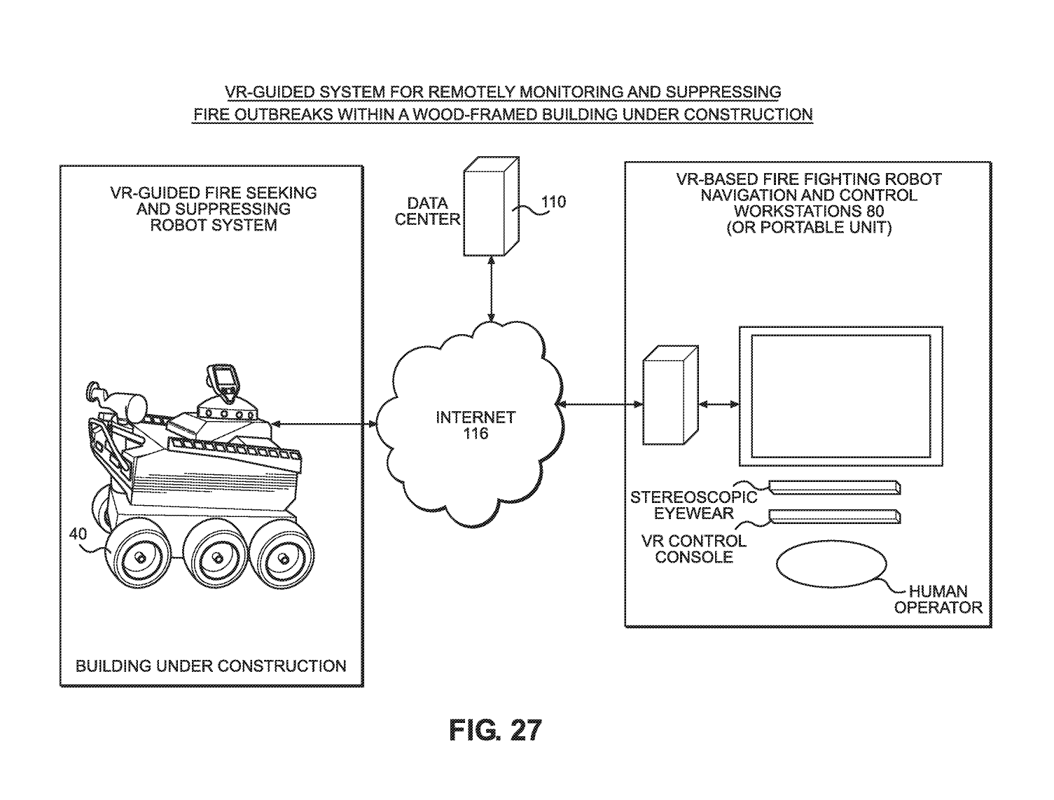

AI-guided/VR-navigated thermal-imaging fire seeking and suppressing robot system 40 has two modes of navigation and control: (1) it can be navigated and controlled by artificial intelligence (AI) algorithms, systems and techniques known in the vehicle navigation and control art, as illustrated in FIG. 26; or (2) it can be controlled by a human operator using a VR-enabled navigation and control interface/console system 80 as shown in FIGS. 27, 28 and 29. Alternatively, a hybrid mode employing both AI and VR-enabled techniques may be used with advantageous results. Both of these modes of operations will be described in greater detail hereinafter.

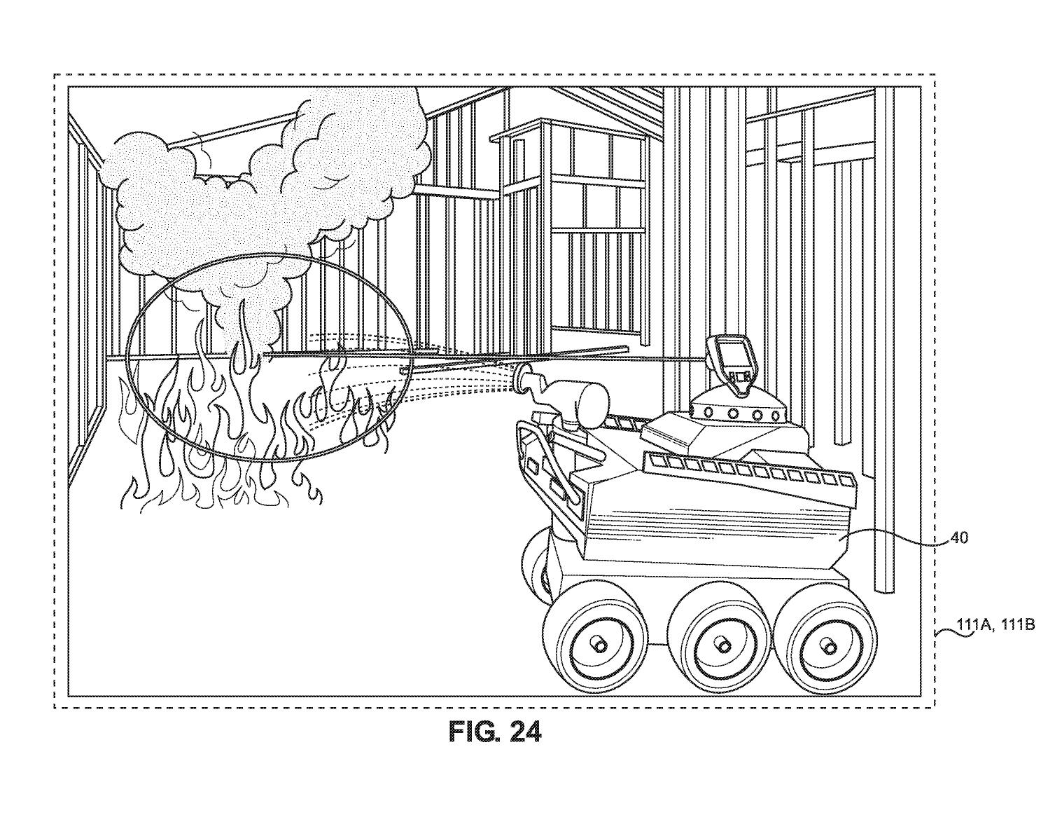

FIG. 24 show the AI-guided/VR-navigated thermal-imaging fire seeking and suppressing robot system 40, in operation eliminating a detected fire outbreak or arson strike within the interior of a wood-framed or mass timber building that has been defended using the Class-A fire-protection methods described in FIGS. 3A through 15. As shown, the robotically-controlled spray nozzle 40D is automatically tracked onto the blazing arson fire and sprays a field-constrained stream of AF liquid onto the field of the fire to eliminate the thermally-tracked fire in an early manner inside the defended building.

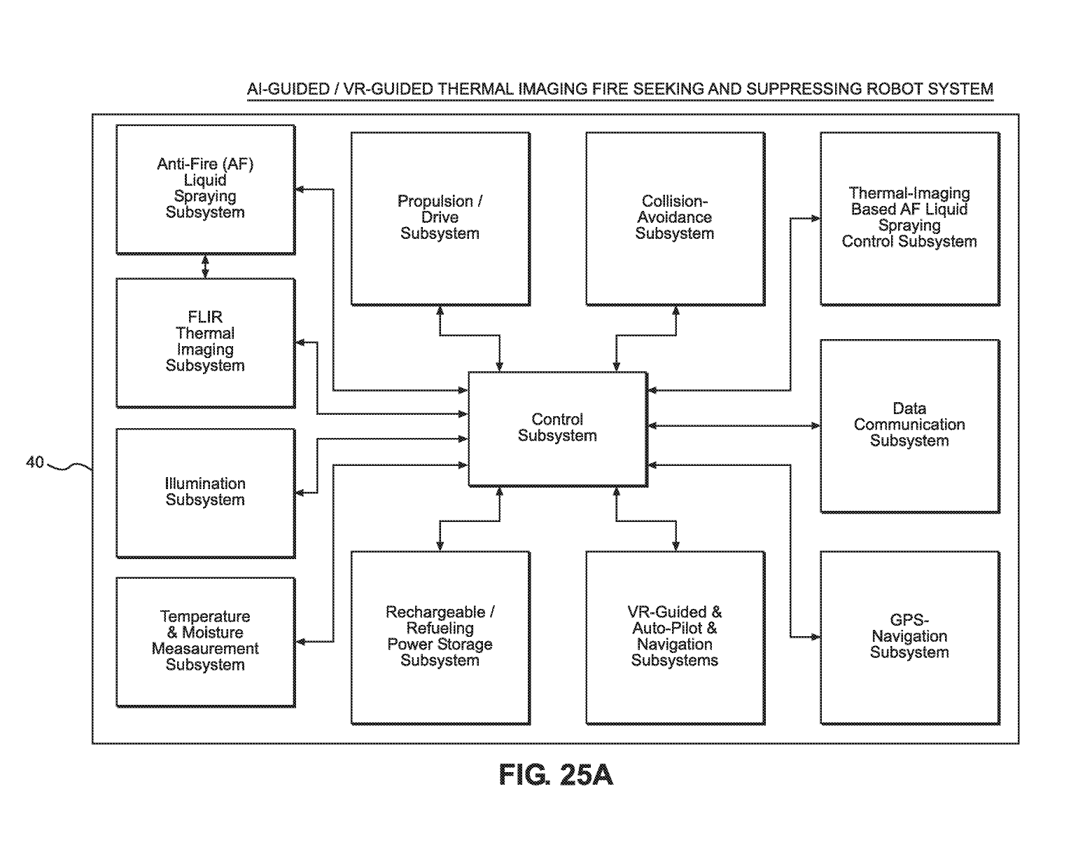

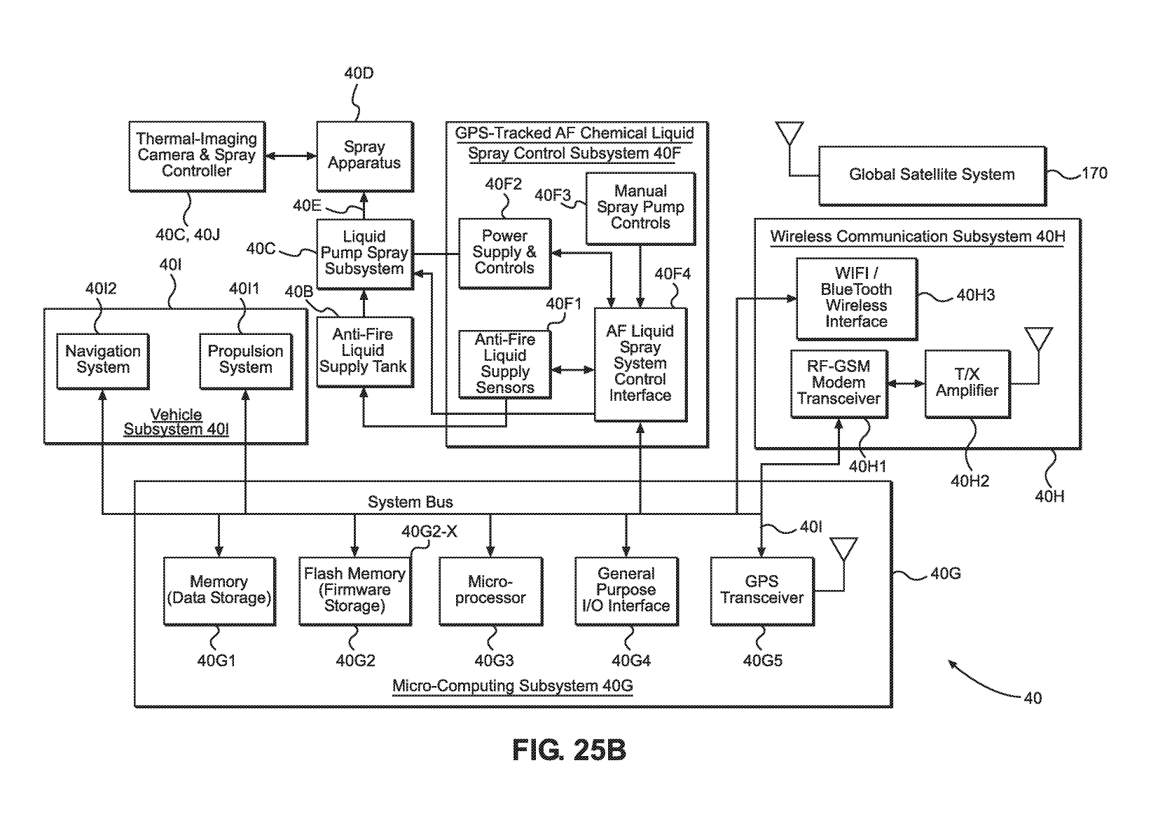

FIG. 25A shows the thermal-imaging guided (or VR-guided) fire seeking and suppressing robot system 40 depicted in FIGS. 23A, 23B, 24, comprising: its anti-fire (AF) liquid spraying nozzle 40D mounted to its front end; equipped with side, front and rear navigational camera systems; side, front and rear ranging sensors; a GPS receiver; an RTK antenna; a 900 MHZ antenna; a recharging port mounted in the rear of the system; digital video camera systems providing field of views (FOVS) in the front and rear of the robotic vehicle; multi-band wireless radio control and communications modules; and GPS-supported navigation and collision avoidance capabilities.

FIG. 25B is a block subsystem diagram for the AI-guided/VR-navigated fire seeking and suppressing robot system of FIGS. 24 and 25A, shown comprising: a lightweight frame 40A0 supporting a propulsion subsystem 40I provided with a set of electric-motor driven axles with durable wheels, driven by electrical power supplied by a rechargeable battery module 409, and controlled and navigated by a GPS-guided navigation subsystem 40I2; an integrated supply tank 40B supported on the airframe 40A0, and connected to either rechargeable-battery-operated electric-motor driven spray pump 40C, for deployment within buildings under construction; a spray nozzle assembly 40D connected to the spray pump 40C by way of a flexible hose 40E, for spraying the same with environmentally-clean anti-fire (AF) liquid under the control of the thermal-imaging-driven controller 40J controlling the spray nozzle and related apparatus 40D.

Once the robot vehicle arrives at the burning section using GPS coordinates and other collected thermal intelligence from the wireless thermal imaging sensor network, during the last leg of travel towards the fire outbreak, the robot will use real-time thermal imaging and tracking principles to seek, find and lock-onto and eliminate the fire outbreak or arson attack with a variable stream of anti-fire (AF) liquid sprayed directly onto the burning fire liquid. In a preferred embodiment, the thermal-imaging camera aboard the system will analyze thermal images captured in real-time and use the thermal and position information contain in such images to improve steering and aiming the AF liquid stream during fire suppression operations.

FIG. 25B shows the GPS-tracked robot system 40 of FIG. 25 as comprising a number of subcomponents, namely: a GPS-tracked and remotely-monitored AF chemical liquid spray control subsystem 40F; a micro-computing platform or subsystem 40G interfaced with the GPS-tracked and remotely-monitored AF chemical liquid spray control subsystem 40F by way of a system bus 40I; a wireless communication subsystem 40H interfaced to the micro-computing platform 40G via the system bus 40I; and a vehicular propulsion and navigation subsystem 40I employing propulsion subsystem 40I1, and AI-driven or manually-driven navigation subsystem 4012.

As configured in the illustrative embodiment, the GPS-tracked anti-fire liquid spraying robot system 40 enables and supports (i) the remote monitoring of the spraying of anti-fire (AF) chemical liquid from the system 40 when located at specific GPS-indexed location coordinates, and (ii) the logging of all such GPS-indexed spray application operations, and recording the data transactions thereof within a local database maintained within the micro-computing platform 40G, as well as in the remote network database 9C1 maintained at the data center 8 of the system network 1.

As shown in FIG. 25B, the micro-computing platform 40G comprises: data storage memory 40G1; flash memory (firmware storage) 40G2; a programmable microprocessor 40G3; a general purpose I/O (GPIO) interface 40G4; a GPS transceiver circuit/chip with matched antenna structure 40G5; and the system bus 40I which interfaces these components together and provides the necessary addressing, data and control signal pathways supported within the system 40. As such, the micro-computing platform 40G is suitably configured to support and run a local control program 40G2-X on microprocessor 40G3 and memory architecture 40G1, 40G2 which is required and supported by the enterprise-level mobile application 12 and the suite of services supported by the system network 1 of the present invention.

As shown in FIG. 25B, the wireless communication subsystem 30H comprises: an RF-GSM modem transceiver 40H1; a T/X amplifier 40H2 interfaced with the RF-GSM modem transceiver 40H1; and a WIFI interface and a Bluetooth wireless interface 40H3 for interfacing with WIFI and Bluetooth data communication networks, respectively, in a manner known in the communication and computer networking art.

As shown in FIG. 25B, the GPS-tracked and remotely-controllable anti-fire (AF) chemical liquid spray control subsystem 40F comprises: anti-fire chemical liquid supply sensor(s) 40F1 installed in or on the anti-fire chemical liquid supply tank 30B to produce an electrical signal indicative of the volume or percentage of the AF liquid supply tank containing AF chemical liquid at any instant in time, and providing such signals to the AF liquid spraying system control interface 40F4; a power supply and controls 40F2 interfaced with the liquid pump spray subsystem 40C, and also the AF liquid spraying system control interface 40F4; manually-operated spray pump controls interface 40F3, interfaced with the AF liquid spraying system control interface 30F4; and the AF liquid spraying system control interface 40F4 interfaced with the micro-computing subsystem 40G, via the system bus 40I. The flash memory storage 40G2 contains microcode for a control program that runs on the microprocessor 40G3 and realizes the various GPS-specified AF chemical liquid spray control, monitoring, data logging and management functions supported by the system 40. This helps in maintaining sufficient levels of AF liquid in the supply tank of the fire seeking and suppressing robot system 40.

### Guiding and Controlling the Thermally-Imaging Fire Seeking and Suppressing Robot System of the Present Invention by an Artificial Intelligence (AI) System Remotely Connected to the Wireless Network

FIG. 26 illustrates the thermally-imaging fire seeking and suppressing robot system of the present invention 40 being guided and controlled by an artificial intelligence (AI) system remotely connected to the wireless network and having full access to rich intelligence continuously collected by thermal and multi-spectral imaging drones, and constructed by powerful AI processing algorithms, and stored in databases maintained within system network of the present invention, for guiding automatically deployed thermal-imaging fire seeking and suppression robots, tasked with early thermal-tracking and elimination of fire outbreaks and arson strikes/attacks within a wood-framed or mass timber building.

### Guiding and Controlling the Thermally-Imaging Fire Seeking and Suppressing Robot System of the Present Invention by VR-Enabled Navigation and Control System Remotely Connected to the Wireless Network

FIG. 27 illustrates the thermally-imaging fire seeking and suppressing robot system 40 being guided and controlled by a virtual reality (VR) navigation and control system (e.g. workstation or portable device). Typically, the VR-enabled navigation and control system 80 is remotely connected to the wireless network and operated by a human being in a remote location trained to guide and control automatically or semi-automatically deployed thermal-imaging fire seeking and suppression robots 40. Such deployed robot systems will be tasked with very specific missions: detection and early thermal-tracking and elimination of fire outbreaks and arson strikes/attacks within a wood-framed or mass timber building, using anti-fire (AF) liquid spray streams directed onto a thermally-tracked building fire. However, these robot systems may also be programmed to perform other intelligence functions to preserve and secure security within wood framed buildings under construction, when they are most vulnerable from attack.

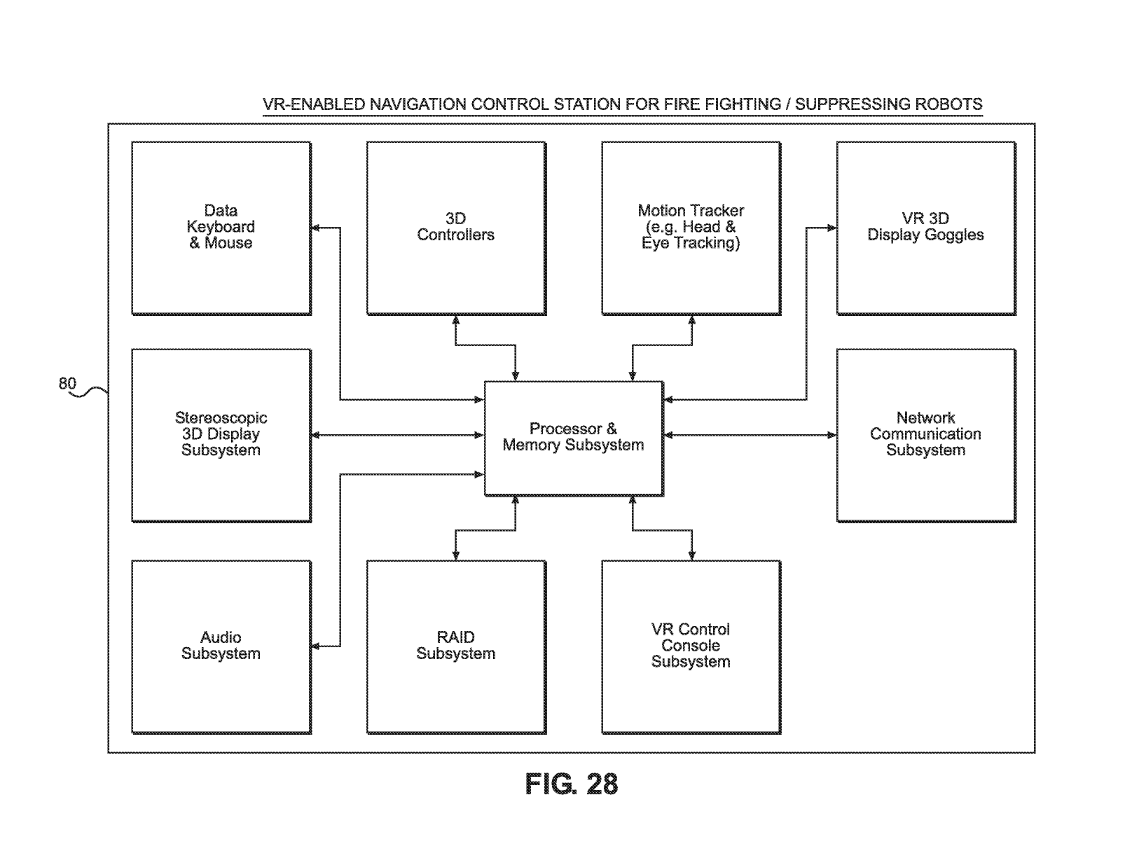

FIG. 28 shows the virtual reality (VR) navigation and control station of FIG. 27, comprising: a stereoscopic 3D display subsystem; a network communication subsystem; data keyboard and mouse: 3D controllers; motion trackers (e.g. head tracker; an eye tracker; face-tracker: and 3D gloves; an audio subsystem; VR control console subsystem; a RAID subsystem for local storage; and processor and memory subsystem.

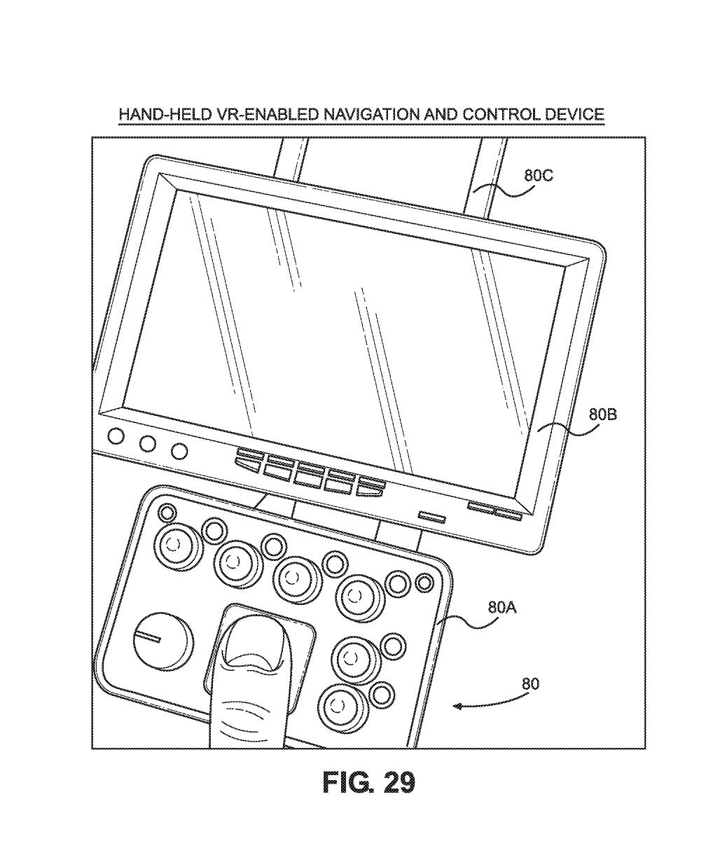

FIG. 29 shows a hand-held mobile VR-navigational and control system for remotely controlling the thermally imaging fire seeking and suppressing robot system shown in FIGS. 27 and 28. As shown, the device 80 comprises a hand-held housing 80A with controls; and touch screen LCD panel 80B driven by a microcomputer system embedded within the hand-held housing; provided with networking and communication circuits, antennas 80C, and wireless interfaces suitable for this form of human-machine interface.

Specification of a Completed Section of a Wood-Framed Building and Mass Timber Building that have been Defended Using Clean Fire Inhibiting Chemical (CFIC) Liquid Using the Class-A Fire-Protection Spray Methods of the Present Invention

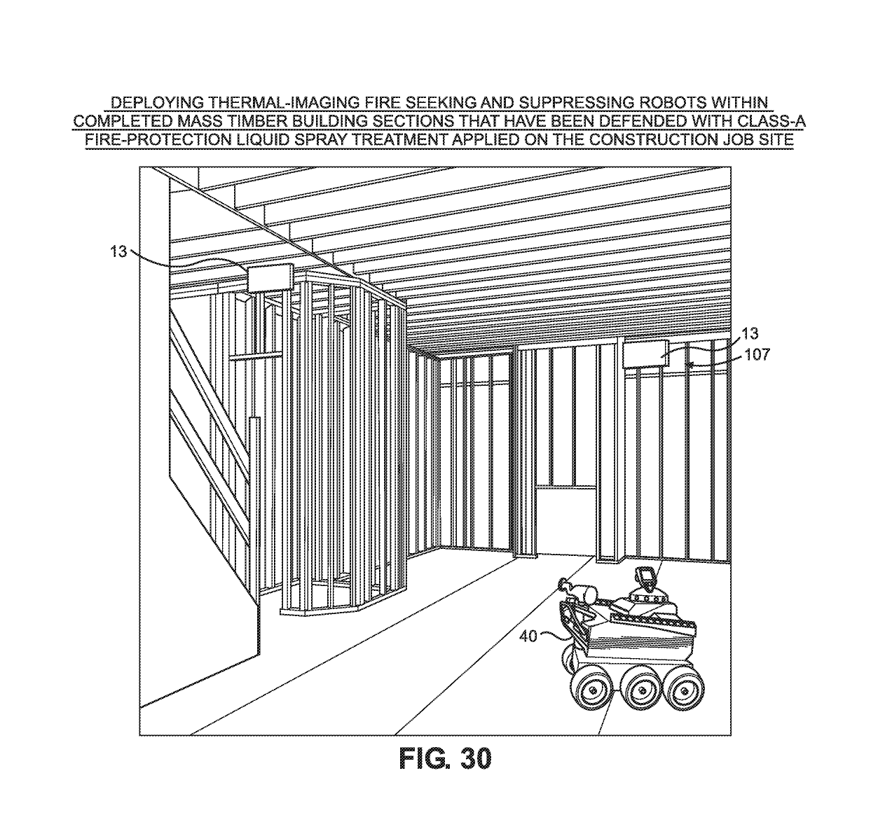

FIG. 30 shows a completed section of a wood-framed building that has been defended using clean fire inhibiting chemical (CFIC) liquid using the Class-A fire-protection spray methods of the present invention disclosed in FIGS. 2 through 15. In this application environment, the early fire outbreak and arson strike elimination system of the present invention has been installed, configured and deployed in this wood building under construction, including deployment of one or more AI-guided or VR-navigated thermal-imaging fire seeking and suppressing robot systems 40 shown in FIGS. 23A through 25B.

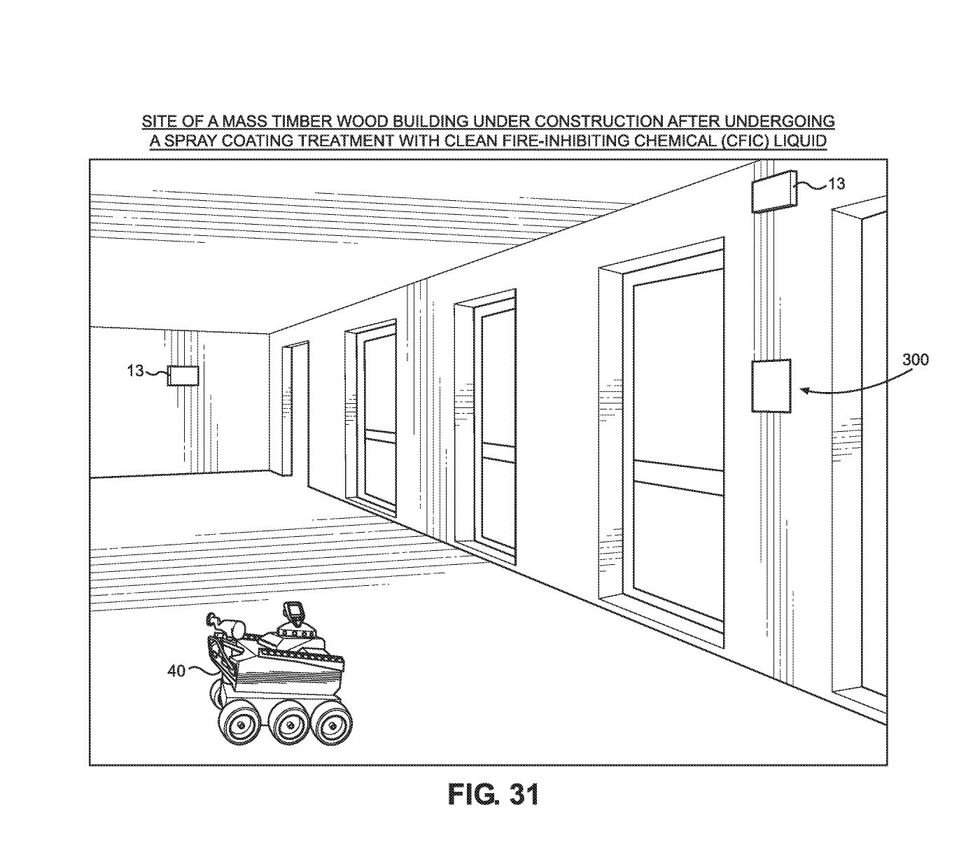

FIG. 31 shows a completed section of a mass timber building that has been defended using clean fire inhibiting chemical (CFIC) liquid using the Class-A fire-protection spray methods of the present invention disclosed in FIGS. 2 through 15. In this application environment, the early fire outbreak and arson strike elimination system of the present invention has been installed, configured and deployed in this wood building under construction, including deployment of one or more AI-guided or VR-navigated thermal-imaging fire seeking and suppressing robot systems 40 shown in FIGS. 23A through 25B.

### Specification of the AI-Guided/VR-Navigated Thermal-Imaging Fire Seeking and Suppressing Drone Aircraft System of the Present Invention

FIG. 32 shows the AI-guided/VR-navigated thermal-imaging fire seeking and suppressing drone aircraft system of the present invention 60. As shown, the system 60 comprises: a compact tanker body 60A containing a supply of clean anti-fire (AF) liquid (e.g. Hartindo AF31 anti-fire liquid); a spray nozzle gun 60D controlled by thermal-images captured and analyzed in real-time by a FLIR thermal-imaging camera subsystem 60C to seek, find, track and suppress fire outbreaks within the wood-framed building.

FIG. 32A is a second perspective view of the AI-guided/VR-navigated flying thermal-imaging fire seeking and suppressing drone aircraft system 60, shown in operation eliminating a detected fire outbreak or arson strike within the interior of a wood-framed or mass timber building being defended using the Class-A fire protection methods described in FIGS. 3A through 15. As shown, the spray nozzle 60D is automatically tracked onto the blazing arson fire and spraying a field-constrained stream of AF liquid to eliminate the thermally-tracked fire in an early manner inside the defended building.

AI-guided/VR-navigated thermal-imaging fire seeking and suppressing flying drone vehicle 60 has two modes of navigation and control: (1) it can be navigated and controlled by artificial intelligence (AI) algorithms, systems and techniques known in the vehicle navigation and control art, as illustrated in FIG. 26; or (2) it can be controlled by a human operator using a VR-enabled navigation and control interface/console system 80 as shown in FIGS. 27, 28 and 29. Alternatively, a hybrid mode employing both AI and VR-enabled techniques may be used with advantageous results. Both of these modes of operations have been described in detail hereinabove.

FIG. 33A is high level block diagram of the AI-guided/VR-navigated thermal-imaging fire seeking and suppressing drone aircraft system 60 depicted in FIGS. 32 and 32A, showing its anti-fire (AF) liquid spraying fire suppression tool, a GPS receiver, RTK antenna, a 900 MHZ antenna, and a refuel/recharging port, digital video camera systems providing field of views (FOVS), multi-band wireless radio control and communications, GPS-supported navigation and collision avoidance capabilities.

FIG. 33B is a block subsystem diagram for the AI-guided/VR-navigated fire seeking and suppressing robot system of FIGS. 32, 32A and 33A, shown comprising a GPS-tracked and remotely-monitored AF chemical liquid spray control subsystem, a micro-computing platform or subsystem interfaced with the GPS-tracked and remotely-monitored AF chemical liquid spray control subsystem by way of a system bus, a wireless communication subsystem interfaced to the micro-computing platform via the system bus, and a vehicular propulsion and navigation subsystem employing propulsion subsystem, and AI-driven or VR-assisted navigation subsystem.

FIG. 33B shows a GPS-tracked unmanned flying anti-fire (AF) liquid spray vehicle system 60 for spraying environmentally-clean anti-fire (AF) chemical liquid on fire outbreaks or arson strikes inside wood-framed and mass timber buildings under construction, in accordance with the principles of the present invention. As shown, the vehicle system 60 is driven by a propulsion drive subsystem 60 and navigated by GPS-guided navigation subsystem 60I2, and carrying an integrated supply tank 60B with either rechargeable-battery-operated electric-motor driven spray pump, for deployment in buildings under construction, for spraying the same with environmentally-clean anti-fire (AF) liquid using a spray nozzle assembly 60D connected to the spray pump 60C by way of a flexible hose.

FIG. 33B shows the GPS-tracked mobile anti-fire liquid spraying system 60 of FIG. 33B as comprising a number of subcomponents, namely: a GPS-tracked and remotely-monitored AF chemical liquid spray control subsystem 60F; a micro-computing platform or subsystem 60G interfaced with the GPS-tracked and remotely-monitored AF chemical liquid spray control subsystem 30F by way of a system bus 60I; a wireless communication subsystem 60H interfaced to the micro-computing platform 60G via the system bus 60I; and a vehicular propulsion and navigation subsystem 60I employing a propulsion subsystem 3011 and AI-driven or manually-driven navigation subsystem 60I2.

As configured in the illustrative embodiment, the GPS-tracked mobile anti-fire liquid spraying system 60 enables and supports (i) the remote monitoring of the spraying of anti-fire (AF) chemical liquid from the system 60 when located at specific GPS-indexed location coordinates, and (ii) the logging of all such GPS-indexed spray application operations, and recording the data transactions thereof within a local database maintained within the micro-computing platform 60G, as well as in the remote network database maintained at the data center of the system network.

As shown in FIG. 33B, the micro-computing platform 60G comprises: data storage memory 60G1; flash memory (firmware storage) 60G2; a programmable microprocessor 60G3; a general purpose I/O (GPIO) interface 60G4; a GPS transceiver circuit/chip with matched antenna structure 60G5; and the system bus 60I which interfaces these components together and provides the necessary addressing, data and control signal pathways supported within the system 60. As such, the micro-computing platform 60G is suitably configured to support and run a local control program 60G2-X on microprocessor 60G3 and memory architecture 60G1, 60G2 which is required and supported by the enterprise-level mobile application 120 and the suite of services supported by the system network 1 of the present invention.

As shown in FIG. 33B, the wireless communication subsystem 60H comprises: an RF-GSM modem transceiver 60H1; a T/X amplifier 60H2 interfaced with the RF-GSM modem transceiver 60H1; and a WIFI interface and a Bluetooth wireless interface 60H3 for interfacing with WIFI and Bluetooth data communication networks, respectively, in a manner known in the communication and computer networking art.

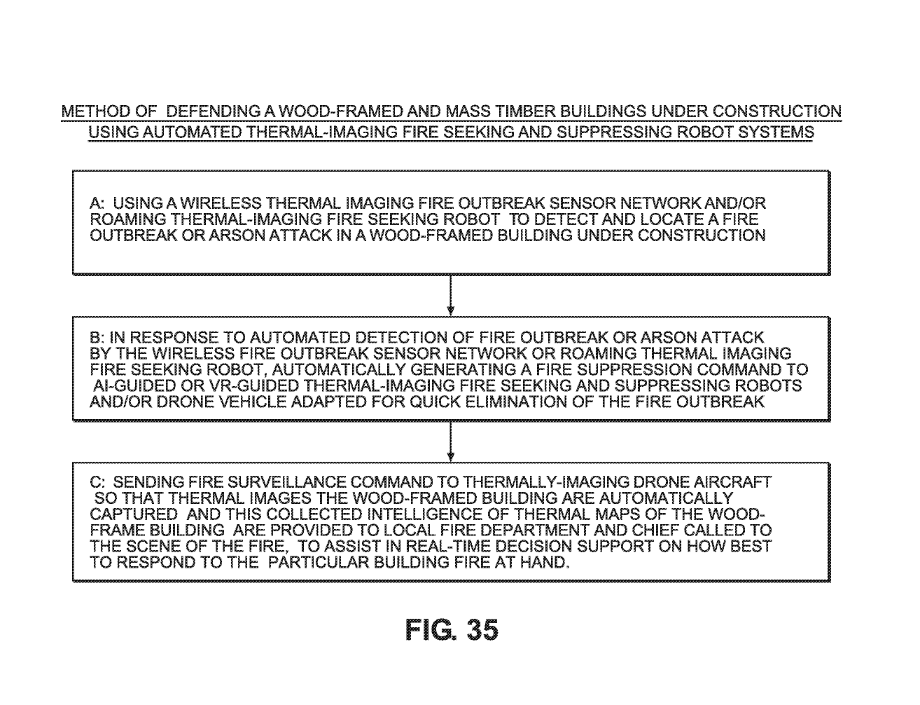

As shown in FIG. 35B, the GPS-tracked and remotely-controllable anti-fire (AF) chemical liquid spray control subsystem 60F comprises: anti-fire chemical liquid supply sensor(s) 60F1 installed in or on the anti-fire chemical liquid supply tank 60B to produce an electrical signal indicative of the volume or percentage of the AF liquid supply tank containing AF chemical liquid at any instant in time, and providing such signals to the AF liquid spraying system control interface 60F4; a power supply and controls 60F2 interfaced with the liquid pump spray subsystem 60C, and also the AF liquid spraying system control interface 60F4; manually-operated spray pump controls interface 60F3, interfaced with the AF liquid spraying system control interface 60F4; and the AF liquid spraying system control interface 60F4 interfaced with the micro-computing subsystem 60G, via the system bus 60I. The flash memory storage 60G2 contains microcode for a control program that runs on the microprocessor 60G3 and realizes the various GPS-specified AF chemical liquid spray control, monitoring, data logging and management functions supported by the system 60.

Once the flying drone vehicle 60 arrives at the burning section using GPS coordinates and other collected thermal intelligence from the wireless thermal imaging sensor network 13N, during the last leg of travel towards the fire outbreak, the drone will use real-time thermal imaging and tracking principles to seek, find and lock-onto and eliminate the fire outbreak or arson attack with a variable stream of anti-fire (AF) liquid sprayed directly onto the burning fire liquid. In a preferred embodiment, the thermal-imaging camera 60C aboard the system 60 will analyze thermal images captured in real-time and use the thermal and position information contain in such images to improve steering and aiming the AF liquid stream during fire suppression operations.

### VR-Guided Method of Detecting and Suppressing Fire Outbreaks and Arson Strikes Inside a Wood-Framed Building Under Construction Defended by the Class-A Fire-Protection Method

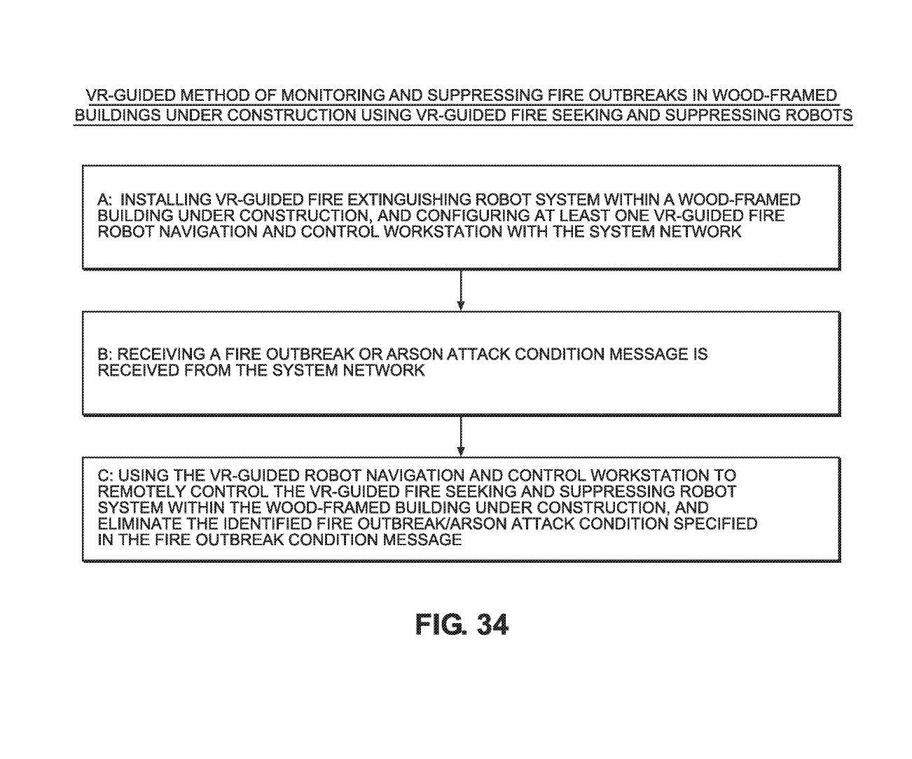

FIG. 34 describes the primary steps involved in the VR-guided method of detecting and suppressing fire outbreaks and arson strikes inside a wood-framed or mass timber building 111A, 111B under construction defended by the Class-A fire-protection methods disclosed in FIGS. 2 through 13.

As shown in FIG. 34, the method comprise: (a) AI-guided/VR-navigated thermal-imaging fire seeking and suppression robot system 40 are deployed within a defended wood-framed building under construction, and at least one VR-based navigation and control workstation or mobile device 80 is configured with the system network; (b) a fire outbreak or arson attack condition message is received from the system network; and (c) the VR-guided robot navigation and control workstation 80 is used to remotely control the VR-guided fire seeking and suppressing robot system 40 within the wood-framed building 111A, 111B under construction, and eliminate the identified fire outbreak/arson attack condition specified in the fire outbreak condition message.

### Specification of Method of Defending a Wood-Framed and Mass Timber Buildings Under Construction Using Automated Thermal-Imaging Fire Seeking and Suppressing Robot Systems

FIG. 35 describes a method of defending a wood-framed and mass timber buildings 111A, 111B under construction using automated thermal-imaging fire seeking and suppressing robot systems 40.

As shown, the method comprises the steps of: (a) using a wireless thermal imaging fire outbreak sensor network 13N and/or a roaming thermal-imaging fire seeking robot to detect and locate afire outbreak or arson attack in a wood-framed building under construction; (b) in response to automated detection of fire outbreak or arson attack by the wireless fire outbreak sensor network 13N or roaming thermal imaging fire seeking robot 20, generate a fire suppression command to an AI-guided or VR-guided thermal-imaging fire seeking and suppressing robot 40; and (c) sending fire surveillance command to thermally-imaging drone aircraft 20 so that thermal images are captured of the wood-framed building to collect intelligence of thermal maps of the wood-frame building 111A, 111B and providing the same to local fire department and chief called to the scene of the fire.

### Modifications of the Illustrative Embodiments of the Present Invention

The present invention has been described in great detail with reference to the above illustrative embodiments. It is understood, however, that numerous modifications will readily occur to those with ordinary skill in the art having had the benefit of reading the present disclosure.

The illustrative embodiments disclose the use of clean fire inhibiting chemicals (CFIC) from Hartindo Chemicatama Industri, particular Hartindo AAF21 and AAF31 for applying and forming CFIC-coatings to the surface of wood, lumber, and timber, and other engineering wood products. However, it is understood that alternative CFIC liquids will be known and available to those with ordinary skill in the art to practice the various methods of Class-A fire-protection according to the principles of the present invention.

These and other variations and modifications will come to mind in view of the present invention disclosure.

While the illustrative embodiments included primarily mass timber buildings and building components, it is understood that all such methods and apparatus of the present invention can be readily applied to prefabricated wood-framed buildings disclosed and taught in Applicant's other pending US patent applications including: Ser. No. 15/829,914 filed 2 Dec. 2017; Ser. No. 15/866,451 filed 9 Jan. 2018; Ser. No. 15/866,454 filed 9 Jan. 2018; Ser. No. 15/866,456 filed 9 Jan. 2018; Ser. No. 15/874,874 filed 18 Jan. 2018; Ser. No. 15/921,617 filed 14 Mar. 2018; and Ser. No. 15/952,183 filed 12 Apr. 2018 each said pending US patent application being incorporated herein by reference in its entirety as if fully set forth herein.

While the on-site applied spray of CFIC liquid was shown for newly constructed prefabricated Class-A fire-protected mass timber buildings, it is understood that this method of Class-A fire-protection treatment also can be practiced on older buildings having: (i) open unfinished attic spaces disposed above roof-trusses with open, unfinished ceiling surfaces, wall and floor surfaces, where bare interior wood surfaces are exposed and at high-risk to fire; and (ii) open unfinished basement spaces, where wall panels are open, exposed and at high-risk to fire. In such environments, the Class-A fire-protection spray-treatment method of the present invention can be practiced with excellent results.

Also, it is understood that there will be a great need to apply the fire-protection spray methods of the present invention, disclosed in Applicant's pending U.S. patent application Ser. No. 15/866,451, and incorporated herein by reference in its entirety, to protect mass timber buildings from wild fires by automatically spraying water-based environmentally clean fire inhibiting chemical (CFIC) liquid over the exterior surfaces of the building, surrounding ground surfaces, shrubs, decking and the like, prior to wild fires reaching such buildings.

These and all other such modifications and variations are deemed to be within the scope and spirit of the present invention as defined by the accompanying Claims to Invention.

1-4. (canceled)

5. An early building fire-outbreak/arson-attack detection and elimination system comprising:
(i) wireless pass infra-red (PIR) or active infra-red (AIR) thermal imaging fire outbreak and arson-attack sensor network,
(ii) VR-guided fire fighting robot systems, and
(iii) flying unmanned thermal imaging drone aircraft systems with video image capturing capabilities to monitor a building under fire,
wherein all such subsystems being integrated with and in communication with the data center and internet (TCP/IP) infrastructure of the building intelligence collection, processing and information management system of the present invention, and are tracked in real-time using a global navigation satellite system (GNSS) with real-time kinematic referencing for high-resolution global positioning.

6-8. (canceled)

9. An early warning fire response system for installation in a wood-framed or mass-timber building under construction, comprising:
a network of passive infra-red (PIR) thermal imaging fire outbreak sensors network installed in said wood-framed or mass timber building, which triggers the takeoff of a thermal imaging drone aircraft to capture real-time aerial IR imaging of a fire detected in said wood-framed or mass timber building, so as to inform fire chiefs in determining how best to respond to a fire burning within said wood-framed or mass timber building under construction.

10-11. (canceled)

12. A method of defending wood-framed and mass timber buildings under construction comprising the steps of:
(a) installing a wireless thermal imaging fire outbreak sensor network in said wood-framed or mass timber building, and deploying roaming thermal-imaging fire seeking robots, to detect and locate a fire outbreak or arson attack in said wood-framed building under construction;
(b) in response to automated detection of fire outbreak or arson attack by said wireless fire outbreak sensor network or roaming thermal imaging fire seeking robots, automatically generating a fire suppression command to an AI-guided or VR-guided thermal-imaging fire seeking and suppressing robots and drone vehicles; and
(c) sending fire surveillance command to thermally-imaging drone aircraft so that thermal images the wood-framed building are automatically captured and this collected intelligence of thermal maps of the wood-frame building are provided to local fire department and chief called to the scene of the fire, to assist in real-time decision support on how best to respond to the particular building fire at hand.
